(19) United States
(12) Patent Application Publication
(10) Pub. No.: US 2021/0287318 A1
(43) Pub. Date: Sep. 16, 2021

(54) Method and System for Managing an Emergency

(71) Applicant: Aleksandar Sterpin, Vitoria (BR)

(72) Inventor: Aleksandar Sterpin, Vitoria (BR)

(21) Appl. No.: 17/257,907

(22) PCT Filed: Jul. 16, 2018
(86) PCT No.: PCT/BR2018/050241

§ 371 Date: Jan. 5, 2021

(51) Int. Cl. G06Q 50/26; H04L 29/08; G06Q 10/06; G01C 21/20

(52) U.S. Cl. CPC G06Q 50/265; G01C 21/20; G06Q 10/06311; H04L 67/12

(57) ABSTRACT

The invention relates to a method and system for emergency management in cases of need for evacuation, in real case, training or simulation, which controls and optimizes the disaster combat actions and the environments escape routes, maintaining the Station Bill updated dynamically, considering the positioning and conditions of people in their work routines, certificates of training in possession, personal evaluations of emergencies or trainings attended, condition and availability of collective protection equipment, availability of rescue equipment, vessel stability and weather condition. The system uses a control and monitoring module, which communicates with a backup module, authenticated computers and portable modules or installed in the environments to report emergency situation, meteorological situation, vessel stability situation and modules for interfacing with people on board and scanning module with camera to capture the presence of people and protection and rescue equipment and the condition of escape routes and zones.

### TECHNICAL FIELD

The invention refers to a method and an emergency management system for environment evacuation, especially for vessels, that update a Dynamic Station Bill and Emergency Communication Protocol, updating in real time the information in a Ship Station Bill and optimizing the action control in real emergency situations, training or simulation. The Ship Station Bill is updated dynamically taking into consideration the positioning and crew conditions in their work routines, training certificates in possession, personal evaluations of attended trainings or real emergencies, conditions and availability of general protective and rescue equipment, vessel stability condition and structure, and the weather condition. A communication protocol is proposed according to international standards, prioritizing the data transmission network, allowing any elements connected to a communication network to send information to a command center, dynamically updating the information of the aforementioned Bill. The system is based on the use of devices with touch screens to collect crew information during normal operation and in emergency situation, allowing people counting in muster points, orders visualization for emergency teams, preview of evacuation safe route and send information to the control center for real-time updating of a plurality of information relevant to the emergency.

### DESCRIPTION OF THE STATE OF THE ART

The international convention Safety Of Life At Sea (SOLAS 1974/1988) prescribes, on rules 8 and 37 of chapter 3, that clear instructions should be provided to be followed in case of emergency by each person on board. These instructions are described on the Station Bill.

For small crew vessels where duties are clearly assigned, without many replacement options, the Station Bill initially elaborated is enough to ensure actions in case of an emergency. Due to this fact, it isn't possible to considerably optimize the use of resources and improve the emergency response time or vessel evacuation time. But using a system that dynamically updates information during emergency events, might help decision making, because it englobes a great amount of processed and saved information for further incident analysis.

In the case of vessels with a complex structure and a more people on board, the review of the Station Bill in a dynamic way, and in real time, to assign new duties and routes for all on board, as well as better use of general protective and rescue equipment, shall provide greater safety, reducing material losses and safeguarding life.

The emergency management system supplies updated Station Bill information sent through plurality of control modules, sent to the communication network using the emergency protocol and performs specific calculations to indicate safer escape routes, also reassigning new duties, according to the emergency event and it progress. The below documents describe the technological scenario used as a base for the elaboration of the proposed system:

The document US 2006/0250271 describes a system to provide a specific communication way for emergency in buildings containing one command station and muster points. Control modules located on muster points maintain at least one emergency communication link between a control module, located in the command station and each one of the control modules. In this document, RFID transmitters are distributed at muster points to track people during emergency events.

The document US 2008/0109099 describes a device and a method for process control using asset and people tracking information. In the presented method, one or more control elements are received by the proposed system that defines the person or asset positioning inside the environment processed by such elements. The location information could be used to prevent entrance in dangerous areas, check specific area evacuation, estimate location of people in need of rescue, among other applications.

The document U.S. Pat. No. 7,916,024 B2 reveals a device to register the arrival of people in a location, with the purpose of counting people in an emergency. It is applicable to places where there are various muster points, such as oil and gas platforms, the device allows the identifying if an individual has moved to a different muster point than the assigned to that individual. As an execution method the document U.S. Pat. No. 7,916,024 B2 mentions the use of labels with passive Radio-Frequency Identification (RFID) technology. The described device includes a communication way of the information with an operator located in command center. The described system depends upon the arrival of the person to the monitored location.

The document U.S. Pat. No. 7,868,760 reveals a people counting method for emergency situations in industrial installations. The described system uses RFID and UWB (ultrawide band) to track people during emergency events. UWB transmitters associated to people and objects, transmit information to the monitoring stations, which in turn, send these data to a computer that calculates the transmitter location.

The document U.S. Pat. No. 8,970,367 B2 reveals the system to location of people on board of platforms and lifeboat situation, indicating people situation in muster points, that is, if they are present of absent, and if the boat has been launched. The described system allows for people outside of the installation to access the location information and to obtain personal profiles and location through use of devices in muster points. The system does not foresee the conjoint analysis of the information for optimization of team formation, evacuation routes, abandon situation and emergency response orders. Nor it describes the use of the computers for analysis and transportation of the emergency information allowing the dynamic update of the Station Bill.

The document ES 2 583 166 A2 reveals the escape route optimization system for vessels, using on board people tracking by RFID wristbands and the situation of the emergency sensors installed in the vessel to calculate the escape routes that result in the safe and shorter time path. Analyzing the data processed by the main system unit, denominated Emergency Management Unit (EMU), mentioned in the claim 3 of the ES 2 583 166 A2, it is noticed that new routes and duties are not attributed to emergency teams, from availability information, necessary certification and safety resources available to the crew, taking into consideration its proximity to the emergency area and how the programed routine tasks collaborate for the assignment, or not, of this crew member for the combat team.

It is and objective of present invention to monitor the presence of general protective and rescue equipment in a specific location, depending on the activity performed at this location, thus allowing to consider it as a resource in the emergency situation and in updating the Station Bill.

The document U.S. Pat. No. 9,541,625 describes the monitoring of Security Assets, mentioning as an example the fire extinguisher and defibrillator, with devices that inform the presence, temperature, obstruction to the Security Asset and the load condition and energy, respectively, to the fire extinguisher and defibrillator, but extrapolating the sensor information use and adding the use of the following technologies: Global Positioning System (GPS) and images captured by mobile telephone devices (smartphones), proposing the definition of optimized escape routes, unlike the present invention that from the location of the crew member or passenger, the allocation or not of the crew member in the emergency response, updates the Station Bill rerouting the escape route, when needed.

The document US20110084830 describes a system to indicate a safe exit in emergency situations, using emergency lights, tracking only passenger, temperature sensors, humidity and vibration for emergency detection and a central computer to process data and control emergency lights. Emergency lights can through the writings “KEEP OUT” and “WAIT” next to the compartment doors, control evacuation, concentration and people congestion. The afore mentioned system uses the PLC network (Power Line Communication) and internet. The system does not reorganize the abandonment teams, firefighting, rescue, etc. Besides, it does not calculate and does not reorganize the Station Bill. In the afore mentioned document, even in emergency situations, the word “WAIT” is used, which is not included in the now presented Emergency Management System, because all the calculations are made to reorganize the teams in the best possible way, saving time and guaranteeing successful performance of firefighting, rescue, abandonment teams, etc.

It is noticeable in the presented Emergency Management System graphs that the congestion and the counterflow is avoided reorganizing in real time all the emergency teams. The Field Module and the Smart Portable Radio Module (which will be described below) have the function of providing the safe path, definitive and complete until the assigned muster point for all embarked persons and not just inform a safe exit.

The document also describes that the humidity sensor is used to detect a flooding. This detail is not correct. The Level sensor is used for flood detection, because the humidity sensor is very sensitive and inadequate for this measurement, and it easily triggers in situations of, for example, floor washing and cleaning, as well as in real cases of high air humidity measurement.

The document WO1993020544 reveals a system used only for fire crisis management. It uses a computer, a sensor network and information from structures involved in the event with the objective of elaborating a mathematical model for fire spread prediction, selection of adequate combat and diagnosis forms to activate the mechanical firefighting system or to supply relevant data to the firefighting team. The document also mentions the use of emergency lights mentioned in the document US20110084830 for safe path signaling. The term “simulation” is used, but on this case, it is the simulation of the fire spread and of the possible affected areas. The mentioned system does not reorganize the abandonment, firefighting and rescue teams, etc. Besides, it does not calculate and does not reorganize the Station Bill.

### Technical Solution

The technical solution presented by this invention has the main objective of reducing the travel time to the muster point, in a real emergency situation, simulated or in training, and the optimized use of the human resources and materials to increase efficiency in the fight against emergencies on vessels. To achieve this objective, are proposed a method and an emergency management system that includes modules, such as the Control and Monitoring Module and other modules, that perform actions to update in real time the Station Bill information.

For the Station Bill update it is necessary that the position of the embarked persons, emergency response resources and general or individual protective and rescue equipment, vessel stability condition, weather condition, ongoing tasks condition, are transmitted to the Control and Monitoring Module, which on this invention is made possible by a Specific Communication Network, an Emergency Communication Protocol, Field Modules, Smart Portable Radio Modules, Scanning Modules with Camera and Sensor Module network distributed throughout the vessel, as well as any other detectors and locators capable of informing the position of a person or a Security Asset.

The technical solution presents a method and a system to obtain the Station Bill, enhanced by the dynamic data update, offshore application method and an information transportation method through Specific Communication Data Network and Protocol with a standard of reduced symbols, to increase the chances of success on information exchange in emergency situations.

The present invention provides a more efficient method for calculating safe evacuation routes, forming of emergency response teams, and other safety actions.

It is also the purpose of the solution to present an Emergency Management System and a method of concentration and presentation of personal information, positioning, work permit, certificates, and emergency events in the control center.

It is also the purpose of the solution to present a form of implementation and regeneration of emergency-Specific Communication Network applied to the devices present in controlled environments.

It is also the purpose of the solution to provide an Emergency Communication Protocol, with a reduced size, capable of transmitting the information necessary to update the Station Bill.

A second objective of the proposed Emergency Management System and Method is to control routine tasks and eventual situations, to decide which ones can be interrupted by the emergency situation and, if interrupted, to use the estimated time referred to the time needed to safely abandon the task and reach a nearer escape route and apply it to the calculations of new duties redistribution in this descriptive report called dynamic duties. The identification of crew certificates and qualifications is part of the information that enables them to carry out duties of the Station Bill with the legal basis, and the personal evaluations of the emergencies or trainings attended can be used to qualify them to assume the duty to combat the real emergency or for training.

Therefore, the technical solution is achieved by the method implemented in the Control and Monitoring Module, Specific Communication Network and modules that interface with people on board or scans to capture the presence of people and protective and rescue equipment.

The present invention is better understood and analyzed through the accompanying drawings, represented by figures and graphs, briefly described below, when confronted with the tables and the text of the detailed descriptive report.

### BRIEF DESCRIPTION OF GRAPHS AND FIGURES

FIG. 1 is a schematic representation of the algorithm for dynamic updating of the Station Bill.

FIG. 2 is a schematic representation of the distribution of active system modules for emergency control, based on people location system and Security Assets, sensor networks, and Field Modules.

FIG. 3 is a schematic representation of the use of dedicated communication for regeneration of the emergency communication network.

FIG. 4 is a schematic representation graph of fire emergency followed by abandonment using the Dynamic Station Bill.

FIG. 5 is a schematic representation graph of the fire emergency followed by abandonment using the Station Bill.

FIG. 6 is a schematic representation graph of the abandonment emergency using the Emergency Management System.

FIG. 7 is a schematic representation graph of the abandonment emergency using the Station Bill.

### DETAILED DESCRIPTION

The present invention discloses a method and a system for updating a Station Bill, here called the Initial Station Bill, from inserted information such as: training certificates in possession, personal evaluations of emergencies or attended trainings, among other personal information, or crew condition and availability and the work permits in progress, condition and location of collective safety equipment, condition of vessel structure and stability, and weather condition, and information obtained from the plurality of sensors, captured in real time, to redefine the most appropriate list of duties and the best route to the muster point of each embarked person at that time.

It is proposed to use whenever the technology allows an RFID tag or Bluetooth Beacon (tags) for each general or individual protective and rescue equipment, here called Security Asset.

The proposed system is comprised of emergency management modules distributed on the vessel and a specific network for communication between the modules and devices that will keep the Emergency Management System up to date.

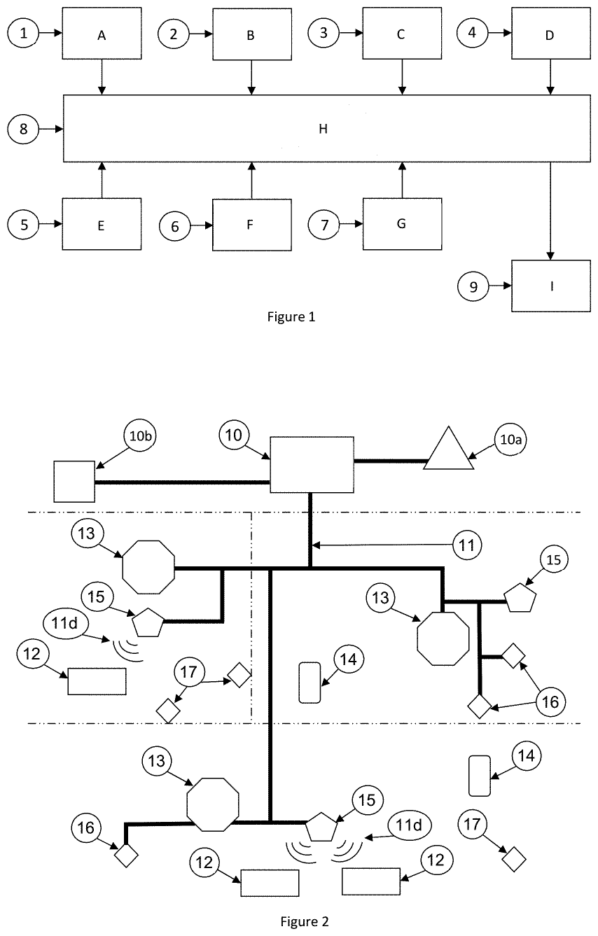

Algorithms and data, manually entered or captured by radio frequency sensors or transceivers, are used in calculations and filters that result in route and resource options. Thus, the commander or responsible for safety on board can select the most efficient way to respond to emergencies and/or abandonment of the vessel. The main steps of the proposed method are shown in FIG. 1 and are listed below using examples with 40 embarked persons and with duties and certificates of a merely illustrative nature. The steps, which are:

Step A (1)—Provide a form for insertion of information from the Initial Station Bill, according to Chapter 3 with Rules 8 and 37 of the International Convention for the Safety of Life at Sea (SOLAS 1974/1988).

The Initial Station Bill is structured with the purpose of forming a list of basic emergencies and duties for easy understanding and memorization of all on board. The Initial Station Bill previews the use of fire emergency teams (in the demonstration example 8) to form other teams, from other emergencies that are not present in the same Station Bill, according to the needs or the development of emergencies (see table 1 below). As can be seen in the Initial Station Bill the function of the person on board, and the working shift, determines the emergency duty.

In addition to the Initial Station Bill on the vessels, a Ship Security Station Bill according to the ISPS code “The International Ship and Port Facility Security Code” is used as an amendment to the SOLAS Convention. It serves for the security protection of the vessel, which aims to dissuade terrorist acts against vessels and ports. This Station Bill describes functions, shift condition (on-duty, off-duty or always), muster points and duties in case of bomb warning, clandestine passenger or intruder. The ISPS Code is implemented by the International Maritime Organization (IMO) through Chapter 11-2, “Special Measures to Enhance Maritime Safety” in the International Convention for the Safety of Life at Sea (SOLAS).

The ISPS code provides for three levels of security: MARSEC 1, 2 and 3. These security levels can be implemented by using the People On Board list (POB), which contains the condition of the shifts and availability of the people on board to perform additional safety duties. This Security Station Bill can be managed using the Emergency Management System in the same way as the Initial Station Bill is being updated and is not present in the detailed description but is on the Emergency Form list as well as all known and trained vessel emergencies (see table 19).

Emergencies presented in the Initial Station Bill are visible in table 4, summarizing data from all emergency teams. To all emergencies an emergency type identifier “ID” is added which may have as reference the ordinal number presented in the list (see table 4, column 1) or a generated code added to each emergency type of this list as identifier “ID” with the objective of referencing it in the communications between the Emergency Management System modules.

All data is simplified and reduced for better understanding. Data presented in tables 1, 2, 4 and 5 will be used in calculations of times, escape routes and redistribution of duties. The emergency type identifier “ID” of the Initial Station Bill corresponds to the ID of the same emergency present in the Emergency Management System.

Table 0 shows the symbols used in the following tables and their meanings.

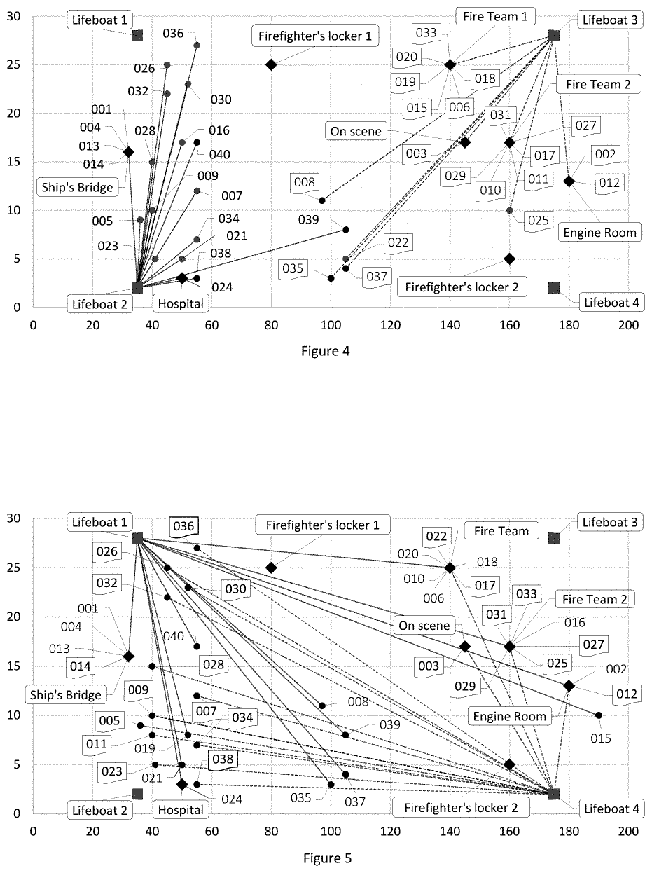

TABLE 0
SYMBOLS USED - meanings in tables and figures

| Ordinal | | |
|---|---|---|
| number | Symbol | Meaning |
| 1 | — | Continuation or insignificant data for presentation |
| 2 | | Fields left empty in the tables contains no data |
| 3 | : | And |
| 4 | ! | Or |
| 5 | ✓ | Option chosen, confirmed |
| 6 | ◯ | Initial Emergency Duty |
| 7 | ▴ | Alarm |
| 8 | [symbol] | Option eliminated by having the same meaning |
| | | or the value is not considerable |
| 9 | \| | Separation of groups of data with different |
| | | origin in the same column |
| 10 | ▪ | Lifeboats position |
| 11 | ♦ | Fire-fighting teams' position |
| 12 | ● | Individual detected position |
| 13 | [symbol] | Air distance between the person and the team or the |
| | | lifeboat different from the ordinal number 14 |
| 14 | [symbol] | Air distance between the person and the team or the |
| | | lifeboat different from the ordinal number 13 |
| 15 | ID | Identifier Code or classification |
| 16 | [symbol] | Personal ID code from the FIG. 4, 5, 6 and 7 added to |
| | | the lifeboat different from the ordinal number 17 |
| 17 | [symbol] | Personal ID code from the FIG. 4, 5, 6 and 7 added to |
| | | the lifeboat different from the ordinal number 16 |

Table 1 shows an example of an Initial Station Bill referring to a fire emergency or other emergency that does not involve abandonment, man overboard or H2S and CH4 (Gas) used today in vessels, with reduced number of embarked persons for example purposes.

TABLE 1
INITIAL STATION BILL - fire or another emergency
not specified on The Initial Station Bill

| Ordinal | Function | | | The initial |
|---|---|---|---|---|
| number | name | Condition | Station, team | duty name |
| 1 | Captain | Always | Ship's Bridge | In charge |
| 2 | Chief | Always | Engine Room | In charge of |
| | Engineer | | | the Engine Room |
| 3 | Chief | Always | Accident | On scene |
| | Officer | | Scene | commander |
| 4 | 2nd Officer | On Duty | Ship's Bridge | Vessel control |
| 5 | 2nd Officer | Off Duty | Reserve on | Maintains order and |
| | | | lifeboat 4 | communication |
| 6 | Motorman | On Duty | Fire | Alternative leader, |
| | | | Team 1 | wearing fire-suit 1 |
| 7 | Motorman | Off Duty | Reserve on | Wait for |
| | | | lifeboat 4 | instructions |
| 8 | Safety Training | On Duty | Reserve on | Maintains order and |
| | Supervisor | | lifeboat 1 | communication |
| 9 | Safety Training | Off Duty | Reserve on | Wait for |
| | Supervisor | | lifeboat 4 | instructions |
| 10 | Engine Oiler | On Duty | Fire | Wear fire-suit 2, |
| | | | Team 1 | hold fire hose nozzle |
| 11 | Engine Oiler | Off Duty | Reserve on | Wait for |
| | | | lifeboat 4 | instructions |
| 12 | 2nd Engineer | On Duty | Engine | Assist Chief |
| | | | Room | Engineer |
| 13 | Radio | Always | Ship's | Maintain |
| | Operator | | Bridge | communications |
| 14 | 2nd Engineer | Off Duty | Reserve on | Wait for |
| | | | lifeboat 1 | instructions |
| 15 | 3rd Engineer | On Duty | Fire | Fire Team |
| | | | Team 1 | Leader |
| 16 | 3rd Engineer | Off Duty | Fire | Fire Team |
| | | | Team 2 | Leader |
| 17 | Mechanic | On Duty | Fire | Open, close |
| | | | Team 1 | fire valve |
| 18 | Mechanic | Off Duty | Reserve on | Wait for |
| | | | lifeboat 1 | instructions |
| 19 | Electrician | On Duty | Fire | Help put fire-suit 2, |
| | | | Team 1 | hold fire hose |
| 20 | Electrician | Off Duty | Reserve on | Wait for |
| | | | lifeboat 1 | instructions |
| 21 | Engine | On Duty | Fire | Help put fire-suit 1, |
| | Wiper | | Team 1 | hold fire hose |
| 22 | Engine | Off Duty | Reserve on | Wait for |
| | Wiper | | lifeboat 4 | instructions |
| 23 | Nurse | Always | Hospital | Stand-by to |
| | | | | attend accidents |
| 24 | Electro- | On Duty | Fire | Help put fire-suit 2, |
| | Technician | | Team 2 | hold fire hose |
| 25 | Electro- | Off Duty | Reserve on | Wait for |
| | Technician | | lifeboat 4 | instructions |
| 26 | Assistant | On Duty | Fire | Open, close |
| | Mechanic | | Team 2 | fire valve |
| 27 | Assistant | Off Duty | Reserve on | Wait for |
| | Mechanic | | lifeboat 4 | instructions |
| 28 | Deck | On Duty | Fire | Alternative leader, |
| | Supervisor | | Team 2 | wearing fire-suit 1 |
| 29 | Deck | Off Duty | Reserve on | Wait for |
| | Supervisor | | lifeboat 4 | instructions |
| 30 | Crane | On Duty | Fire | Help put fire-suit 1, |
| | Operator | | Team 2 | hold fire hose |
| 31 | Crane | Off Duty | Reserve on | Wait for |
| | Operator | | lifeboat 4 | instructions |
| 32 | Roustabout | On Duty | Fire | Wear fire-suit 2, |
| | | | Team 2 | hold fire hose nozzle |
| 33 | Roustabout | Off Duty | Reserve on | Wait for |
| | | | lifeboat 4 | instructions |
| 34 | Bosun | On Duty | Reserve on | Wait for |
| | | | lifeboat 1 | instructions |
| 35 | Bosun | Off Duty | Reserve on | Wait for |
| | | | lifeboat 4 | instructions |
| 36 | Deck | On Duty | Reserve on | Wait for |
| | Seaman | | lifeboat 1 | instructions |
| 37 | Deck | Off Duty | Reserve on | Wait for |
| | Seaman | | lifeboat 4 | instructions |
| 38 | Ordinary | Always | Reserve on | Wait for |
| | Seaman | | lifeboat 1 | instructions |
| 39 | — | — | — | — |
| — | All other | Always | Assigned | Wait for |
| | persons | | lifeboat | instructions |

Table 2 shows an example of an Initial Station Bill regarding the emergency of abandonment as it is presented today in the vessels with the quantity of embarked persons adapted for presentation in this descriptive.

TABLE 2
INITIAL STATION BILL - Abandon

| Ordinal | Function | | | Initial |
|---|---|---|---|---|
| number | name | Condition | Station, team | duty |
| 1 | Captain | Always | Lifeboat 1 | In charge |
| 2 | Chief Engineer | Always | Lifeboat 1 | Prepares the engine |
| 3 | Chief Officer | Always | Lifeboat 4 | In charge |
| 4 | 2nd Officer | On Duty | Lifeboat 1 | Maintains order and |
| | | | | communication |
| 5 | 2nd Officer | Off Duty | Lifeboat 4 | Maintains order and |
| | | | | communication |
| 6 | Motorman | On Duty | Lifeboat 1 | Wait for |
| | | | | instructions |
| 7 | Motorman | Off Duty | Lifeboat 4 | Wait for |
| | | | | instructions |
| 8 | Safety Training | On Duty | Lifeboat 1 | Help at the |
| | Supervisor | | | muster point |
| 9 | Safety Training | Off Duty | Lifeboat 4 | Help at the |
| | Supervisor | | | muster point |
| 10 | Engine | On Duty | Lifeboat 1 | Wait for |
| | Oiler | | | instructions |
| 11 | Engine | Off Duty | Lifeboat 4 | Wait for |
| | Oiler | | | instructions |
| 12 | 2nd Engineer | Off Duty | Lifeboat 4 | Prepares the engine |
| 13 | Radio | On Duty | Lifeboat 1 | Brings GMDSS |
| | Operator | | | equipment |
| 14 | Radio | Off Duty | Lifeboat 4 | Brings GMDSS |
| | Operator | | | equipment |
| 15 | 2nd Engineer | On Duty | Lifeboat 1 | Wait for |
| | | | | instructions |
| 16 | 3rd Engineer | On Duty | Lifeboat 1 | Wait for |
| | | | | instructions |
| 17 | 3rd Engineer | Off Duty | Lifeboat 4 | Wait for |
| | | | | instructions |
| 18 | Mechanic | Always | Lifeboat 1 | Wait for |
| | | | | instructions |
| 19 | Electrician | Always | Lifeboat 1 | Wait for |
| | | | | instructions |
| 20 | Engine Wiper | Always | Lifeboat 4 | Wait for |
| | | | | instructions |
| 21 | Nurse | Always | Lifeboat 1 | Wait for |
| | | | | instructions |
| 22 | Electro- | Always | Lifeboat 4 | Wait for |
| | Technician | | | instructions |
| 23 | Assistant | Always | Lifeboat 4 | Wait for |
| | Mechanic | | | instructions |
| 24 | Deck | Always | Lifeboat 4 | Wait for |
| | Supervisor | | | instructions |
| 25 | Crane | Always | Lifeboat 4 | Wait for |
| | Operator | | | instructions |
| 26 | Roustabout | Always | Lifeboat 4 | Wait for |
| | | | | instructions |
| 27 | Bosun | On Duty | Lifeboat 1 | Prepares lifeboat |
| | | | | for launch |
| 28 | Bosun | Off Duty | Lifeboat 4 | Prepares lifeboat |
| | | | | for launch |
| 29 | Deck | On Duty | Lifeboat 1 | Help preparing |
| | Seaman | | | lifeboat |
| 30 | Deck | Off Duty | Lifeboat 4 | Help preparing |
| | Seaman | | | lifeboat |
| 31 | Ordinary | Always | Lifeboat 1 | Wait for |
| | Seaman | | | instructions |
| 32 | — | — | — | — |
| — | All other | Always | Assigned | Wait for |
| | persons | | lifeboat | instructions |

Table 3 shows an Initial Station Bill concerning the emergency of man overboard as it is presented today on the vessels.

TABLE 3
INITIAL STATION BILL - Man Overboard

| Ordinal | | | Initial |
|---|---|---|---|
| number | Function name | Condition | duty |
| 1 | Deck | On Duty | In charge of the |
| | Supervisor | | fast rescue boat |
| 2 | Crane Operator | On Duty | Crew |
| 3 | Mechanic | On Duty | Crew |
| 4 | Safety Training | On Duty | Crew |
| | Supervisor | | |
| 5 | Roustabout | On Duty | Prepares launch and hold of |
| | | | the fast rescue boat |
| 6 | Electrician | On Duty | Prepares launch and hold of |
| | | | the fast rescue boat |

Table 4 shows the common emergencies found today in a table format or described in the Initial Station Bill.

TABLE 4
INITIAL STATION BILL - resulting statistics

| | | Number | Number | Number | |
|---|---|---|---|---|---|
| | | of | of | of unique | Number |
| Emergency | Emergency | muster | initial | initial | of |
| ID | name | points | teams | duties | participants |
| 01 | Fire or another | 10 | 8 | 12 | All |
| | not listed | | | | |
| | emergency | | | | |
| 02 | Abandon | 4 | 2 | 8 | All |
| 03 | Man | 1 | 1 | 3 | 6 |
| | Overboard | | | | |
| 04 | H25 or CH4 | 2 | 2 | 1 | All |

Table 5 shows the fixed muster points deducted from the Initial Station Bill and the emergencies presented on it.

TABLE 5
INITIAL STATION BILL - resulting muster points

| | | | | Number |
|---|---|---|---|---|
| Emergency | Muster | | | of unique |
| ID | point | Team name | Type | duties |
| 01 | Firefighter's | Fire | A | 6 |
| | locker 1 | Team 1 | | |
| 01 | Firefighter's | Fire | A | 6 |
| | locker 2 | Team 2 | | |
| 01 | Ship's Bridge | Ship's Bridge | B | 3 |
| 01 | EngineRoom | Engine Room | B | 2 |
| 01 | On scene | Accident Scene | A!B | 1 |
| 01 | Lifeboat 1 | Reserve on | A | 2 |
| | | lifeboat 1 | | |
| 01 | Lifeboat 2 | Alternative reserve | A | 2 |
| | | for lifeboat 1 | | |
| 01 | Lifeboat 3 | Alternative reserve | A | 2 |
| | | for lifeboat 4 | | |
| 01 | Lifeboat 4 | Reserve on | A | 2 |
| | | lifeboat 4 | | |
| 01 | Hospital | Hospital | B | 1 |
| 02 | Lifeboat 1 | Lifeboat 1 | A | 8 |
| 02 | Lifeboat 2 | Alternative for | A | 8 |
| | | lifeboat 1 | | |
| 02 | Lifeboat 3 | Alternative for | A | 8 |
| | | lifeboat 4 | | |
| 02 | Lifeboat 4 | Lifeboat 4 | A | 8 |
| 03 | Fast Rescue | Man | A | 3 |
| | Boat | Overboard | | |
| 04 | — | — | | — |

Step B (2)—Provide a people on board registration form, to register each crew member and others, which in this descriptive report are treated as embarked persons, associating each embarked person with one identifier in the form of a label, badge or any other type of radio-frequency identification device, known as passive or active Radio-Frequency Identification Tag (RFID Tag). At this step, the form may allow the filling of personal data, information on certificates and qualifications, evaluation results met in emergencies and trainings and other data forming the list of people on board. (POB).

The people on board form is a set of forms covering all the data needed to manage the people on board. For example, the form also contains physical measures of the people on board, like body mass, boot number, number of the fireman suit, etc. These data are required for calculations of the estimated mustering times and redistribution of duties in emergencies. For example, body mass is necessary for redistribution of personnel on the lifeboats and their seats, and the number of boots and suit for the firefighting teams.

The control of the total mass of the lifeboat is necessary mainly for those that use the davits (windlasses) for the launch (lowering). The davit mechanism has limitations in relation to the maximum mass that the lifeboat may have on the lowering. The International Maritime Organization (IMO) adopted Resolution MSC.272 (85) at the 85th session of the Maritime Safety Committee, correcting chapters IV and V of the International Life-Saving Appliance (LSA) Code, introducing an increase in the so-called mass of occupants for the approval of life rafts and lifeboats. For lifeboats, the lifeboat arrangement design thus assumes an average mass of 75 kg per person in passenger ships and 82.5 kg per person for others including the use of life jackets (see table 23). This is the minimum requirement for the calculation of the arrangement that construction companies should consider. Considering these limitations in addition to the capacity of embarked persons on the lifeboats, the total weight of embarked persons is controlled so that it does not exceed the maximum allowed by the manufacturer.

The people on board form has as reference an ordinal number for each embarked person (see table 6, column 1) or a generated code added to each person in this form as an “ID” for the purposes of referencing it in communications between the modules of the Emergency Management System. Using the Initial Station Bill (see tables 1 and 2) and the people on board form (see table 6) the initial firefighting and abandonment duties are generated (see tables 7 and 8) and for other emergencies not included in this description (present in table 19).

The people on board form also contains data on all required and held certificates by the people on board for the automatic distribution of initial duties, dynamic duties and certificates required to perform the designated functions (see table 9, 11, 12 and 13). The people on board form is updated with the exit and entry of the embarked persons on the shift. The entry and exit of the embarked persons shift are confirmed in the Field Module (13) or the Smart Portable Radio Module (14) or the Authorized Computer (10b). Subsequently, the data is sent to the Control and Monitoring Modules (10, 10a) for updating the Emergency Management System.

The classification of the preparation point (see table 6, column 9) is used to determine the estimated time of preparation only for the embarked persons off-duty at the specific points of the vessel, generally known as changing rooms.

Certificates and courses required to perform an on-board function (see table 11) are separate from the certificates and courses required to perform emergency duty (see table 12). Thus, for example, the certificate with the classification “F” is only necessary to carry out emergency duty in abandonment of the vessel and does not prevent the embarked person from carrying out its function on board. Certificates required to perform emergency duties can be changed to reflect new requirements in the formation of dynamic duties in the revisions form (see table 26, 27, 28, 30 and 31).

An example of possible separation of courses and certificates between functions and duties is present in table 9. The Initial Station Bill does not bring order in team formation, the order of team “ID” applied to table 10 is random and serves to future analysis and formation of the dynamic duty's “ID”. In all vessels a hierarchy of command and responsibilities is used. Table 13 shows a hierarchy model to be used in the formation of dynamic duties. All functions have a certificate that authorizes them, which could be a certificate valid for all companies or only in one company.

An example of the company level certificate in this case is the deck supervisor (see table 9, certificate “AO”, table 13, hierarchy group 05). This function is based on work experience and leadership ability; however, it is necessary to have a crane operator course and internal course of deck supervisor among others to receive the authorization to perform the function. Supervisor course, “AT” classification, is generic and does not specifically refer to deck supervisor, but can also be part of the courses and certificates required for this function, depends on the company requirements and the decision of the security person in charge. Data presented in tables 6, 7, 8, 9, 10, 11, 12 and 13 are used in calculations of times, escape routes and redistribution of duties.

Table 6 shows all the personal data of the embarked persons in a simplified form. This table can contain a lot of data such as: Full name, function, classification or ID, company name, room, assigned lifeboat according to the Initial Station Bill, boarding day, expected day of disembarking, working time on-duty or off-duty, certificates and required courses and those in possession, social security card, ID card, passport, home address, department, e-mail, physical measurements, photography etc.

TABLE 6
PEOPLE ON BOARD LIST - People

| | | | | | Fire- | | | |
|---|---|---|---|---|---|---|---|---|
| Person | | Function | Weight | Boots | suite | Valid and in possession | Current | Preparation |
| ID | Function name | ID | Kg | number | number | course or certificate code | Condition | point |
| 001 | Captain | 04 | 81 | 42 | 58 | A:C:D:E:F:T:AT:XX:XY | On Duty | A |
| 002 | Chief Engineer | 05 | 108 | 44 | 64 | A:C:D:E:F:Z:AT:XX:XY | On Duty | A |
| 003 | Chief Officer | 06 | 88 | 43 | 60 | A:C:D:E:F:K:U:AT:XX:XY | On Duty | A |
| 004 | 2nd Officer | 07 | 96 | 40 | 54 | A:C:D:E:F:V:AT:XX:XY | On Duty | A |
| 005 | 2nd Officer | 07 | 87 | 42 | 62 | A:C:D:E:F:V:AT:XX:XY | Off Duty | A |
| 006 | Motorman | 08 | 85 | 41 | 56 | A:C:D:E:F:AS:AT:XX:XY | On Duty | B |
| 007 | Motorman | 08 | 93 | 41 | 54 | A:C:D:E:F:AS:AT:XX:XY | Off Duty | B |
| 008 | Safety Training Supervisor | 09 | 79 | 40 | 56 | A:C:D:E:AP:AT:XX:XY | On Duty | A |
| 009 | Safety Training Supervisor | 09 | 111 | 43 | 58 | A:C:D:E:AP:AT:XX:XY | Off Duty | A |
| 010 | Engine Oiler | 10 | 100 | 43 | 60 | B:C:D:E:F:AR:XX:XY | On Duty | B |
| 011 | Engine Oiler | 10 | 85 | 42 | 56 | B:C:D:E:F:AR:XX:XY | Off Duty | B |
| 012 | 2nd Engineer | 11 | 75 | 41 | 58 | A:C:D:E:F:AA:AT:XX:XY | Off Duty | A |
| 013 | Radio Operator | 12 | 75 | 40 | 54 | B:C:D:E:L:J:XX:XY | On Duty | A |
| 014 | Radio Operator | 12 | 74 | 43 | 60 | B:C:D:E:L:J:XX:XY | Off Duty | A |
| 015 | 2nd Engineer | 11 | 86 | 42 | 56 | A:C:D:E:F:AA:AT:XX:XY | On Duty | A |
| 016 | 3rd Engineer | 13 | 92 | 43 | 62 | A:C:D:E:F:AB:AT:XX:XY | Off Duty | B |
| 017 | 3rd Engineer | 13 | 106 | 41 | 56 | A:C:D:E:F:AB:AT:XX:XY | On Duty | B |
| 018 | Mechanic | 01 | 111 | 43 | 60 | B:C:D:E:AF:XX:XY | On Duty | B |
| 019 | Mechanic | 01 | 81 | 44 | 62 | B:C:D:E:AF:XX:XY | Off Duty | B |
| 020 | Electrician | 02 | 86 | 41 | 56 | B:C:D:E:H:AJ:XX:XY | On Duty | A |
| 021 | Electrician | 02 | 88 | 41 | 54 | B:C:D:E:H:AJ:XX:XY | Off Duty | A |
| 022 | Engine Wiper | 03 | 77 | 42 | 56 | B:C:D:E:AQ:XX:XY | On Duty | B |
| 023 | Engine Wiper | 03 | 93 | 41 | 54 | B:C:D:E:AQ:XX:XY | Off Duty | B |
| 024 | Nurse | 14 | 81 | 41 | 56 | B:C:D:E:M:AM:XX:XY | On Duty | B |
| 025 | Electro-Technician | 15 | 112 | 40 | 54 | B:C:D:E:AI:XX:XY | On Duty | A |
| 026 | Electro-Technician | 15 | 89 | 43 | 58 | B:C:D:E:AI:XX:XY | Off Duty | A |
| 027 | Assistant Mechanic | 16 | 87 | 43 | 60 | B:C:D:E:AG:XX:XY | On Duty | A |
| 028 | Assistant Mechanic | 16 | 82 | 42 | 60 | B:C:D:E:AG:XX:XY | Off Duty | A |
| 029 | Deck Supervisor | 17 | 83 | 42 | 62 | A:C:D:E:P:AO:XX:XY | On Duty | A |
| 030 | Deck Supervisor | 17 | 81 | 43 | 60 | A:C:D:E:P:AO:XX:XY | Off Duty | A |
| 031 | Crane Operator | 18 | 81 | 44 | 58 | B:C:D:E:P:XX:XY | On Duty | A |
| 032 | Crane Operator | 18 | 87 | 42 | 58 | B:C:D:E:P:XX:XY | Off Duty | A |
| 033 | Roustabout | 19 | 73 | 44 | 58 | B:C:D:E:AN:XX:XY | On Duty | B |
| 034 | Roustabout | 19 | 112 | 41 | 54 | B:C:D:E:AN:XX:XY | Off Duty | B |
| 035 | Bosun | 20 | 87 | 41 | 58 | A:C:D:E:F:W:AT:XX:XY | On Duty | B |
| 036 | Bosun | 20 | 72 | 40 | 52 | A:C:D:E:F:W:AT:XX:XY | Off Duty | B |
| 037 | Deck Seaman | 21 | 87 | 42 | 61 | B:C:D:E:F:X:XX:XY | On Duty | B |
| 038 | Deck Seaman | 21 | 91 | 41 | 58 | B:C:D:E:F:X:XX:XY | Off Duty | B |
| 039 | Ordinary Seaman | 22 | 74 | 40 | 52 | B:C:D:E:Y:XX:XY | On Duty | B |
| 040 | Ordinary Seaman | 22 | 85 | 41 | 54 | B:C:D:E:Y:XX:XY | Off Duty | B |
| 041 | — | — | — | — | — | — | — | — |

Table 7 represents the junction of table 1 and table 6, that is, application of the Initial Fire Station Bill (or other emergency that is not present in table 4) and the list of people on board, thus distributing the initial duties in case of fire emergency.

TABLE 7
PEOPLE ON BOARD LIST -
Fire, intital duties distribution

| | Initial | | | | |
|---|---|---|---|---|---|
| Person | duty | Function | | Initial | Station, |
| ID | ID | name | Condition | duty | initial team |
| 001 | 01 | Captain | On Duty | Overall | Ship's |
| | | | | command | Bridge |
| 002 | 02 | Chief | On Duty | In charge | Engine |
| | | Engineer | | of the | Room |
| | | | | Engine Room | |
| 003 | 03 | Chief | On Duty | On scene | Accident |
| | | Officer | | commander | Scene |
| 004 | 04 | 2nd | On Duty | Vessel | Ship's |
| | | Officer | | control | Bridge |
| 005 | 05 | 2nd | Off Duty | Maintains | Reserve |
| | | Officer | | order and | on |
| | | | | communication | lifeboat 4 |
| 006 | 06 | Motorman | On Duty | Alternative | Fire |
| | | | | leader, | Team 1 |
| | | | | wearing fire-suit 1 | |
| 007 | 07 | Motorman | Off Duty | Wait for | Reserve |
| | | | | instructions | on |
| | | | | | lifeboat 4 |
| 008 | 05 | Safety | On Duty | Maintains | Reserve |
| | | Training | | order and | on |
| | | Supervisor | | communication | lifeboat 1 |
| 009 | 07 | Safety | Off Duty | Wait for | Reserve |
| | | Training | | instructions | on |
| | | Supervisor | | | lifeboat 4 |
| 010 | 08 | Engine | On Duty | Wearfire-suit 2, | Fire |
| | | Oiler | | hold fire | Team 1 |
| | | | | hose nozzle | |
| 011 | 07 | Engine | Off Duty | Wait for | Reserve |
| | | Oiler | | instructions | on |
| | | | | | lifeboat 4 |
| 012 | 09 | 2nd | On Duty | Assist Chief | Engine |
| | | Engineer | | Engineer | Room |
| 013 | 10 | Radio | On Duty | Maintain | Ship's |
| | | Operator | | communications | Bridge |
| 014 | 10 | Radio | Off Duty | Maintain | Ship's |
| | | Operator | | communications | Bridge |
| 015 | 07 | 2nd | Off Duty | Wait for | Reserve |
| | | Engineer | | instructions | on |
| | | | | | lifeboat 1 |
| 016 | 11 | 3rd | Off Duty | Fire Team | Fire |
| | | Engineer | | Leader | Team 2 |
| 017 | 11 | 3rd | On Duty | Fire Team | Fire |
| | | Engineer | | Leader | Team 1 |
| 018 | 12 | Mechanic | On Duty | Open, close | Fire |
| | | | | fire valve | Team 1 |
| 019 | 07 | Mechanic | Off Duty | Wait for | Reserve |
| | | | | instructions | on |
| | | | | | lifeboat 1 |
| 020 | 13 | Electrician | On Duty | Help put | Fire |
| | | | | fire-suit 2, | Team 1 |
| | | | | hold fire hose | |
| 021 | 07 | Electrician | Off Duty | Wait for | Reserve |
| | | | | instructions | on |
| | | | | | lifeboat 1 |
| 022 | 14 | Engine | On Duty | Help put | Fire |
| | | Wiper | | fire-suit 1, | Team 1 |
| | | | | hold fire hose | |
| 023 | 07 | Engine | Off Duty | Wait for | Reserve |
| | | Wiper | | instructions | on |
| | | | | | lifeboat 4 |
| 024 | 15 | Nurse | On Duty | Stand-by | Hospital |
| | | | | to attend | |
| | | | | accidents | |
| 025 | 13 | Electro- | On Duty | Help put | Fire |
| | | Technician | | fire-suit 2, | Team 2 |
| | | | | hold fire hose | |
| 026 | 07 | Electro- | Off Duty | Wait for | Reserve |
| | | Technician | | instructions | on |
| | | | | | lifeboat 4 |
| 027 | 12 | Assistant | On Duty | Open, close | Fire |
| | | Mechanic | | fire valve | Team 2 |
| 028 | 07 | Assistant | Off Duty | Wait | Reserve |
| | | Mechanic | | for | on |
| | | | | instructions | lifeboat 4 |
| 029 | 06 | Deck | On Duty | Alternative | Fire |
| | | Supervisor | | leader, wearing | Team 2 |
| | | | | fire-suit 1 | |
| 030 | 07 | Deck | Off Duty | Wait for | Reserve |
| | | Supervisor | | instructions | on |
| | | | | | lifeboat 4 |
| 031 | 14 | Crane | On Duty | Help put | Fire |
| | | Operator | | fire-suit 1, | Team 2 |
| | | | | hold fire hose | |
| 032 | 07 | Crane | Off Duty | Wait for | Reserve |
| | | Operator | | instructions | on |
| | | | | | lifeboat 4 |
| 033 | 08 | Roustabout | On Duty | Wear fire-suit 2, | Fire |
| | | | | hold fire | Team 2 |
| | | | | hose nozzle | |
| 034 | 07 | Roustabout | Off Duty | Wait for | Reserve |
| | | | | instructions | on |
| | | | | | lifeboat 4 |
| 035 | 07 | Bosun | On Duty | Wait for | Reserve |
| | | | | instructions | on |
| | | | | | lifeboat 1 |
| 036 | 07 | Bosun | Off Duty | Wait for | Reserve |
| | | | | instructions | on |
| | | | | | lifeboat 4 |
| 037 | 07 | Deck | On Duty | Wait for | Reserve |
| | | Seaman | | instructions | on |
| | | | | | lifeboat 1 |
| 038 | 07 | Deck | Off Duty | Wait for | Reserve |
| | | Seaman | | instructions | on |
| | | | | | lifeboat 4 |
| 039 | 07 | Ordinary | Always | Wait for | Reserve |
| | | Seaman | | instructions | on |
| | | | | | lifeboat 1 |
| 040 | 07 | Ordinary | Always | Wait for | Reserve |
| | | Seaman | | instructions | on |
| | | | | | lifeboat 1 |
| 041 | — | — | — | — | — |
| — | 07 | All other | Always | Wait for | Assigned |
| | | persons | | instructions | lifeboat |

Table 8 represents the junction of table 2 and table 6, that is, the application of the Initial Abandonment Station Bill and the list of people on board, thus distributing the initial duties in case of abandonment emergency.

TABLE 8
PEOPLE ON BOARD LIST- Abandon, initial duties distribution

| Person | Initial | Function | | | Station, |
|---|---|---|---|---|---|
| ID | duty ID | name | Condition | Initial duty | Initial team |
| 001 | 01 | Captain | Always | In charge | Lifeboat 1 |
| 002 | 02 | Chief | Always | Prepares | Lifeboat 1 |
| | | Engineer | | the engine | |
| 003 | 01 | Chief | Always | In | Lifeboat 4 |
| | | Officer | | charge | |
| 004 | 03 | 2nd | On Duty | Maintains | Lifeboat 1 |
| | | Officer | | order and | |
| | | | | communication | |
| 005 | 03 | 2nd | Off Duty | Maintains | Lifeboat 4 |
| | | Officer | | order and | |
| | | | | communication | |
| 006 | 08 | Motorman | On Duty | Wait for | Lifeboat 1 |
| | | | | instructions | |
| 007 | 08 | Motorman | Off Duty | Wait for | Lifeboat 4 |
| | | | | instructions | |
| 008 | 05 | Safety | On Duty | Help at the | Lifeboat 1 |
| | | Training | | muster point | |
| | | Supervisor | | | |
| 009 | 05 | Safety | Off Duty | Help at the | Lifeboat 4 |
| | | Training | | muster point | |
| | | Supervisor | | | |
| 010 | 08 | Engine | On Duty | Wait for | Lifeboat 1 |
| | | Oiler | | instructions | |
| 011 | 08 | Engine | Off Duty | Wait for | Lifeboat 4 |
| | | Oiler | | instructions | |
| 012 | 02 | 2nd | Off Duty | Prepares | Lifeboat 4 |
| | | Engineer | | the engine | |
| 013 | 07 | Radio | On Duty | Brings | Lifeboat 1 |
| | | Operator | | GMDSS | |
| | | | | equipment | |
| 014 | 07 | Radio | Off Duty | Brings | Lifeboat 4 |
| | | Operator | | GMDSS | |
| | | | | equipment | |
| 015 | 08 | 2nd | On Duty | Wait for | Lifeboat 1 |
| | | Engineer | | instructions | |
| 016 | 08 | 3rd | Off Duty | Wait for | Lifeboat 1 |
| | | Engineer | | instructions | |
| 017 | 08 | 3rd | On Duty | Wait for | Lifeboat 4 |
| | | Engineer | | instructions | |
| 018 | 08 | Mechanic | Always | Wait for | Lifeboat 1 |
| | | | | instructions | |
| 019 | 08 | Mechanic | Always | Wait for | Lifeboat 1 |
| | | | | instructions | |
| 020 | 08 | Electrician | Always | Wait for | Lifeboat 1 |
| | | | | instructions | |
| 021 | 08 | Electrician | Always | Wait for | Lifeboat 1 |
| | | | | instructions | |
| 022 | 08 | Engine | Always | Wait for | Lifeboat 4 |
| | | Wiper | | instructions | |
| 023 | 08 | Engine | Always | Wait for | Lifeboat 4 |
| | | Wiper | | instructions | |
| 024 | 08 | Nurse | Always | Wait for | Lifeboat 1 |
| | | | | instructions | |
| 025 | 08 | Electro- | Always | Wait for | Lifeboat 4 |
| | | Technician | | instructions | |
| 026 | 08 | Electro- | Always | Wait for | Lifeboat 4 |
| | | Technician | | instructions | |
| 027 | 08 | Assistant | Always | Wait for | Lifeboat 4 |
| | | Mechanic | | instructions | |
| 028 | 08 | Assistant | Always | Wait for | Lifeboat 4 |
| | | Mechanic | | instructions | |
| 029 | 08 | Deck | Always | Wait for | Lifeboat 4 |
| | | Supervisor | | instructions | |
| 030 | 08 | Deck | Always | Wait for | Lifeboat 4 |
| | | Supervisor | | instructions | |
| 031 | 08 | Crane | Always | Wait for | Lifeboat 4 |
| | | Operator | | instructions | |
| 032 | 08 | Crane | Always | Wait for | Lifeboat 4 |
| | | Operator | | instructions | |
| 033 | 08 | Roustabout | Always | Wait for | Lifeboat 4 |
| | | | | instructions | |
| 034 | 08 | Roustabout | Always | Wait for | Lifeboat 4 |
| | | | | instructions | |
| 035 | 04 | Bosun | On Duty | Prepares lifeboat | Lifeboat 1 |
| | | | | for launch | |
| 036 | 04 | Bosun | Off Duty | Prepares lifeboat | Lifeboat 4 |
| | | | | for launch | |
| 037 | 06 | Deck | On Duty | Help preparing | Lifeboat 1 |
| | | Seaman | | lifeboat | |
| 038 | 06 | Deck | Off Duty | Help preparing | Lifeboat 4 |
| | | Seaman | | lifeboat | |
| 039 | 08 | Ordinary | Always | Wait for | Lifeboat 1 |
| | | Seaman | | instructions | |
| 040 | 08 | Ordinary | Always | Wait for | Lifeboat 1 |
| | | Seaman | | instructions | |
| 041 | — | — | — | — | — |
| — | 08 | All | Always | Wait for | Assigned |
| | | other | | instructions | lifeboat |
| | | persons | | | |

Table 9 shows an example table of courses and certificates with the codes assigned for reference and for the purpose that each course and certificate have for function formation, duty in emergency or other.

TABLE 9
PEOPLE ON BOARD LIST - Coding and division of certificates and courses

| | | Time of | Time of | | | |
|---|---|---|---|---|---|---|
| | | validity | renewal | | Defines | |
| | | expressed | expressed | Defines | emergency | |
| Code | Course or certificate name | in months | in months | functions | duties | Other |
| A | Advanced Firefighting course | — | — | | ✓ | |
| B | Basic Firefighting course | — | — | | ✓ | |
| C | Basic First Aid course | — | — | | ✓ | |
| D | Personal Safety and Social Responsibility | — | — | | ✓ | |
| E | Personal Survival Techniques | — | — | | ✓ | |
| F | Survival Craft and Rescue Bouts | — | — | | ✓ | |
| G | PEI - Individual Emergency Plan | — | — | | ✓ | |
| H | Electrical Installations Basic course | — | — | | ✓ | |
| I | Fast Rescue Boat course | — | — | | ✓ | |
| J | Offshore Radio Operator course | — | — | | ✓ | |
| K | Ship Security Officer - ISPS CODE | — | — | | ✓ | |
| L | GMDSS Radio Operator course | — | — | ✓ | ✓ | |
| M | Advanced First Aid course | — | — | | ✓ | |
| N | Confined Space entry 16 h | — | — | | ✓ | |
| O | Confined Space 40 h - supervisor | — | — | | ✓ | |
| P | Crane Operator course | — | — | ✓ | | |
| Q | Explosive area | — | — | | ✓ | |
| R | Work at height | — | — | | | ✓ |
| S | Rescue at height | — | — | | ✓ | |
| T | STCW II/2 - Captain | — | — | ✓ | ✓ | |
| U | STCW II/1 - Chief Officer | — | — | ✓ | ✓ | |
| V | STCW II/1 - 2nd Officer | — | — | ✓ | ✓ | |
| W | STCW II/5 Bosun | — | — | ✓ | ✓ | |
| X | STCW II/4 Deck seaman | — | — | ✓ | ✓ | |
| Y | STCW II/4 Ordinary seaman | — | — | ✓ | ✓ | |
| Z | STCW III/2 Chief Engineer | — | — | ✓ | ✓ | |
| AA | STCW III/2 2nd Engineer | — | — | ✓ | ✓ | |
| AB | STCW III/1 3rd Engineer | — | — | ✓ | ✓ | |
| AC | STCW III/7 Electro-Technical Officer | — | — | ✓ | ✓ | |
| AD | Mechanical Supervisor | — | — | ✓ | ✓ | |
| AE | Mechanical Technician | — | — | ✓ | ✓ | |
| AF | Mechanic | — | — | ✓ | ✓ | |
| AG | Assistant Mechanic | — | — | ✓ | ✓ | |
| AH | Electrical Supervisor | — | — | ✓ | ✓ | |
| AI | Electro-Technician | — | — | ✓ | ✓ | |
| AJ | Electrician | — | — | ✓ | ✓ | |
| AK | Assistant Electrician | — | — | ✓ | ✓ | |
| AL | Doctor | — | — | ✓ | ✓ | |
| AM | Nurse | — | — | ✓ | ✓ | |
| AN | Roustabout | — | — | ✓ | ✓ | |
| AO | Deck Supervisor certificate (company level) | — | — | ✓ | ✓ | |
| AP | Safety Training Supervisor | — | — | ✓ | ✓ | |
| AQ | STCW III/4 Engine Wiper | — | — | ✓ | ✓ | |
| AR | STCW III/4 Engine Oiler | — | — | ✓ | ✓ | |
| AS | The STCW III/5 Motorman (CDM) | — | — | ✓ | ✓ | |
| AT | Supervisor Course (company level) | — | — | | ✓ | |
| AU | — | — | — | — | — | — |
| XX | Familiarization with the vessel | — | — | ✓ | ✓ | |
| XY | Familiarization with the safety company standards | — | — | ✓ | ✓ | |
| XZ | — | — | — | — | — | — |

Table 10 shows teams present in the Initial Station Bill (not considering H2S and CH4, as these are muster points for which people on board must go in case of a gas alert. Each person on board must go to the nearest point to its location according to the instructions given in the Initial Station Bill). The vessel may have more than one muster point in case of gas leak.

TABLE 10
PEOPLE ON BOARD LIST - Initial teams

| Emergency | Team | |
|---|---|---|
| ID | ID | Team |
| 001 | 01 | Fire Team 1 |
| 001 | 02 | Fire Team 2 |
| 001 | 03 | Ship's Bridge |
| 001 | 04 | Engine Room |
| 001 | 05 | Accident Scene |
| 001 | 06 | Reserve on lifeboat 1 |
| 001 | 07 | Reserve on lifeboat 4 |
| 001 | 08 | Hospital |
| 002 | 01 | Lifeboat 1 |
| 002 | 02 | Lifeboat 4 |
| 003 | 01 | Man Overboard |
| 004 | — | — |

Table 11 represents an example list of certificates and courses required to perform a specific function on the vessel used in present patent application.

TABLE 11
PEOPLE ON BOARD LIST - Functions and certificates

| Function | | Certificate or course code |
|---|---|---|
| ID | Function name | required to exercise a function |
| 01 | Mechanic | B:C:D:E:AF:XX:XY |
| 02 | Electrician | B:C:D:E:H:AJ:XX:XY |
| 03 | Engine Wiper | B:C:D:E:AQ:XX:XY |
| 04 | Captain | A:C:D:E:T:XX:XY |
| 05 | Chief Engineer | A:C:D:E:Z:XX:XY |
| 06 | Chief Officer | A:C:D:E:U:XX:XY |
| 07 | 2nd Officer | A:C:D:E:V:XX:XY |
| 08 | Motorman | A:C:D:E:AS:XX:XY |
| 09 | Safety Training Supervisor | A:C:D:E:AP:XX:XY |
| 10 | Engine Oiler | B:C:D:E:AR:XX:XY |
| 11 | 2nd Engineer | A:C:D:E:AA:XX:XY |
| 12 | Radio Operator | B:C:D:E:L!J:XX:XY |
| 13 | 3rd Engineer | A:C:D:E:AB:XX:XY |
| 14 | Nurse | B:C:D:E:M:AM:XX:XY |
| 15 | Electro-Technician | B:C:D:E:AI:XX:XY |
| 16 | Assistant Mechanic | B:C:D:E:AG:XX:XY |
| 17 | Deck Supervisor | A:C:D:E:AO:XX:XY |
| 18 | Crane Operator | B:C:D:E:P:XX:XY |
| 19 | Roustabout | B:C:D:E:AN:XX:XY |
| 20 | Bosun | A:C:D:E:W:XX:XY |
| 21 | Deck Seaman | B:C:D:E:X:XX:XY |
| 22 | Ordinary Seaman | B:C:D:E:Y:XX:XY |
| 23 | — | — |

Table 12 is an example of a possible separation between the duties in an emergency that are function dependent (column 6) and those that are not based on the function of the person on board (column 5). In this table, it is clear that, on the general command, according to the choice of those in charge, there will be the captain or commander, but if he is unable, the maritime hierarchy will put in from the second place the chief officer one who will assume the position of the captain and exercise the general command duty. Table 13 refers to this hierarchy.

TABLE 12
PEOPLE ON BOARD LIST - Separation of duties and certificates in emergency as per the Initial Station Bill

| | | | | Depends on | Depends | Certificate or course |
|---|---|---|---|---|---|---|
| | Initial | | | the safety | on the | code required to |
| Emergency | duty | | | responsible | function | perform emergency |
| ID | ID | Quantity | Duty | person choice | and hierarchy | duty |
| 001 | 01 | 1 | Overall command | | ✓ | A:C:D:E:T:XX:XY |
| 001 | 02 | 1 | In charge of the Engine Room | | ✓ | A:C:D:E:Z:XX:XY |
| 001 | 03 | 1 | On scene commander | | ✓ | A:C:D:E:U:XX:XY |
| 001 | 04 | 1 | Vessel control | | ✓ | A:C:D:E:V:XX:XY |
| 001 | 05 | 2 | Maintains order and communication | ✓ | | A:C:D:E:V!AP:XX:XY |
| 001 | 06 | 2 | Alternative leader, wearing fire-suit 1 | ✓ | | A:C:D:E:AS!AO:XX:XY |
| 001 | 08 | 2 | Wear fire-suit 2, hold fire hose nozzle | ✓ | | B:C:D:E:AR!AN:XX:XY |
| 001 | 09 | 1 | Assist Chief Engineer | | ✓ | A:C:D:E:AA:XX:XY |
| 001 | 10 | 2 | Maintain communications | | ✓ | B:C:D:E:L!J:XX:XY |
| 001 | 11 | 2 | Fire Team Leader | ✓ | | A:C:D:E:AB:XX:XY |
| 001 | 12 | 2 | Open, close fire valve | ✓ | | B:C:D:E:AF!AG:XX:XY |
| 001 | 13 | 2 | Help put fire-suit 2, hold fire hose | ✓ | | B:C:D:E:AJ!AI:XX:XY |
| 001 | 14 | 2 | Help put fire-suit 1, hold fire hose | ✓ | | B:C:D:E:AQ!P:XX:XY |
| 001 | 15 | 1 | Stand-by to attend accidents | | ✓ | B:C:D:E:M:AM:XX:XY |
| 001 | 07 | — | Wait for instructions | ✓ | | |
| 001 | 16 | — | Assigned lifeboat | ✓ | | |
| 002 | 01 | 2 | In charge | | ✓ | A:C:D:E:F:T!U:XX:XY |
| 002 | 02 | 2 | Prepares the engine | | ✓ | A:C:D:E:F:Z!AA:XX:XY |
| 002 | 03 | 2 | Maintains order and communication | ✓ | | A:C:D:E:F:V:XX:XY |
| 002 | 04 | 2 | Prepares lifeboat for launch | | ✓ | A:C:D:E:F:W:XX:XY |
| 002 | 05 | 2 | Help at the muster point | ✓ | | A:C:D:E:AP:XX:XY |
| 002 | 06 | 2 | Help preparing lifeboat | | ✓ | B:C:D:E:F:X:XX:XY |
| 002 | 07 | 2 | Brings GMDSS equipment | | ✓ | B:C:D:E:L!J:XX:XY |
| 002 | 08 | — | Wait for instructions | ✓ | | |
| 002 | 09 | — | Assigned lifeboat | ✓ | | |
| 003 | 01 | 1 | In charge of the fast rescue boat | ✓ | | — |
| 003 | 02 | 3 | Crew | ✓ | | — |
| 003 | 03 | 2 | Prepares launch and hold of the fast rescue boat | ✓ | | — |
| 004 | — | — | — | — | — | — |

Table 13 represents an example of a hierarchy of courses and certificates used on board of vessels, which serve as reference in case of automatic substitution of duty by hierarchy.

TABLE 13
PEOPLE ON BOARD LIST - Hierarchy of courses and certificates

| Hierarchy | Certificate | | |
|---|---|---|---|
| Group ID | code | Certificate or course | Level |
| 01 | T | STCW II/2 - Captain | 6 |
| | U | STCW II/1 - Chief Officer | 5 |
| | V | STCW II/1 - 2nd Officer | 4 |
| | W | STCW II/5 Bosun | 3 |
| | X | STCW II/4 Deck Seaman | 2 |
| | Y | STCW II/4 Ordinary Seaman | 1 |
| 02 | Z | STCW III/2 Chief Engineer | 6 |
| | AA | STCW III/2 2nd Engineer | 5 |
| | AB | STCW III/1 3rd Engineer | 4 |
| | AS | STCW III/5 Motorman | 3 |
| | AR | STCW III/4 Engine Oiler | 2 |
| | AQ | STCW III/4 Engine Wiper | 1 |
| 03 | AD | Mechanical Supervisor | 4 |
| | AE | Mechanical Technician | 3 |
| | AF | Mechanic | 2 |
| | AG | Assistant Mechanic | 1 |
| 04 | AH | Electrical Supervisor | 5 |
| | AC | STCW III/7 Electro-Technical Officer | 4 |
| | AI | Electro-Technician | 3 |
| | AJ | Electrician | 2 |
| | AK | Assistant Electrician | 1 |
| 05 | AO | Deck Supervisor | 3 |
| | P | Crane Operator | 2 |
| | AN | Roustabout | 1 |
| 06 | — | Safety Engineer | 3 |
| | AP | Safety Training Supervisor | 2 |
| | — | Assistant Safety Training Supervisor | 1 |
| 07 | J | Offshore Radio Operator | 2 |
| | L | Radio Operator | 1 |
| 08 | AL | Doctor | 2 |
| | AM | Nurse | 1 |
| 09 | A | Advanced Firefighting course | 2 |
| | B | Basic Firefighting course | 1 |
| 10 | M | Advanced First Aid course | 2 |
| | C | Basic First Aid course | 1 |
| 11 | — | — | — |
| | — | — | — |

Step C (3)—Make available the work permit form, to register the work permits and the necessary information found in the further attachments of the same. The work permit is a form that can be filled by hand or electronically, containing a set of control measures aimed to develop safe work, in addition to emergency and rescue measures. Several other documents can be attached, one of the main required is job safety analysis. The essential data for the normal operation of the Dynamic Station Bill used in these forms are shown in table 14. The job safety analysis contains all the work separate in phases or steps (see table 14, column 9). For each of these steps a specific safety time can be added to safely leave the work in case of emergency (see table 14, column 11). Permission to work with all attachments is intended to enable work in hazardous areas for authorized people for a specified period. The whole vessel is considered an area of risk, so that all the work, which takes a considerable amount of time (for example, more than 5 seconds) for the person on board to abandon the task in progress safely and participate to an emergency, is justified by an open work permit, always discriminating this safety time referenced to each phase or step described in the job safety analysis. There are several types of work permits, for example: hot work, cold work, confined space, work at height, work in explosive/radioactive area, work with chemicals, work over the sea, handling of dangerous or heavy loads etc.

All permissions form a list in which the permission can have as reference the ordinal number in the list or a generated code added to each permission in this list (see table 14, column 1) as identifier “ID” for the purpose of refer to it in the communications between the Emergency Management System modules. Table 14 refers to a work permit of “ID 002” which is of “Hot” type, which means that sparks, heat or flame are generated in this work. A job of this kind needs a fire watch selected just for this purpose. The guard, in this case, is the embarked person with the “ID 003”. In the same table, column 11 shows the safety time, which is the time required for embarked person to leave work and location in the safe manner.

This means that everyone who passes through this place will not be exposed to any risk of accident caused by this same job that has been stopped, and it is also understood that no harm or emergency or risk can develop due to stopped work in case of an emergency. However, it is not always possible to stop a job. For example, moving heavy or dangerous cargo on vessels may take longer than is usually foreseen, because of vessel stability or balance. In cases like this, the safety time can be very high, or the step of the work permit cannot be stopped. Thus, the whole team or the person working will be excluded from the possible emergency or training. The example for the work permit step that cannot be stopped is the work permit of “ID 003”, which has the “x” mark in the safety time column 11. The only emergency that excludes no one is abandonment. Safety time is estimated according to the description and detailed work analysis with the participation of all involved, supervisors, managers, executors, fire watchers and other participants. The data presented in table 14 are used in calculations of times, escape routes and redistribution of duties.

Table 14 represents required data provided in the work permit and job safety analysis for the normal operation of the Emergency Management System, adding the safety time proposed by this system.

TABLE 14
WORK PERMITS - Current work permissions

| | | | | | | | Schedule | | | |
|---|---|---|---|---|---|---|---|---|---|---|
| | | | Responsible | | Fire | Others | from-to | Current | | Security |
| | | Site | Person | | guard | Involved | expressed | step/ | | time |
| ID | Type | ID | ID | Job Name | ID | ID | in hours | total | Condition | S |
| 001 | Cold | 025 | 043 | — | | — | 12-00 | 03/05 | Open | 30 |
| 002 | Hot | 015 | 050 | Weld inside the fuel tank | 022 | — | 12-00 | 08/05 | Open | 160 |
| 003 | Cold | 045 | 061 | — | | — | 12-00 | 02/03 | Open | X |
| 004 | Cold | 018 | 033 | Cleaning the cement silo | | 044 | 12-00 | 08/11 | Open | 120 |
| 005 | Cold | — | — | — | | — | 12-00 | — | — | 0 |
| 006 | — | — | — | — | — | — | — | — | — | — |

Step D (4)—Maintain communication between system modules to manually identify or through automatic scanning the embarked persons position, confirming their presence in the locations, and the position of each Security Asset (12) that has the RFID tags or Bluetooth Beacon (tags).

On this step, the Scanning Module with Camera (15) receives the “ID” identifiers of the people and Security Assets found in range. The location and position (see tables 15, 16 and 17) required for the calculations are added to the people's identifiers and Security Assets (see FIG. 1, item 8). The Field Module (13), Smart Portable Radio Module (14) and Authorized Computers (10b) send the “ID” identifiers of the persons using them to the Control and Monitoring Modules (10, 10a). Cameras are used to check for possible emergency location and the state of escape routes. For the formation of the list of dynamic duties, in addition to other data, it is essential to obtain real-time positioning of the embarked persons and Security Assets (see Table 15, 16 and 17). Data present in table 15 and 17 will be used for calculations of time, escape routes and redistribution of duties, thus enabling the formation of the Emergency Management System, which has a Dynamic Station Bill that is constantly updated with one or more active emergencies or not.

Table 15 shows the positioning of the people on board detected with the Scanning Modules to be used in the calculation of escape routes.

TABLE 15
POSITIONING - Persons

| | | | | | Person relative |
|---|---|---|---|---|---|
| Person | | | Site | | position in |
| position | Person | Site | position | | Cartesian |
| ID | ID | ID | ID | Site name | coordinates m |
| E018 | 018 | 025 | C049 | Main Deck aft port | 10:5:0 |
| E020 | 020 | 045 | C102 | Electrical Workshop | 5:10:0 |
| E022 | 022 | 015 | C063 | Main Deck | 6:8:10 |
| | | | | starboard bow | |
| E023 | — | — | — | — | — |

Table 16 shows the detected position of the mobile and removable Security Assets. The Smart Portable Radio can identify the embarked person, because it is for personal use and it is a necessary equipment for use in emergency.

TABLE 16
POSITIONING - Mobile and removable Security Assets, detected position

| | | | | | | Mobile asset |
|---|---|---|---|---|---|---|
| | | | | | | relative position |
| Asset | | | | Site | | in Cartesian |
| position | Asset | | Site | position | | coordinates |
| ID | ID | Asset name | ID | ID | Site name | m |
| M001 | 001 | — | — | — | | — |
| M002 | — | 1 Fire Extinguisher | — | — | | — |
| M003 | — | 2 Fire Extinguisher | — | — | | — |
| M004 | — | GMDSS equipment 1 | — | C087 | Room radio | — |
| M005 | — | Smart Portable Radio ID 001 | — | C063 | Main Deck starboard bow | — |
| M006 | — | — | — | — | | — |

Table 17 shows the detected position of the fixed assets also used as fixed or additional muster points selected by the person in charge.

TABLE 17
POSITIONING - Fixed Security Assets

| | | | | | | Fixed assets |
|---|---|---|---|---|---|---|
| | | | | | | relative |
| Fixed | | | | | | position |
| asset | Fixed | | | Site | | In Cartesian |
| position | asset | | Site | position | | coordinates |
| ID | ID | Asset name | ID | ID | Site name | m |
| F001 | 001 | Fire hose locker 1 | — | — | — | — |
| F002 | — | Fire Pump 1 | — | — | — | — |
| F003 | — | Fireman's locker 1 | — | C017 | Fire team 1 muster point | — |
| F004 | — | Field Module ID 001 | — | C017 | Fire team 1 muster point | — |
| F005 | — | Field Module ID 002 | — | C018 | Fire team 2 muster point | — |
| F006 | — | Field Module ID 003 | — | C019 | Ship's Bridge muster point | — |
| F007 | — | Field Module ID 004 | — | C020 | Engine room muster point | — |
| F008 | — | Field Module ID 005 | — | C021 | Lifeboat 1 muster point | — |
| F009 | — | Field Module ID 006 | — | C022 | Lifeboat 2 muster point | — |
| F010 | — | Field Module ID 007 | — | C023 | Lifeboat 3 muster point | — |
| F011 | — | Field Module ID 008 | — | C024 | Lifeboat 4 muster point | — |
| F012 | — | Field Module ID 009 | — | C025 | Nursery muster point | — |
| F013 | — | Field Module ID 010 | — | C016 | Fast rescue boat muster point | — |
| F014 | — | — | — | — | — | — |

Step E (5)—Maintain communication between system modules to obtain information on vessel stability, weather conditions, potentially dangerous events, beginning of possible emergency, faults and other events. In this communication process, are obtained vessel or emergency factors automatically reported by the Sensor Modules (16), informed or confirmed by the Scanning Modules with Camera (15) or informed by the person on board via Field Modules (13), Smart Portable Radio Module (14), Control and Monitoring Module (10, 10a) or Authorized Computers (10b).

At this stage, the sensors alert us so that a decision can be made regarding the emergency that may develop or is already present. The sensor with its “ID” is associated with the code of the location of its installation (see table 18, column 4). Thus, in case of an alarm, the location position and the sensor provide necessary data—such as: emergency or alarm type, measurement value and location position—for time calculations and redistribution of duties. All sensors are equipped with LiFePO4 rechargeable batteries and are connected to the vessel's power system and to its own battery charge management system.

The plurality of sensors is divided between the fixed/removable sensors distributed across the vessel and those portable in the smart radio devices (14) of the embarked persons. Sensors present in portable devices detect movements, lack of movement and the speed of movement so that they can later be compared to the one predefined at each access point. The velocities are compared and if necessary, altered with the new measurements, thus approaching the calculation model to the real situation. In addition, the data is being recorded constantly and in case an embarked person is idle for a while or not present among those detected, an alarm is generated. It is also possible to generate alarm if an embarked person is running on the vessel, since such an attitude is prohibited, considering it not suitable and unsafe. An alarm is also generated in the event of an embarked person fall. Other examples of sensors in mobile devices are gas, smoke, heat, etc. The data presented in table 18 are used in calculations of time, escape routes and redistribution of duties.

Table 18 shows a list of sensors and values needed to identify the type and location of the emergency to be verified by cameras or crew before making a final decision.

TABLE 18
SENSORS - Sensors list, position, measurement and alarm

| | | | | | | | Sensor relative | | |
|---|---|---|---|---|---|---|---|---|---|
| | | | | | | | position In | | |
| | | | Site | | Alarm | | Cartesian | | |
| Sensor | Type of | Site | position | | position | Measured | coordinates | Measurement | |
| ID | measurement | ID | ID | Site name | ID | value | m | subtype | Alarm |
| 001 | Level | 021 | C092 | Pump room | | — | 0:10:4 | Flood | |
| 002 | Heat | 030 | C005 | Warehouse 2 | S005 | — | 5:15:4 | A fire | ▴ |
| 003 | Movement | 060 | — | — | | — | 0:1:1 | Pitch | |
| 004 | Movement | 060 | — | — | | — | 0:1:1 | Roll | |
| 005 | Movement | 060 | — | — | | — | 0:1:1 | Heave | |
| 006 | Wind | 040 | — | — | | — | 5:5:1 | Speed | |
| 007 | Wind | 040 | — | — | | — | 5:5:1 | Inlet relative direction | |
| 008 | — | — | — | — | — | — | — | — | — |

Step F (6)—Provide emergency form, to inform the location of the emergency, in real situation, in training or simulation, and what are the restrictions on access to muster points caused by the emergency. At this step, the form may allow the commander or the one responsible for the safety on board to appoint as a muster point any location where a Field Module (13) exists or request that an embarked person with a Smart Portable Radio Module (14) remain in a location that will be named as new muster point (see table 22, column 1).

The Emergency form contains a list of all known and on the vessel trained emergencies (see table 19), unlike the Initial Station Bill, which includes only basic emergencies. All emergencies on this form have for reference the ordinal number present on the list, or a code generated and added to each emergency type of the list as identifier “ID”, with the purpose of referencing it in the communications between modules of the Emergency Management System.

When a sensor detects an alarm (see table 18, column 10) it can be checked by viewing it with the Scanning Modules with Camera (15). As a result, the responsible for safety on board can confirm or reject the emergency (see table 20, column 2). From this form it is possible to announce training or actual emergency selecting location and routes (Access Points) to interdict (see table 21). It is also possible to start a security simulation without, in fact, having to announce the event, as it is calculated according to the current or simulated position of the employees in order to predict security breaches and future unwanted events such as: lack of members in emergency teams, delayed response to emergencies, lack of escape routes, lack of certificates, etc. The simulation is obtained by copying all the data from steps 1 to 9, with the possibility of changing the copied data, in order to reflect the desired situation, thus enabling the execution of the simulation without compromising the real situation.

The Emergency form allows isolating access to the emergency location through the list of accesses to this location or through the graphical presentation with electronic maps installed in the Control and Monitoring Modules (10, 10a) for better visualization of the environment. By interdicting access to the emergency location, these routes will not be included in the time calculations and redistribution of duties (see table 21, column 7) and embarked persons will not be able to use them. The best route will be visible in the system modules used by the embarked persons and designed for this type of visualization, and the interdicted routes will be visible as such.

All teams have a predefined muster point according to the Initial Station Bill (see table 5). This muster point remains the main one, and the one selected by the responsible for safety on board (see table 22) will be the next location to go and start, for example, firefighting. In other emergencies with a fixed main muster point, in this way are given order for after got muster or get equipped to proceed to the location determined by the person in charge (see table 22).

The Emergency Form also contains the characteristics of the Security Assets whose data are used in emergencies and are part of the calculations. As an example, the lifeboats and the contents of the fireman's outfit cabinet (see table 23 and 24). The current SOLAS regulation, Chapter 2, Rule 17 prescribes that all ships must have at least two complete firefighting equipment meeting the following requirements: vessels between 500-2500 tons, at least two sets, vessels between 2500-4000 minimum three sets and for vessels of 4000 tons and more, four sets. The data presented in Tables 19, 20, 21, 22, 23 and 24 are used in calculations of times, escape routes and redistribution of duties.

Table 19 shows all emergencies trained on board of the vessels, depending on the type of vessel.

TABLE 19
EMERGENCIES - Mandatory training cycle, teams and times

| | | | Training | Muster |
|---|---|---|---|---|
| | | Total | cycle | time |
| Emergency | | teams | expressed | limit |
| ID | Emergency name | number | in days | S |
| 001 | Fire | 7 | 7 | 230 |
| 002 | Abandon | 2 | 7 | 300 |
| 003 | Man Overboard | 1 | 30 | 120 |
| 004 | Helicopter crash | — | 60 | — |
| 005 | H2S or CH4 | — | 90 | — |
| 006 | Well control | — | 7 | — |
| 007 | Oil spill | — | 30 | — |
| 008 | Man down | — | 60 | — |
| 009 | ISPS | — | 90 | — |
| 010 | Blackout | — | 180 | — |
| 011 | Confined space | — | 60 | — |
| 012 | Loss of dynamic | — | 90 | — |
| | positioning | | | |
| 013 | Ballast control | — | 60 | — |
| 014 | Loss of steering | — | 90 | — |
| 015 | Uncontrolled drift | — | 180 | — |
| 016 | Collision | — | 90 | — |
| 017 | Rescue from height | — | 365 | — |
| 018 | Radioactive or explosive | — | 365 | — |
| 019 | Electrical shock | — | 365 | — |
| 020 | — | — | — | — |

Table 20 represents the selection of the responsible person according to the emergency alarm that appeared in the position detected by the sensor or manually. In this exemplary case, the sensor in table 18 reported an alarm.

TABLE 20
EMERGENCIES - Fire, alarm condition

| | | | | | Sensor relative |
|---|---|---|---|---|---|
| | | | | | position in |
| Alarm | Acknowl- | Emergency | Site | Position | Cartesian |
| condition | edge | ID | ID | ID | coordinates m |
| Real | ✓ | 01 | 030 | S005 | 5:15:4 |
| Training | | | | | |
| Simulation | | | | | |
| Reject | | | | | |

Table 21 represents the selection of the responsible person for inhibiting the escape route leading to the fire location so that it is not used in the escape route calculations. All options suggested by the Emergency Management System can be automated without the need for acceptance or rejection, depending on the choice of the person responsible for security onboard in the System configuration for each option. Options in team building, muster points, escape routes and choice of Security Assets. The person responsible for the security onboard can always interfere and thus change the automatic choice if necessary.

TABLE 21
EMERGENCIES - Access points, site ID 030

| | | Access point | Interdicted | | | |
|---|---|---|---|---|---|---|
| Access | | position | position | | | |
| point | Access point name | ID | ID | Next site name | Next zone name | Interdicted |
| 1 | Escape Route | C055 | 1055 | The compressor room | Engine Room | ✓ |
| 2 | Door | C095 | | Mechanical Workshop | Main Deck | |
| 3 | Ladder | — | | — | Main Deck | |

Table 22 represents the selection by the responsible for safety on board of the Field Modules near the emergency location where the teams, after properly equipped, should go and start fighting the emergency.

TABLE 22
EMERGENCIES- Nearest Field Modules, local ID 30

| | Field | Muster | | | Nearest | | |
|---|---|---|---|---|---|---|---|
| Field | Module | point | | | access point | | |
| Module | position | position | Site | | position | | Set as next |
| ID | ID | ID | ID | Site name | ID | Team name | muster point |
| 020 | F040 | P040 | 021 | The Pump Room | C092 | Fire Team 1 | ✓ |
| 023 | F048 | P048 | 029 | Mechanical Workshop | C095 | Fire Team 2 | ✓ |
| 030 | — | — | — | Lifeboat 3 | — | — | |
| — | — | | — | — | | — | — |

Table 23 represents values necessary for the selection and calculations about the lifeboats for the abandonment emergency.

TABLE 23
EMERGENCIES - Security Assets, lifeboats, characteristics

| | | | Average | Use the | | | | |
|---|---|---|---|---|---|---|---|---|
| | | | person's mass | average | Davit | Primary | Maximum | Maximum |
| | Person's | Gross mass | for calculation | mass for | capacity | on Station | heel for | trim for |
| Lifeboat | capacity | Kg | Kg | calculation | Kg | Bill | launch | launch |
| 1 | 65 | 2500 | 82.50 | ✓ | 7900 | ✓ | 20° | 17° |
| 2 | 65 | 2500 | 82.50 | ✓ | 7900 | | 20° | 17° |
| 3 | 90 | 3000 | 82.50 | ✓ | 10450 | | 17° | 15° |
| 4 | 90 | 3000 | 82.50 | ✓ | 10450 | ✓ | 17° | 15° |

Table 24 explains what the fireman's outfit cabinet must have, according to SOLAS regulation, fireman's suit and boots numbers available for the calculation of fire team 1 and 2.

TABLE 24
EMERGENCIES - Security Assets, firefighter's locker, content

| | | | | SCBA - | | | Explosion- | Flame- | | |
|---|---|---|---|---|---|---|---|---|---|---|
| | | | | Autonomous | | | proof | proof | Explosive | |
| | Fireman's | Fireman's | Fireman's | Breathing | Fireman's | Fireman's | portable | safety | atmosphere | Safety |
| Locker | suit | boots | Gloves | Apparatus | helmet | ax | flashlight | line | proof radio | belt |
| 1 | 56:60 | 41:43 | 2 | 2 | 2 | 2 | 2 | 2 | 2 | 2 |
| 2 | 58:62 | 42:44 | 2 | 2 | 2 | 2 | 2 | 2 | 2 | 2 |

Step G (7)—Provide the revisions form, to register the dynamic duties that the embarked persons can exercise in the case of the different types of emergencies. These duties are kept up to date by the commander or responsible for safety on board, considering that the more dynamic duties are registered per embarked person, the more flexible or adaptable to any type of emergency the system will be.

The revisions form is a list of people on board with the certificates in possession that authorize them with the legal basis of performing a duty or being part of an emergency team even though not provided for in the Initial Station Bill. Various combinations of certificates for the same duty are possible limiting or extending the option for selection of the embarked persons. The form uses all types of emergencies presented in the Emergency Form (see table 19) and forms all possible routes for all embarked person and all emergencies (see table 32, example for fire emergency only).

The revisions form, as the name itself suggests, is used primarily to delete, change or add duty code, emergency teams code, muster points code; set the sequence in team formation (see Tables 25, 26 and 27); establish times of readiness and preparation for all teams (see table 29, example for fire team only) and the certification required to perform the emergency duty. Formation of the new duty code is necessary, as the fire teams will merge and all duties will be disputed between both teams, thus allowing the choice of better times for the team that is the nearest to emergency location. In our fire emergency example, the fire team 2 will first be set up, which is nearest to the location of the incident. This will start combat or approach first. In the formation of the new duties it is important to establish the minimum certification requirement (see tables 26 and 27, column 6). This requirement serves as a guide and basis for future restrictions or reductions and additions to new dynamic duties (see tables 28 and 30).

As an example of this, duties are added to the reserve team on the lifeboats (see table 28), duty ID 060301, 060401, 060302, 060402, 060303, 060403, 060304 and 060404. These duties are the same as abandonment duties 070201, 070401, 070202, 070402, 070203, 070403, 070204 and 070404. Thus, the basic certificates required for these duties are found in table 27 and copied to table 28 by adding the functions and group hierarchy (see table 28, column 4 and 5) to reflect the desired selection. These duties ensure that the seafarers required to launch the lifeboats in the event of abandonment after the firefighting will be available at the selected muster points and will not be eventually distributed to a fire team. Thus, in the event of a forthcoming abandonment, it is possible to begin with the preparations for the launching of the lifeboats immediately, since the boarding of firefighting personnel and other teams may take place after the launch when the lifeboat is in the water through the rope ladder. The rope ladder is launched at the time of preparation of the lifeboat for launch.

The sequence for the formation of the teams has the function of first forming the vessel command and control teams, necessary to start fighting any type of emergency (see table 25, column 8) with the essential duties to maintain the vessel operational already distributed. It is necessary to determine the readiness and preparation times to be alerted when they are exceeded with the calculated estimates (see table 29), allowing for action and solution as necessary, or by use of the simulation avoid these alarms before a real emergency happens.

For a duty to be considered a dynamic duty, it is necessary to select it from the list of the dynamic duties of an emergency (see table 28, column 6 and table 30, column 8). Successively, it is necessary to select all the duties in the emergencies that each embarked person can execute, or that the responsible for safety on board is going to desire that it is practiced in the trainings or performed in real emergencies. As an example, the embarked person “ID 018” (see table 31, column 9) will dispute three duties with other IDs in “Fire Team 1” (duty ID 030305, 030405 and 030505) in addition to the initial duty (ID 030605), and three duties in “Fire Team 2” (duty ID 030406, 030506 and 030606). If the embarked person does not have the required certificates, or one or more are expired, he or she will not be selected for the dynamic duty which requires them.

Columns 7 and 8 in table 31 show that evidence of training, real situations, and training evaluations is maintained, which helps in the selection of dynamic duties and are part of the filters for calculations and selection of dynamic duties.

Filters are computational algorithms that use the evaluations and statistics of emergencies to select the embarked persons with the best characteristics for an emergency. Evaluation is given by supervisors and team leaders. After each emergency a meeting is held to discuss and evaluate the response of all participants by the responsible supervisors and emergency statistics, such as the number of emergencies attended is automatically changed after it has ended.

After resolving the union of the teams and meeting points (see table 25), forming new duties with minimum certification for the fire emergency (see table 26), using the Initial Fire Station Bill (see table 7), all the possible routes for the fire emergency are formed (see table 32). Table 32 is used later in combination with other tables to calculate the routes of the dynamic duties. The data present in tables 28, 29, 30, 31, 32 are used in calculations of times, escape routes and redistribution of duties.

Table 25 refers to revisions made to the Initial Station Bill, so that the Dynamic Station Bill is correctly interpreted and calculated.

TABLE 25
REVISIONS - Teams, teams union and muster points

| New | | Initial | | | Muster | | Sequence |
|---|---|---|---|---|---|---|---|
| team | Emergency | Team | | New team name for | point | New muster point name | for team's |
| ID | ID | ID | Initial team name | calculation | code | for calculation | formation |
| 01 | 01 | 03 | Ship's Bridge | Ship's Bridge | 07 | Ship's Bridge | 1 |
| 02 | 01 | 05 | Accident Scene | Accident Scene | 08 | On scene | 2 |
| 03 | 01 | 01 | Fire Team 1 | Fire Team | 05 | Firefighter's locker 1 | 6 |
| | | 02 | Fire Team 2 | | 06 | Firefighter's locker 2 | |
| 04 | 01 | 04 | Engine Room | Engine Room | 09 | Engine Room | 3 |
| 05 | 01 | 08 | Hospital | Hospital | 10 | Hospital | 4 |
| 06 | 01 | 06 | Reserve on lifeboat 1 | Reserve on Lifeboat | 01 | Lifeboat 1 | 5 |
| | | | | | 02 | Lifeboat 2 | |
| | | 07 | Reserve on lifeboat 4 | | 03 | Lifeboat 3 | |
| | | | | | 04 | Lifeboat 4 | |
| 07 | 02 | 01 | Lifeboat 1 | Lifeboat | 01 | Lifeboat 1 | 1 |
| | | | | | 02 | Lifeboat 2 | |
| | | 02 | Lifeboat 4 | | 03 | Lifeboat 3 | |
| | | | | | 04 | Lifeboat 4 | |
| 08 | 03 | 01 | Man Overboard | Man Overboard | 11 | Fast rescue boat | 1 |

Tables 26 and 27 show the formation of new duties and the minimum certification required for fire emergency duties. The new duty ID is made up of three codes that are: the team ID, the duty ordinal number on the same team, and the muster point code. All data present in the table are prepared by the company responsible safety persons on board and ashore.

TABLE 26
REVISIONS - Fire, new duties formation and minimum certification

| | | Initial | Muster | | Duty minimum | New |
|---|---|---|---|---|---|---|
| Emergency | Team | duty | point | | certification | Duty |
| ID | ID | ID | code | Initial duty name | requirement | ID |
| 01 | 01 | 01 | 07 | Overall command | A:C:D:E:T:XX:XY | 010107 |
| | | 04 | 07 | Vessel control | A:C:D:E:V:XX:XY | 010207 |
| | | 10 | 07 | Maintain communications | B:C:D:E:L!J:XX:XY | 010307 |
| | 02 | 03 | 08 | On scene commander | A:C:D:E:U:XX:XY | 020108 |
| | 03 | 11 | 05 | Fire Team Leader | A:C:D:E:AT:XX:XY | 030105 |
| | | 06 | 05 | Alternative leader, wearing fire-suit 1 | A:C:D:E:AT:XX:XY | 030205 |
| | | 08 | 05 | Wear fire-suit 2, hold fire hose nozzle | B:C:D:E:XX:XY | 030305 |
| | | 14 | 05 | Help put fire-suit 1, hold fire hose | B:C:D:E:XX:XY | 030405 |
| | | 13 | 05 | Help put fire-suit 2, hold fire hose | B:C:D:E:XX:XY | 030505 |
| | | 12 | 05 | Open, close fire valve | B:C:D:E:XX:XY | 030605 |
| | | 11 | 06 | Fire Team Leader | A:C:D:E:AT:XX:XY | 030106 |
| | | 06 | 06 | Alternative leader, wearing fire-suit 1 | A:C:D:E:AT:XX:XY | 030206 |
| | | 08 | 06 | Wear fire-suit 2, hold fire hose nozzle | B:C:D:E:XX:XY | 030306 |
| | | 14 | 06 | Help put fire-suit 1, hold fire hose | B:C:D:E:XX:XY | 030406 |
| | | 13 | 06 | Help put fire-suit 2, hold fire hose | B:C:D:E:XX:XY | 030506 |
| | | 12 | 06 | Open, close fire valve | B:C:D:E:XX:XY | 030606 |
| | 04 | 02 | 09 | In charge of the Engine Room | A:C:D:E:Z:XX:XY | 040109 |
| | | 09 | 09 | Assist Chief Engineer | A:C:D:E:AA:XX:XY | 040209 |
| | 05 | 15 | 10 | Stand-by to attend accidents | B:C:D:E:M:AM:XX:XY | 050110 |
| | 06 | 05 | 01 | Maintains order and communication | A:C:D:E:AT:XX:XY | 060101 |
| | | 07 | 01 | Wait for instructions | | 060201 |
| | | 05 | 02 | Maintains order and communication | A:C:D:E:AT:XX:XY | 060102 |
| | | 07 | 02 | Wait for instructions | | 060202 |
| | | 05 | 03 | Maintains order and communication | A:C:D:E:AT:XX:XY | 060103 |
| | | 07 | 03 | Wait for instructions | | 060203 |
| | | 05 | 04 | Maintains order and communication | A:C:D:E:AT:XX:XY | 060104 |
| | | 07 | 04 | Wait for instructions | | 060204 |

TABLE 27
REVISIONS - Abandon, new duties formation and minimum certification

| | | Initial | Muster | | Duty minimum | New |
|---|---|---|---|---|---|---|
| Emergency | Team | duty | point | | certification | Duty |
| ID | ID | ID | code | Initial duty name | requirement | ID |
| 02 | 07 | 01 | 01 | In charge | A:C:D:E:F:AT:XX:XY | 070101 |
| | | 02 | 01 | Prepares the engine | A:C:D:E:F:XX:XY | 070201 |
| | | 03 | 01 | Maintains order and communication | A:C:D:E:F:AT:XX:XY | 070301 |
| | | 04 | 01 | Prepares lifeboat for launch | A:C:D:E:F:XX:XY | 070401 |
| | | 05 | 01 | Help at the muster point | A:C:D:E:AT:XX:XY | 070501 |
| | | 06 | 01 | Help preparing lifeboat | B:C:D:E:F:XX:XY | 070601 |
| | | 07 | 01 | Brings GMDSS equipment | B:C:D:E:L!J:XX:XY | 070701 |
| | | 08 | 01 | Wait for instructions | | 070801 |
| | | 01 | 02 | In charge | A:C:D:E:F:AT:XX:XY | 070102 |
| | | 02 | 02 | Prepares the engine | A:C:D:E:F:XX:XY | 070202 |
| | | 03 | 02 | Maintains order and communication | A:C:D:E:F:AT:XX:XY | 070302 |
| | | 04 | 02 | Prepares lifeboat for launch | A:C:D:E:F:XX:XY | 070402 |
| | | 05 | 02 | Help at the muster point | A:C:D:E:AT:XX:XY | 070502 |
| | | 06 | 02 | Help preparing lifeboat | B:C:D:E:F:XX:XY | 070602 |
| | | 07 | 02 | Brings GMDSS equipment | B:C:D:E:L!J:XX:XY | 070702 |
| | | 08 | 02 | Wait for instructions | | 070802 |
| | | 01 | 03 | In charge | A:C:D:E:F:AT:XX:XY | 070103 |
| | | 02 | 03 | Prepares the engine | A:C:D:E:F:XX:XY | 070203 |
| | | 03 | 03 | Maintains order and communication | A:C:D:E:F:AT:XX:XY | 070303 |
| | | 04 | 03 | Prepares lifeboat for launch | A:C:D:E:F:XX:XY | 070403 |
| | | 05 | 03 | Help at the muster point | A:C:D:E:AT:XX:XY | 070503 |
| | | 06 | 03 | Help preparing lifeboat | B:C:D:E:F:XX:XY | 070603 |
| | | 07 | 03 | Brings GMDSS equipment | B:C:D:E:L!J:XX:XY | 070703 |
| | | 08 | 03 | Wait for instructions | | 070803 |
| | | 01 | 04 | In charge | A:C:D:E:F:AT:XX:XY | 070104 |
| | | 02 | 04 | Prepares the engine | A:C:D:E:F:XX:XY | 070204 |
| | | 03 | 04 | Maintains order and communication | A:C:D:E:F:AT:XX:XY | 070304 |
| | | 04 | 04 | Prepares lifeboat for launch | A:C:D:E:F:XX:XY | 070404 |
| | | 05 | 04 | Help at the muster point | A:C:D:E:AT:XX:XY | 070504 |
| | | 06 | 04 | Help preparing lifeboat | B:C:D:E:F:XX:XY | 070604 |
| | | 07 | 04 | Brings GMDSS equipment | B:C:D:E:L!J:XX:XY | 070704 |
| | | 08 | 04 | Wait for instructions | | 070804 |

Table 28 represents the demonstration of the addition of dynamic duties, courses and certificates to the minimum requirement in a fire emergency, thus increasing the options for selection of the embarked persons competing for the redistribution of duties.

TABLE 28
REVISIONS - Fire, dynamic duties

| | | Certificate or | | | |
|---|---|---|---|---|---|
| | | course code | Certificates and | | |
| New duty | | required to perform | courses hierarchy | | Set dynamic |
| ID | New duty name | emergency duty | Group | Level | duty |
| 010107 | Overall command | A:C:D:E:T:XX:XY | | | |
| 010207 | Vessel control | A:C:D:E:V:XX:XY | | | |
| 010307 | Maintain communications | B:C:D:E:L!J:XX:XY | | | |
| 020108 | On scene commander | A:C:D:E:U:XX:XY | | | |
| 030105 | Fire Team Leader | A:C:D:E:AB!AA:AT:XX:XY | 02 | 4:5 | ✓ |
| 030205 | Alternative leader, wearing fire-suit 1 | A:C:D:E:W:AT:XX:XY | | | |
| 030305 | Wear fire-suit 2, hold fire hose nozzle | A!B:C:D:E:XX:XY | 09 | 2 | ✓ |
| 030405 | Help put fire-suit 1, hold fire hose | A!B:C:D:E:XX:XY | 09 | 2 | ✓ |
| 030505 | Help put fire-suit 2, hold fire hose | A!B:C:D:E:XX:XY | 09 | 2 | ✓ |
| 030605 | Open, close fire valve | B:C:D:E:XX:XY | | | ✓ |
| 030106 | Fire Team Leader | A:C:D:E:AB!AA:XX:XY | 02 | 4:5 | ✓ |
| 030206 | Alternative leader, wearing fire-suit 1 | A:C:D:E:XX:XY | | | ✓ |
| 030306 | Wear fire-suit 2, hold fire hose nozzle | A!B:C:D:E:XX:XY | 09 | 2 | ✓ |
| 030406 | Help put fire-suit 1, hold fire hose | B:C:D:E:XX:XY | | | |
| 030506 | Help put fire-suit 2, hold fire hose | B:C:D:E:XX:XY | | | |
| 030606 | Open, close fire valve | B:C:D:E:XX:XY | | | |
| 040109 | In charge of the Engine Room | A:C:D:E:Z:XX:XY | | | |
| 040209 | Assist Chief Engineer | A:C:D:E:AA:XX:XY | | | |
| 050110 | Stand-by to attend accidents | B:C:D:E:M:AM:XX:XY | | | |
| 060101 | Maintains order and communication | A:C:D:E:AP:AT:XX:XY | | | |
| 060201 | Wait for instructions | | | | |
| 060301 | Readiness for launch | A!B:C:D:E:F:W!X:XX:XY | 01\|09 | 2:3\|2 | ✓ |
| 060401 | Readiness to prepare the engine | A!B:C:D:E:F:AS!AR:XX:XY | 02\|09 | 2:3\|2 | ✓ |
| 060102 | Maintains order and communication | A:C:D:E:V:AT:XX:XY | | | |
| 060202 | Wait for instructions | | | | |
| 060302 | Readiness for launch | A!B:C:D:E:F:W!X:XX:XY | 01\|09 | 2:3\|2 | ✓ |
| 060402 | Readiness to prepare the engine | A!B:C:D:E:F:AS!AR:XX:XY | 02\|09 | 2:3\|2 | ✓ |
| 060103 | Maintains order and communication | A:C:D:E:AP:AT:XX:XY | | | |
| 060203 | Wait for instructions | | | | |
| 060303 | Readiness for launch | A!B:C:D:E:F:W!X:XX:XY | 01\|09 | 2:3\|2 | ✓ |
| 060403 | Readiness to prepare the engine | A!B:C:D:E:F:AS!AR:XX:XY | 02\|09 | 2:3\|2 | ✓ |
| 060104 | Maintains order and communication | A:C:D:E:V:AT:XX:XY | | | |
| 060204 | Wait for instructions | | | | |
| 060304 | Readiness for launch | A!B:C:D:E:F:W!X:XX:XY | 01\|09 | 2:3\|2 | ✓ |
| 060404 | Readiness to prepare the engine | A!B:C:D:E:F:AS!AR:XX:XY | 02\|09 | 2:3\|2 | ✓ |

Table 29 represents times evaluated based on experience for the calculation of the preparation time and selection of team members, as well as for alarming purpose if the preparation time is exceeded.

TABLE 29
REVISIONS - Fire Team ID 003, calculation times

| New | | Readiness | Maximum | |
|---|---|---|---|---|
| duty | | target | readiness | Preparation |
| ID | New duty name | time s | time s | time limit s |
| 030105 | Fire Team Leader | 180 | 230 | 10 |
| 030205 | Alternative leader, wearing fire-suit 1 | 200 | 230 | 60 |
| 030305 | Wear fire-suit 2, hold fire hose nozzle | 200 | 230 | 60 |
| 030405 | Help put fire-suit 1, hold fire hose | 200 | 230 | 60 |
| 030505 | Help put fire-suit 2, hold fire hose | 200 | 230 | 60 |
| 030605 | Open, close fire valve | 180 | 230 | 10 |
| 030106 | Fire Team Leader | 180 | 230 | 10 |
| 030206 | Alternative leader, wearing fire-suit 1 | 200 | 230 | 60 |
| 030306 | Wear fire-suit 2, hold fire hose nozzle | 200 | 230 | 60 |
| 030406 | Help put fire-suit 1, hold fire hose | 200 | 230 | 60 |
| 030506 | Help put fire-suit 2, hold fire hose | 200 | 230 | 60 |
| 030606 | Open, close fire valve | 180 | 230 | 10 |

Table 30 represents a demonstration of the addition of dynamic duties, courses and certificates to the minimum requirement in abandonment emergency, thus increasing the selection option of embarked persons for the redistribution of duties. For better selection of the application of dynamic duty, the duties were classified into three groups of importance (columns 5, 6 and 7).

TABLE 30
REVISIONS - Abandon, dynamic duties

| New | Certificate or course code | Certificates and | | | | | Set |
|---|---|---|---|---|---|---|---|
| duty | required to perform | courses hierarchy | | Duty classification at the muster point | | | dynamic |
| ID | emergency duty | Group | Level | Navigation | Organization | Launch | duty |
| 070101 | A:C:D:E:F:T!U!V!W:AT:XX:XY | 01 | 3:4:5:6 | ✓ | | | ✓ |
| 070201 | A:C:D:E:F:Z!AA!AB:XX:XY | 02 | 4:5:6 | | | ✓ | ✓ |
| 070301 | A:C:D:E:F:V!U!T:AT:XX:XY | 01 | 4:5:6 | | ✓ | | ✓ |
| 070401 | A:C:D:E:F:X!W!V!U:XX:XY | 01 | 2:3:4:5 | | | ✓ | ✓ |
| 070501 | A:C:D:E:AP:AT:XX:XY | | | | ✓ | | |
| 070601 | B:C:D:E:F:X!W!V:XX:XY | 01 | 2:3:4 | | | ✓ | ✓ |
| 070701 | B:C:D:E:L!J:XX:XY | | | ✓ | | | |
| 070801 | | | | ✓ | | | |
| 070102 | A:C:D:E:F:T!U!V!W:AT:XX:XY | 01 | 3:4:5:6 | ✓ | | | ✓ |
| 070202 | A:C:D:E:F:Z!AA!AB:XX:XY | 02 | 4:5:6 | | | ✓ | ✓ |
| 070302 | A:C:D:E:F:V!U!T:AT:XX:XY | 01 | 4:5:6 | | ✓ | | ✓ |
| 070402 | A:C:D:E:F:X!W!V!U:XX:XY | 01 | 2:3:4:5 | | | ✓ | ✓ |
| 070502 | A:C:D:E:AP:AT:XX:XY | | | | ✓ | | |
| 070602 | B:C:D:E:F:X!W!V:XX:XY | 01 | 2:3:4 | | | ✓ | ✓ |
| 070702 | B:C:D:E:L!J:XX:XY | | | ✓ | | | |
| 070802 | | | | ✓ | | | |
| 070103 | A:C:D:E:F:T!U!V!W:AT:XX:XY | 01 | 3:4:5:6 | ✓ | | | ✓ |
| 070203 | A:C:D:E:F:Z!AA!AB:XX:XY | 02 | 4:5:6 | | | ✓ | ✓ |
| 070303 | A:C:D:E:F:V!U!T:AT:XX:XY | 01 | 4:5:6 | | ✓ | | ✓ |
| 070403 | A:C:D:E:F:X!W!V!U:XX:XY | 01 | 2:3:4:5 | | | ✓ | ✓ |
| 070503 | A:C:D:E:AP:AT:XX:XY | | | | ✓ | | |
| 070603 | B:C:D:E:F:X!W!V:XX:XY | 01 | 2:3:4 | | | ✓ | ✓ |
| 070703 | B:C:D:E:L!J:XX:XY | | | ✓ | | | |
| 070803 | | | | ✓ | | | |
| 070104 | A:C:D:E:F:T!U!V!W:AT:XX:XY | 01 | 3:4:5:6 | ✓ | | | ✓ |
| 070204 | A:C:D:E:F:Z!AA!AB:XX:XY | 02 | 4:5:6 | | | ✓ | ✓ |
| 070304 | A:C:D:E:F:V!U!T:AT:XX:XY | 01 | 4:5:6 | | ✓ | | ✓ |
| 070404 | A:C:D:E:F:X!W!V!U:XX:XY | 01 | 2:3:4:5 | | | ✓ | ✓ |
| 070504 | A:C:D:E:AP:AT:XX:XY | | | | ✓ | | |
| 070604 | B:C:D:E:F:X!W!V:XX:XY | 01 | 2:3:4 | | | ✓ | ✓ |
| 070704 | B:C:D:E:L!J:XX:XY | | | ✓ | | | |
| 070804 | | | | ✓ | | | |

Table 31 shows the possibility of the selection of dynamic duty for an embarked person according to the required certificates, physical measures, evaluations of emergencies and emergencies attended on a fire emergency.

TABLE 31
REVISIONS - Fire, person ID 018, dynamic duties

| New | | Certificate or course code | Boots | | | Real | Evaluation | Set |
|---|---|---|---|---|---|---|---|---|
| duty | | required to perform | and | Lockers | | emergency | from | dynamic |
| ID | New duty name | emergency duty | suit | boots | suit | and training | 1 to 10 | duty |
| 010107 | Overall command | A:C:D:E:T:XX:XY | | | | | | |
| 010207 | Vessel control | A:C:D:E:V:XX:XY | | | | | | |
| 010307 | Maintain communications | B:C:D:E:L:J:XX:XY | | | | | | |
| 020108 | On scene commander | A:C:D:E:U:XX:XY | | | | | | |
| 030105 | Fire Team Leader | A:C:D:E:AB!AA:AT:XX:XY | | | | | | |
| 030205 | Alternative leader, wearing fire-suit 1 | A:C:D:E:W:AT:XX:XY | 43\|60 | 41:43 | 56:60 | | | |
| 030305 | Wear fire-suit 2, hold fire hose nozzle | A!B:C:D:E:XX:XY | 43\|60 | 41:43 | 56:60 | 0\|2 | 7 | ✓ |
| 030405 | Help put fire-suit 1, hold fire hose | A!B:C:D:E:XX:XY | | | | 1\|4 | 9 | ✓ |
| 030505 | Help put fire-suit 2, hold fire hose | A!B:C:D:E:XX:XY | | | | 1\|6 | 9 | ✓ |
| 030605 | Open, close fire valve | B:C:D:E:XX:XY | | | | 0\|3 | 10 | ◯ |
| 030106 | Fire Team Leader | A:C:D:E:AB!AA:AT:XX:XY | | | | | | |
| 030206 | Alternative leader, wearing fire-suit 1 | A:C:D:E:AT:XX:XY | 43\|60 | 42:44 | 58:62 | | | |
| 030306 | Wear fire-suit 2, hold fire hose nozzle | A!B:C:D:E:XX:XY | 43\|60 | 42:44 | 58:62 | 0\|2 | 7 | |
| 030406 | Help put fire-suit 1, hold fire hose | B:C:D:E:XX:XY | | | | 1\|4 | 9 | ✓ |
| 030506 | Help put fire-suit 2, hold fire hose | B:C:D:E:XX:XY | | | | 1\|6 | 9 | ✓ |
| 030606 | Open, close fire valve | B:C:D:E:XX:XY | | | | 0\|3 | 10 | ✓ |
| 040109 | In charge of the Engine Room | A:C:D:E:Z:XX:XY | | | | | | |
| 040209 | Assist Chief Engineer | A:C:D:E:AA:XX:XY | | | | | | |
| 050110 | Stand-by to attend accidents | B:C:D:E:M:AM:XX:XY | | | | | | |
| 060101 | Maintains order and communication | A:C:D:E:V:AT:XX:XY | | | | | | |
| 060201 | Wait for instructions | | | | | 0\|1 | 10 | ✓ |
| 060301 | Readiness for launch | A!B:C:D:E:F:W!X:XX:XY | | | | | | |
| 060401 | Readiness to prepare the engine | A!B:C:D:E:F:AS!AR:XX:XY | | | | | | |
| 060102 | Maintains order and communication | A:C:D:E:V:AT:XX:XY | | | | | | |
| 060202 | Wait for instructions | | | | | 0\|1 | 10 | ✓ |
| 060302 | Readiness for launch | A!B:C:D:E:F:W!X:XX:XY | | | | | | |
| 060402 | Readiness to prepare the engine | A!B:C:D:E:F:AS!AR:XX:XY | | | | | | |
| 060103 | Maintains order and communication | A:C:D:E:V:AT:XX:XY | | | | | | |
| 060203 | Wait for instructions | | | | | 0\|1 | 10 | ✓ |
| 060303 | Readiness for launch | A!B:C:D:E:F:W!X:XX:XY | | | | | | |
| 060403 | Readiness to prepare the engine | A!B:C:D:E:F:AS!AR:XX:XY | | | | | | |
| 060104 | Maintains order and communication | A:C:D:E:V:AT:XX:XY | | | | | | |
| 060204 | Wait for instructions | | | | | 0\|1 | 10 | ✓ |
| 060304 | Readiness for launch | A!B:C:D:E:F:W!X:XX:XY | | | | | | |
| 060404 | Readiness to prepare the engine | A!B:C:D:E:F:AS!AR:XX:XY | | | | | | |

Table 32 shows all resulting escape routes in a fire emergency, using duties distributed with the Initial Station Bill (see table 7) and dynamic duties assigned in table 26. This table serves to better understand the calculation of the estimated time and the selection of team members.

TABLE 32
REVISIONS - Fire, resulting escape routes using table 7, 25 and 26

| Route | Person | New duty | | | |
|---|---|---|---|---|---|
| ID | ID | ID | Duty name | New team name | New muster point name |
| 001 | 001 | 010107 | Overall command | Ship's Bridge | Ship's Bridge |
| 002 | 004 | 010207 | Vessel control | Ship's Bridge | Ship's Bridge |
| 003 | 013 | 010307 | Maintain communications | Ship's Bridge | Ship's Bridge |
| 004 | 014 | 010307 | Maintain communications | Ship's Bridge | Ship's Bridge |
| 005 | 003 | 020108 | On scene commander | Accident Scene | On scene |
| 006 | 017 | 030105 | Fire Team Leader | Fire Team | Firefighter's locker 1 |
| 007 | 017 | 030105 | Fire Team Leader | Fire Team | Firefighter's locker 2 |
| 008 | 016 | 030106 | Fire Team Leader | Fire Team | Firefighter's locker 1 |
| 009 | 016 | 030106 | Fire Team Leader | Fire Team | Firefighter's locker 2 |
| 010 | 006 | 030205 | Alternative leader, wearing fire-suit 1 | Fire Team | Firefighter's locker 1 |
| 011 | 006 | 030205 | Alternative leader, wearing fire-suit 1 | Fire Team | Firefighter's locker 2 |
| 012 | 029 | 030206 | Alternative leader, wearing fire-suit 1 | Fire Team | Firefighter's locker 1 |
| 013 | 029 | 030206 | Alternative leader, wearing fire-suit 1 | Fire Team | Firefighter's locker 2 |
| 014 | 010 | 030305 | Wear fire-suit 2, hold fire hose nozzle | Fire Team | Firefighter's locker 1 |
| 015 | 010 | 030305 | Wear fire-suit 2, hold fire hose nozzle | Fire Team | Firefighter's locker 2 |
| 016 | 033 | 030306 | Wear fire-suit 2, hold fire hose nozzle | Fire Team | Firefighter's locker 1 |
| 017 | 033 | 030306 | Wear fire-suit 2, hold fire hose nozzle | Fire Team | Firefighter's locker 2 |
| 018 | 022 | 030405 | Help put fire-suit 1, hold fire hose | Fire Team | Firefighter's locker 1 |
| 019 | 022 | 030405 | Help put fire-suit 1, hold fire hose | Fire Team | Firefighter's locker 2 |
| 020 | 031 | 030406 | Help put fire-suit 1, hold fire hose | Fire Team | Firefighter's locker 1 |
| 021 | 031 | 030406 | Help put fire-suit 1, hold fire hose | Fire Team | Firefighter's locker 2 |
| 022 | 020 | 030505 | Help put fire-suit 2, hold fire hose | Fire Team | Firefighter's locker 1 |
| 023 | 020 | 030505 | Help put fire-suit 2, hold fire hose | Fire Team | Firefighter's locker 2 |
| 024 | 025 | 030506 | Help put fire-suit 2, hold fire hose | Fire Team | Firefighter's locker 1 |
| 025 | 025 | 030506 | Help put fire-suit 2, hold fire hose | Fire Team | Firefighter's locker 2 |
| 026 | 018 | 030605 | Open, close fire valve | Fire Team | Firefighter's locker 1 |
| 027 | 018 | 030605 | Open, close fire valve | Fire Team | Firefighter's locker 2 |
| 028 | 027 | 030606 | Open, close fire valve | Fire Team | Firefighter's locker 1 |
| 029 | 027 | 030606 | Open, close fire valve | Fire Team | Firefighter's locker 2 |
| 030 | 002 | 040109 | In charge of the Engine Room | Engine Room | Engine Room |
| 031 | 012 | 040209 | Assist Chief Engineer | Engine Room | Engine Room |
| 032 | 024 | 050110 | Stand-by to attend accidents | Hospital | Hospital |
| 033 | 008 | 060101 | Maintains order and communication | Reserve on lifeboats | Lifeboat 1 |
| 034 | 008 | 060102 | Maintains order and communication | Reserve on lifeboats | Lifeboat 2 |
| 035 | 008 | 060103 | Maintains order and communication | Reserve on lifeboats | Lifeboat 3 |
| 036 | 008 | 060104 | Maintains order and communication | Reserve on lifeboats | Lifeboat 4 |
| 037 | 005 | 060101 | Maintains order and communication | Reserve on lifeboats | Lifeboat 1 |
| 038 | 005 | 060102 | Maintains order and communication | Reserve on lifeboats | Lifeboat 2 |
| 039 | 005 | 060103 | Maintains order and communication | Reserve on lifeboats | Lifeboat 3 |
| 040 | 005 | 060104 | Maintains order and communication | Reserve on lifeboats | Lifeboat 4 |
| 041 | 015 | 060201 | Wait for instructions | Reserve on lifeboats | Lifeboat 1 |
| 042 | 015 | 060202 | Wait for instructions | Reserve on lifeboats | Lifeboat 2 |
| 043 | 015 | 060203 | Wait for instructions | Reserve on lifeboats | Lifeboat 3 |
| 044 | 015 | 060204 | Wait for instructions | Reserve on lifeboats | Lifeboat 4 |
| 045 | 019 | 060201 | Wait for instructions | Reserve on lifeboats | Lifeboat 1 |
| 046 | 019 | 060202 | Wait for instructions | Reserve on lifeboats | Lifeboat 2 |
| 047 | 019 | 060203 | Wait for instructions | Reserve on lifeboats | Lifeboat 3 |
| 048 | 019 | 060204 | Wait for instructions | Reserve on lifeboats | Lifeboat 4 |
| 049 | 021 | 060201 | Wait for instructions | Reserve on lifeboats | Lifeboat 1 |
| 050 | 021 | 060202 | Wait for instructions | Reserve on lifeboats | Lifeboat 2 |
| 051 | 021 | 060203 | Wait for instructions | Reserve on lifeboats | Lifeboat 3 |
| 052 | 021 | 060204 | Wait for instructions | Reserve on lifeboats | Lifeboat 4 |
| 053 | 039 | 060201 | Wait for instructions | Reserve on lifeboats | Lifeboat 1 |
| 054 | 039 | 060202 | Wait for instructions | Reserve on lifeboats | Lifeboat 2 |
| 055 | 039 | 060203 | Wait for instructions | Reserve on lifeboats | Lifeboat 3 |
| 056 | 039 | 060204 | Wait for instructions | Reserve on lifeboats | Lifeboat 4 |
| 057 | 040 | 060201 | Wait for instructions | Reserve on lifeboats | Lifeboat 1 |
| 058 | 040 | 060202 | Wait for instructions | Reserve on lifeboats | Lifeboat 2 |
| 059 | 040 | 060203 | Wait for instructions | Reserve on lifeboats | Lifeboat 3 |
| 060 | 040 | 060204 | Wait for instructions | Reserve on lifeboats | Lifeboat 4 |
| 061 | 007 | 060201 | Wait for instructions | Reserve on lifeboats | Lifeboat 1 |
| 062 | 007 | 060202 | Wait for instructions | Reserve on lifeboats | Lifeboat 2 |
| 063 | 007 | 060203 | Wait for instructions | Reserve on lifeboats | Lifeboat 3 |
| 064 | 007 | 060204 | Wait for instructions | Reserve on lifeboats | Lifeboat 4 |
| 065 | 009 | 060201 | Wait for instructions | Reserve on lifeboats | Lifeboat 1 |
| 066 | 009 | 060202 | Wait for instructions | Reserve on lifeboats | Lifeboat 2 |
| 067 | 009 | 060203 | Wait for instructions | Reserve on lifeboats | Lifeboat 3 |
| 068 | 009 | 060204 | Wait for instructions | Reserve on lifeboats | Lifeboat 4 |
| 069 | 011 | 060201 | Wait for instructions | Reserve on lifeboats | Lifeboat 1 |
| 070 | 011 | 060202 | Wait for instructions | Reserve on lifeboats | Lifeboat 2 |
| 071 | 011 | 060203 | Wait for instructions | Reserve on lifeboats | Lifeboat 3 |
| 072 | 011 | 060204 | Wait for instructions | Reserve on lifeboats | Lifeboat 4 |
| 073 | 023 | 060201 | Wait for instructions | Reserve on lifeboats | Lifeboat 1 |
| 074 | 023 | 060202 | Wait for instructions | Reserve on lifeboats | Lifeboat 2 |
| 075 | 023 | 060203 | Wait for instructions | Reserve on lifeboats | Lifeboat 3 |
| 076 | 023 | 060204 | Wait for instructions | Reserve on lifeboats | Lifeboat 4 |
| 077 | 026 | 060201 | Wait for instructions | Reserve on lifeboats | Lifeboat 1 |
| 078 | 026 | 060202 | Wait for instructions | Reserve on lifeboats | Lifeboat 2 |
| 079 | 026 | 060203 | Wait for instructions | Reserve on lifeboats | Lifeboat 3 |
| 080 | 026 | 060204 | Wait for instructions | Reserve on lifeboats | Lifeboat 4 |
| 081 | 028 | 060201 | Wait for instructions | Reserve on lifeboats | Lifeboat 1 |
| 082 | 028 | 060202 | Wait for instructions | Reserve on lifeboats | Lifeboat 2 |
| 083 | 028 | 060203 | Wait for instructions | Reserve on lifeboats | Lifeboat 3 |
| 084 | 028 | 060204 | Wait for instructions | Reserve on lifeboats | Lifeboat 4 |
| 085 | 030 | 060201 | Wait for instructions | Reserve on lifeboats | Lifeboat 1 |
| 086 | 030 | 060202 | Wait for instructions | Reserve on lifeboats | Lifeboat 2 |
| 087 | 030 | 060203 | Wait for instructions | Reserve on lifeboats | Lifeboat 3 |
| 088 | 030 | 060204 | Wait for instructions | Reserve on lifeboats | Lifeboat 4 |
| 089 | 032 | 060201 | Wait for instructions | Reserve on lifeboats | Lifeboat 1 |
| 090 | 032 | 060202 | Wait for instructions | Reserve on lifeboats | Lifeboat 2 |
| 091 | 032 | 060203 | Wait for instructions | Reserve on lifeboats | Lifeboat 3 |
| 092 | 032 | 060204 | Wait for instructions | Reserve on lifeboats | Lifeboat 4 |
| 093 | 034 | 060201 | Wait for instructions | Reserve on lifeboats | Lifeboat 1 |
| 094 | 034 | 060202 | Wait for instructions | Reserve on lifeboats | Lifeboat 2 |
| 095 | 034 | 060203 | Wait for instructions | Reserve on lifeboats | Lifeboat 3 |
| 096 | 034 | 060204 | Wait for instructions | Reserve on lifeboats | Lifeboat 4 |
| 097 | 036 | 060301 | Readiness for launch | Reserve on lifeboats | Lifeboat 1 |
| 098 | 036 | 060302 | Readiness for launch | Reserve on lifeboats | Lifeboat 2 |
| 099 | 036 | 060303 | Readiness for launch | Reserve on lifeboats | Lifeboat 3 |
| 100 | 036 | 060304 | Readiness for launch | Reserve on lifeboats | Lifeboat 4 |
| 101 | 035 | 060301 | Readiness for launch | Reserve on lifeboats | Lifeboat 1 |
| 102 | 035 | 060302 | Readiness for launch | Reserve on lifeboats | Lifeboat 2 |
| 103 | 035 | 060303 | Readiness for launch | Reserve on lifeboats | Lifeboat 3 |
| 104 | 035 | 060304 | Readiness for launch | Reserve on lifeboats | Lifeboat 4 |
| 105 | 038 | 060401 | Readiness to prepare the engine | Reserve on lifeboats | Lifeboat 1 |
| 106 | 038 | 060402 | Readiness to prepare the engine | Reserve on lifeboats | Lifeboat 2 |
| 107 | 038 | 060403 | Readiness to prepare the engine | Reserve on lifeboats | Lifeboat 3 |
| 108 | 038 | 060404 | Readiness to prepare the engine | Reserve on lifeboats | Lifeboat 4 |
| 109 | 037 | 060401 | Readiness to prepare the engine | Reserve on lifeboats | Lifeboat 1 |
| 110 | 037 | 060402 | Readiness to prepare the engine | Reserve on lifeboats | Lifeboat 2 |
| 111 | 037 | 060403 | Readiness to prepare the engine | Reserve on lifeboats | Lifeboat 3 |
| 112 | 037 | 060404 | Readiness to prepare the engine | Reserve on lifeboats | Lifeboat 4 |

Step H (8)—Calculate the times of the escape routes or course to the disaster location, with the objective of reducing travel times and avoiding risk exposure during the course, selecting the best possible route and Security Asset option, considering all the embarked persons as a single group (for example as in the initial calculation of abandonment) and separately each one with its characteristics previously detected or saved in the system to separate them into teams as it is predefined in selection of the responsible for safety on board and considering different emergencies simultaneously.

In the fight against any type of emergency time is the main factor that can ensure success. The course of the embarked person, from the detected position to the muster point, is made of common access points. The shortest route to the muster point does not always mean the safest and the fastest. It depends on how many common accesses points the person must go through. Points such as: doors, escape courses (here referred to as escape routes, which include corridors, walkways and paths properly marked on the floor), stairs, elevators, vertical stairs, hatches, etc.

These points also increase the possibility of accidents. With this vision the purpose is to calculate the estimated time to redistribute the duties and escape routes. For this to be achievable, it is necessary to choose an average speed used on the vessels, since running on board is prohibited. In calculations, the average speed used is 1.3 meters per second. All the velocity estimates (see table 33, column 6) used can be improved with each training or real emergency because the same values will be measured to compare them with those used, helping to improve the estimates and bringing them closer to the real situation. The route from the embarked person to the muster point is measured and accompanied by the reading of the portable sensors in the Smart Portable Radio Modules (14), together with the embarked persons position scanning provided by Scanning Modules with Camera (15), thus enabling the implementation of the individual “fi” speed factor present in the calculations (see tables 36, 37, 38 and 39, column 8). The time is calculated uniquely for each step (see tables 36, 37, 38 and 39, column 1) and the total time represents the addition of all steps separately and individually for each person on board.

The calculation is derived by multiplying the course distance “L” (see table 36, 37, 38 and 39, column 5) by the predefined time factor “X” (see table 33, column 7), dividing the result with the result of multiplying the estimated average velocity “V” at the access point (see table 33, column 6), by individual speed factor “fi” of the embarked person, adding the predefined time “TP” (see table 33, column 8) and the safety time “TS” (see table 14, column 11). The individual speed factor “fi” is an individual locomotion velocity factor for each person and separately characterizes the speed for each classified access point (see table 33, column 1). This factor is derived from the results of actual training and emergencies. For example, if the speed of the embarked person “ID 018” through the doors with the classification “A” measured in one or more emergencies is an average velocity of 0.75 meters per second, it is different from the estimated “V”, which is 0.8 meters per second, the individual “fi” factor of the person “ID 018” for the “A” classification doors shall be the embarked person “ID 018” individual measured speed divided by the estimated speed “V”, which results in 0,9375. In table 36, the passage of the embarked person with the “ID 018” through the doors with the classification “A” in step 3 would be 2.67 seconds and not 2.5 seconds as is with the “fi=1” factor. By applying the individual factor for each embarked person and for each classified access point, according to table 33, are achieved forecast results even closer to the real situation. In tables 36, 37, 38 and 39, the individual factor “fi” used is of value 1.

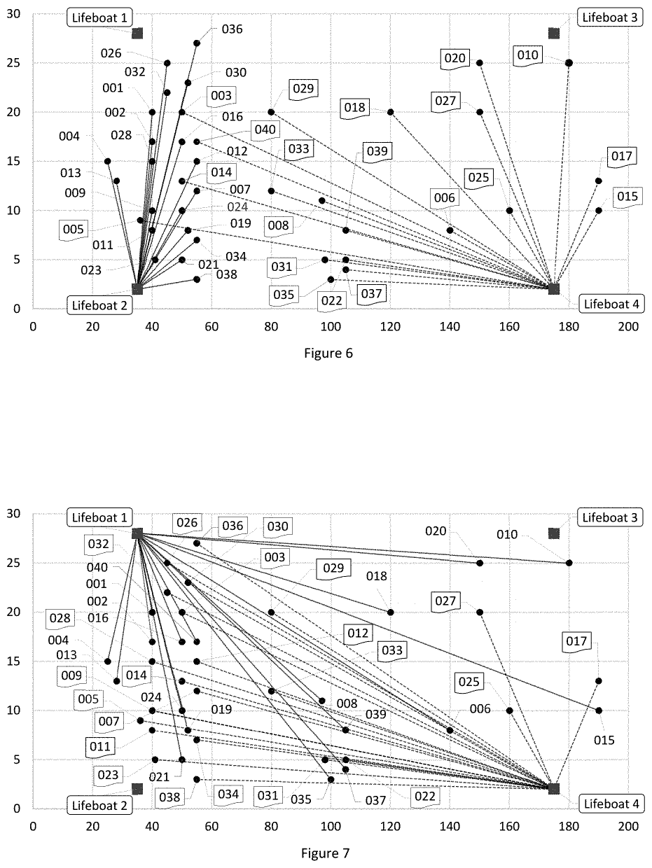

Many other factors can be implemented in the calculation to improve time estimates in calculations, such as: human (speed of movement), flow (density and counter flow), meteorological (rain, snow, wind, ice etc.), and stability (motions and inclinations). All these mentioned factors affect most calculations in vessels with many passengers where the flow in the corridors (escape routes) is relevant as well as the age factor (locomotion) is considerable. With the use of the Emergency Management System, the counter flow is reduced to a minimum (see FIGS. 4, 5, 6 and 7). The Emergency Management System is the solid foundation for the implementation, development and study of the mentioned factors that affect the speed of the locomotion of the embarked persons.

Table 33 in column 7 represents the value that determines whether an access point is calculable, whether it has a predefined or a default value. The value 0 of column 7 in table 33 means that the access point has a predefined estimated time value and is not calculable. As an example, we have the resting point, preparation point and similar. The value 1 in the same column followed by the unspecified unit distance “L” (column 5) means that the length of the access point is not standard, it is defined separately and can be complex with several connection points (see table 34). Also, more calculations may be required to set the length, for example: escape route, ladder, elevator and similar. The value 1 in column 7, followed by the unit distance “L” (column 5), means that the default value of the length of the access point is defined in column 5 for all points in this classification, such as door, hatch and the like. As an example, if the value in column 7 is 1, the value of column 5 is 2, access point is the door with the classification “A”, means that the passage through this door has a total length of 2 meters until a connection with another access point that can be a ladder, an escape route, etc. This length of 2 meters is standard for all doors of the same classification “A” (see table 33, column 3).

Table 34 shows the formation of the identifier “ID” of the common access points, their distances and associated connections. The common access point identifier is composed of code “A1”, which is the serial number of the point classification (see table 33, column 1) plus the code “A2”, which is the serial number of the point in the same classification group (see table 34, column 3), and at the end, the number of connections present between the beginning and the end of the access point. For all common access points, according to the three-dimensional location of the Cartesian coordinate system, there is a start point and an end point. The identification of these two access points is defined in table 34, column 9. Adding the letter “A” to the “ID” of the point means that the point is initial, or the letter “B” which means that the point is final. This identification serves to separate and discern these two points, since the beginning and the end of the points in the calculation of the estimated time depend on the direction of movement that the embarked person has through the access point. Thus, for the calculation, the point marked “B” in front of the “ID” (example B010010) may actually be the starting point for the embarked person, and the point marked “A” in front of the “ID” of the point (example A010010) may be the end point in the calculation.

All access points can have at least two connections. These are the beginning and end of the access point, and between these two points can be found several connection points, connection points with another access point (for example crossing with another escape route), or zone (see table 35, column 6). The position of the connection point is determined in table 35, column 3 and 4 with the variable “L1” and “L2”. This variable determines the position of the connection (if any) between the two marginal points of a common access point. Connection points are marked with the letter “K” in front of the “ID” of the common access point. For example, common access point “ID 070012” has the last number 2. This means that there are two connection points in total, “K070011” near start point “A070012” and connection point “K070012” after “K070011” and so on until the end point “B070012”. The zone, on the other hand, can be defined as a free space that does not include any escape route. These free spaces can be spaces with different purposes. In passenger ships they can be various entertainment spaces such as swimming pools, tennis courts, basketball, etc. In cargo ships and others, they are the surfaces designated for the storage of cargoes, tools etc.

An example of time calculation up to the muster point is introduced in tables 36, 37, 38 and 39. The tables represent different embarked persons positioning situations. In table 36, the embarked person is away from the escape route. In table 37, he is in front of the door. And in tables 38 and 39, they have open work permits and with the safety times in effect, working, and this safety time will be applied in the calculation. The safety time also contains the time required to reach an escape route. For this reason, the distance “L”, “L1” or “L2” (see tables 38 and 39, column 5, step 1) has a value of 0. The four embarked persons, represented in the calculations mentioned above, reach the same muster point from four different directions. The arrival of the embarked persons at the muster point of the Field Module (13), with the related position “ID F004” in an emergency may, but do not have to be confirmed in the Field Module (13), since the embarked persons are constantly tracked by the Scanning Modules with Camera (15), as they also confirmed the mandatory receipt of duty at the beginning of the emergency. This way giving the embarked person more freedom of movement, preparation time and more focus on the environment and personnel around and at the muster point.

The embarked persons with “ID 022” and “ID 033” in tables 38 and 39 have the safety time applied in the calculation. This is correlated with work permits (see table 14). In an embodiment of the present invention, only two work permits are part of the calculations. But in reality, the representation of the permissions in the calculations is significantly greater, depending on the number of embarked persons working. With a greater representation of work permits in the calculation of dynamic duties, the differences in calculated times increase, and also increase the probability that an embarked person with the “wait for instructions” duty is selected to fulfill a dynamic duty, because it has a shorter estimated calculated time as the embarked persons working. The embarked person working can, on the other hand, be with a safety time in a step with a value of 0. This is the value of the safety time and means that the embarked person can immediately attend the emergency. The muster point (last step in the calculation) is a point that may be in a zone or an escape route witch in return lies in an area or a location. “Area” is considered an open or closed space that can contain multiple locations (closed or open spaces). A location, area, or zone on the other hand, may have the name of a muster point. If the muster point is a Field Module (13) the position “ID” is visible in table 17, and if it is a Smart Portable Radio Module (14) the position “ID” is visible in table 16. A muster point in the Dynamic Station Bill system can be defined as such if on the location are present a Field Module (13) or a Smart Portable Radio Module (14).

The formation of all escape routes in this invention for the fire emergency with the conditions presented prior to the calculation is visible on table 40 and table 41. Table 40 represents the dynamic duties (see table 28) applied to all escape routes for the fire emergency (see table 32), considering only those embarked persons that are part of the fire teams. And table 41 represents the dynamic duties (see table 28) applied to all escape routes for the fire emergency (see table 32), considering only the “wait for instructions” duty. Embarked persons awaiting instructions will help form the fire teams.

The estimated response times applied to the analysis are of informative nature and are not product of exact calculation. The best estimated response times will be selected from both tables in order to form table 42, defining the two firefighting teams. This is the procedure for all teams. The sequence for the formation of the teams is presented in table 25. With the sequence shown it is visible that the fire team is the last one to be formed. The reserve in the lifeboats station is formed before, because it is necessary to define the duties of organization of the muster point (duty ID 060101, 060102, 060103 and 060104) and launching of the lifeboats in case of the abandonment after the fire emergency (duty ID 060301, 060401, 060302, 060402, 060303, 060403, 060304 and 060404). Only after these duties have been defined the fire teams will be formed using the embarked persons whose duty is “wait for instructions” (duty ID 060201, 060202, 060203 and 060204). The last number of each “ID” of the dynamic duty represents the muster point which is the designated lifeboat number.

The differences between the use of the Emergency Management System containing a Dynamic Station Bill and the Initial Station Bill are clearly visible by comparing tables 42, 43, 44 and 45 and FIGS. 4, 5, 6 and 7. Tables 42, 43, 44 and 45 represent the comparation of fire teams 1 and 2 using the Emergency Management System and Method and the Initial Station Bill. To avoid time calculation and to simplify the figures and tables as much as possible, the air distance of the embarked persons and the respective muster points is used instead of using the time calculations. The use of time calculation would further increase the differences between the compared systems, favoring the Emergency Management System.

Table 48 shows the distance calculation for the embarked persons considering the Initial Station Bill, and table 49 using the Dynamic Station Bill demonstrating the selected combination of lifeboats with the shorter distance for calculation, which, in the example, are the lifeboats 2 and 3. The total length of the routes and combinations of lifeboats are visible in table 50, showing that, in fact, the best combination is between lifeboats 2 and 3. With the data in table 46 can be distributed the emergency fire teams to obtain the successive abandonment calculations. The difference between the calculations of abandonment after fire and abandonment is that the abandonment after the fire calculates the position of the teams from their combat positions, which the responsible for safety on board selected for the two fire teams (see table 22), and other teams present in fire emergency to calculate abandonment and select the best combination of lifeboats.

It can be seen in all the abandonment calculations that the Initial Station Bill always has the lifeboats 1 and 4 as a selection for abandonment, whether it is the only emergency of abandonment or abandonment after the fire. Instead, the Dynamic Station Bill shows that the selection of lifeboats can change depending on when the abandonment happens, so for abandonment the best option is for lifeboats 2 and 4, and for the abandonment after the fire is for lifeboats 2 and 3.

Table 49 is used to understand the steps of the calculation and separation of the embarked persons on the lifeboats. The first separation of embarked persons happens based on the smaller distance between the embarked person and the muster point that is, in fact, the lifeboat station. Column 3 demonstrates the closest muster point, having 24 embarked persons near the lifeboat 2 and 16 embarked persons near the lifeboat 3. After the first separation, the dynamic duties in abandonment emergency will be applied (see table 30), considering the combination of smaller distance as the standard of separation of the dynamic duties (see table 51 and 52). Tables 51 and 52 reveal us how the separation of the dynamic duties in abandonment is carried out for the duties “ID 060302” and “ID 060303”. Table 49, column 7, shows that for embarked person “ID 037”, the lifeboat is changed to lifeboat 3 and the duty to “ID 060303”, and according to table 52, this is the combination of the lowest total distance for the combination of “ID 037” and “ID 038”. The dynamic duties are applied, and now column 7, table 49 has 22 embarked persons on lifeboat 2 and 18 on lifeboat 3. The final separation of the embarked persons between the lifeboats is carried out with the ones that have as duty “wait for instructions” in the lifeboat with more embarked persons (in this case, lifeboat 2). The objective of this is to achieve a proportional scheme of 50% of embarked persons in both selected lifeboats.

In a real situation, not exceeding the capacity of the lifeboat in people and in total mass (see table 23), it would not be necessary to take the next step. Column 5 of table 49 shows embarked persons in lifeboat 2 with less difference of distances between the two lifeboats in ascending order, so that the embarked person with less difference of distances between the lifeboats is transferred first to the lifeboat 3, and thus less affects the final distance calculation. Since there are 22 embarked persons on lifeboat 2, the first two to be transferred are those with the number 1 and 2 in column 5. These are the embarked persons of “ID 022” and “ID 039”. The same principle is used for the emergency of abandonment (see tables 53, 55, 56, 57 and 58), but with the result of a better combination of different lifeboats. Depending on several factors, such as boat inclination, wind, gas leak, collision, fire on the surface of the water, smoke, etc., the responsible for safety on board may select the vessel board for abandonment. Factors such as inclinations, gas, wind, smoke, fire and flood are monitored by Sensor Modules (16). Vessel inclination, which is present in table 23, is constantly monitored by the Emergency Management System and Method. If exceeded, the inclination of the vessel prevents the launching of the lifeboats. External factors such as collision, fire on the surface of the water and similar will be considered by the person responsible for the safety on board at the time of the selection of the abandonment board. Other factors mentioned as gas, wind, fire, smoke, flood and the like are considered in the calculation that interdicts escape routes.

If it is not possible to set up any emergency response team, an alarm is generated informing one or more failures that are: lack of staff to complete teams; lack of certificates to have more options for selection of additional duties; embarked person certificate is expired and cannot complete the team; times for readiness are compromised; lack of escape routes for access to the emergency location or embarked persons with no escape route available to reach a muster point as a result of the selection of interdicted routes, according to table 10.

A person can be present in several teams, in the sense that there could be several types of emergency happening at the same time. As the scan is constant, the calculations of the escape routes and formation of the teams are also constant. In an emergency state, scanning and calculations continue. For example, after firefighting you must leave the vessel. Through the scanning and the movement of the embarked persons, it is verified that, for the teams fighting the emergency to leave the vessel, it is better to use a lifeboat different from the one previously calculated. In this way, new duties will be passed on in the act of the alarm for abandonment. Also due to various fire escalation events, routes to the previously assigned lifeboat were, for example, prohibited. In this case, using FIG. 4, “Fire Team 1”, “Fire Team 2”, “Engine Room”, “On Scene” and possibly the person with “ID 008”, “ID 022”, “ID 035” and “ID 037” may be redirected to lifeboat 4, rather than 3, which was previously assigned. Redirects and quantity of embarked persons attributed to a lifeboat depend on the capacity of the same, as well as the total weight of the people. Embarked persons present in various teams must have “competitors” for the same duties. Otherwise, a fault alarm will be generated for the lack of personnel. People already participating in an emergency cannot participate in another. For this reason, they will be excluded in calculations of the new emergency. This is one of the reasons why it is necessary to have additional duties which are not provided for by the Initial Station Bill and are possible with the implementation of the Emergency Management System.

A more elaborate analysis of emergencies in Table 19 is necessary to determine emergencies, which may occur simultaneously, or may develop as the cause of the chain reaction of events in emergencies. In this way, it will be possible to apply new filters (computational algorithms); distribute additional duties; form and train teams; provide the necessary certificates for all team members, to avoid lack of personnel alarms and complete teams. The aforementioned analysis is not present in the Initial Station Bill, since it provides as principal only the fire emergency, and, sometimes, the possible abandonment as a consequence.

Duties are divided for the fire emergency and the others are on standby waiting on the designated lifeboats. From the teams ready to abandon in the lifeboats, the responsible for safety on board according to the Initial Station Bill determines who will attend any secondary emergency that can develop successively or help one of the teams already formed. With the implementation of the Emergency Management System, the selection and optimization are automatic, and the results are visible in FIGS. 4, 5, 6 and 7. These figures show that the crossing of escape routes, or so-called counterflow, is minimized.

It is apparent that the Emergency Management System optimizes, defines and can meet future requirements by imposing itself as a stable basis for estimated time calculations, simulations and optimization of response to emergencies in general. Therefore, it is concluded that it is better to wait for an emergency with the defined teams, instead of trying to define the teams with the emergency already in course, because we can see now how much data is needed to make the definition of a team acceptable.

Table 33 shows the classification of common access points with estimated average speed, preset time factor, and preset time values. It is used to calculate escape routes.

TABLE 33
CALCULATION - Common access point, classification and values for calculation

| | | | | | V - | | |
|---|---|---|---|---|---|---|---|
| | | | | L - | Estimated | | TP - |
| | | | Points | Unitary | average | X - | Preset |
| A1 | Common access | Point | total | distance | speed | Preset | time |
| code | point name | classification | number | m | m/s | time factor | s |
| 01 | Door | A | 45 | 2.00 | 0.80 | 1 | |
| 02 | Watertight door | B | 24 | 2.00 | 0.60 | 1 | |
| 03 | Ladder | A | 12 | | 0.70 | 1 | |
| 04 | Vertical ladder | B | — | | 0.40 | 1 | |
| 05 | Elevator | A | — | | 0.50 | 1 | |
| 06 | Hatch | A | — | 2.00 | 0.30 | 1 | |
| 07 | Escape route | A | 150 | | 1.30 | 1 | |
| 08 | Escape route | B | 25 | | 1.00 | 1 | |
| 09 | Zone 1 | A | 1 | | 0.90 | 1 | |
| 10 | Resting point | A | — | | 1.00 | 0 | 40 |
| 11 | Preparation point | A | — | | 1.00 | 0 | 30 |
| 12 | Preparation point | B | — | | 1.00 | 0 | 35 |
| 13 | Equipment withdrawal point | A | — | | 1.00 | 0 | 15 |
| 14 | Equipment withdrawal point | B | — | | 1.00 | 0 | 10 |
| 15 | Zone 1 | B | 13 | | 1.10 | 1 | |
| 16 | Zone 2 | A | — | | — | 1 | |
| — | — | — | — | — | — | — | — |

Table 34 represents the formation of the common access point ID and the related connection points used in the calculations. Connection points are start points, but in addition there may be a connection in the middle of these points with another common escape route, zone or access point (starting with the letter K). Unitary distance refers to the distance between the beginning of the access point and the end of the access point (for example, between A010010 and B010010).

TABLE 34
CALCULATION - Common access point, ID, position, distance and connection points

| | | | | | | Common | | |
|---|---|---|---|---|---|---|---|---|
| | | | | Common | | access | L - | |
| | | | Connection | Access | Site | point | Unitary | Connection |
| A1 | Point name and | A2 | points | Point | position | position | distance | points |
| code | classification | code | number | ID | ID | ID | m | ID |
| 01 | Door A | 001 | 0 | 010010 | — | — | 2.00 | A010010:B010010 |
| | | 002 | 0 | 010020 | — | — | 2.00 | A010020:B010020 |
| | | 003 | 0 | 010030 | — | — | 2.00 | A010030:B010030 |
| | | 004 | 0 | 010040 | — | — | 2.00 | A010040:B010040 |
| | | — | — | — | — | — | — | — |
| 02 | Watertight door B | 001 | 0 | 020010 | — | — | 2.00 | A020010:B020010 |
| | | — | — | — | — | — | — | — |
| 03 | Ladder A | 001 | 0 | 030010 | — | — | 5.00 | A030010:B030010 |
| | | 002 | 0 | 030020 | — | — | 4.00 | A030020:B030020 |
| | | 003 | 0 | 030030 | — | — | 6.00 | A030030:B030030 |
| | | 004 | 0 | 030040 | — | — | 5.00 | A030040:B030040 |
| | | 005 | 0 | 030050 | — | — | 7.50 | A030050:B030050 |
| | | — | — | — | — | — | — | — |
| 04 | Vertical ladder B | 001 | 0 | 040010 | — | — | 4.50 | A040010:B040010 |
| | | 002 | 0 | 040020 | — | — | 8.00 | A040020:B040020 |
| | | — | — | — | — | — | — | — |
| 05 | Elevator A | 001 | 1 | 050011 | — | — | — | A050011:B050011:K050011 |
| | | — | — | — | — | — | — | — |
| 06 | Hatch A | 001 | 0 | 060010 | — | — | — | A060010:B060010 |
| | | 002 | 0 | 060020 | — | — | — | — |
| 07 | Escape route A | 001 | 2 | 070012 | C147 | A001 | 14.00 | A070012:B070012: K070011:K070012 |
| | | 002 | 1 | 070021 | C189 | A002 | 6.00 | A070021:B070021:K070021 |
| | | 003 | 1 | 070031 | C132 | A003 | 14.00 | A070031:B070031:K070031 |
| | | 004 | 0 | 070040 | — | — | 30.00 | A070040:B070040 |
| | | 005 | 0 | 070050 | — | — | 10.00 | A070050:B070050 |
| | | 006 | 0 | 070060 | — | — | 8.00 | A070060:B070060 |
| | | 007 | 0 | 070070 | — | — | 4.00 | A070070:B070070 |
| | | 008 | 0 | 070080 | — | — | 7.00 | A070080:B070080 |
| | | 009 | 0 | 070090 | — | — | 11.00 | A070090:B070090 |
| | | 010 | 0 | 070100 | — | — | 8.00 | A070100:B070100 |
| | | 011 | 0 | 070110 | — | — | 23.00 | A070110:B070110 |
| | | 012 | 0 | 070120 | — | — | 6.00 | A070120:B070120 |
| | | 013 | 0 | 070130 | — | — | 15.00 | A070130:B070130 |
| | | 014 | 0 | 070140 | — | — | 7.00 | A070140:B070140 |
| | | 015 | 0 | 070150 | — | — | 14.00 | A070150:B070150 |
| | | 016 | 0 | 070160 | — | — | 21.00 | A070160:B070160 |
| | | 017 | 0 | 070170 | — | — | 10.50 | A070170:B070170 |
| | | 018 | 0 | 070180 | — | — | 4.00 | A070180:B070180 |
| | | 019 | 0 | 070190 | — | — | 2.00 | A070190:B070190 |
| | | — | — | — | — | — | — | — |
| 08 | Escape route B | 001 | 0 | 080010 | — | — | — | A080010:B080010 |
| | | — | — | — | — | — | — | — |
| 09 | Zone 1 A | 001 | 1 | 090011 | — | — | | K070012 |
| | | — | — | — | — | — | — | — |
| — | — | — | — | — | — | — | — | — |

Table 35 shows the connection points used in calculations and the distance between them at their common access points. This is to select the correct distance values, depending on the direction of the embarked person movement, to the muster point.

TABLE 35
CALCULATION - Connection point, positions

| | Common | L1 - Distance to | | L - unitary distance | |
|---|---|---|---|---|---|
| Connection | access point | beginning of | L2 - Distance to | of common access | |
| point | position | common access | end of common | point | |
| ID | ID | point m | access point m | L = L1 + L2 m | Connection point type |
| — | — | — | — | — | — |
| K070021 | A002 | 1.00 | 5.00 | 6.00 | Escape routes connection |
| K070011 | A001 | 4.00 | 10.00 | 14.00 | Zone 1 connection |
| K070012 | A001 | 11.00 | 3.00 | 14.00 | Zone 2 connection |
| K070031 | A003 | 1.00 | 13.00 | 14.00 | Escape routes connection |
| — | — | — | — | — | — |
| A070012 | A001 | 0.00 | 14.00 | 14.00 | Access point beginning |
| B070012 | A001 | 14.00 | 0.00 | 14.00 | Access point end |
| — | — | — | — | — | — |

Table 36 represents the estimated time calculation for the embarked person of ID 018.

TABLE 36
CALCULATION - Estimated Time, person ID 018

| | | Site, person, | | | | | T - |
|---|---|---|---|---|---|---|---|
| | | connection | Next | L or L1 or L2 - | TP - | TS - | Estimated time |
| | | or access | connection | Calculation | Preset | Security | [(L*X)/(V*fi)] + |
| Step | Site or access | point | point | distance | time | time | TP + TS |
| number | point name | position ID | ID | m | s | s | s |
| 1 | Zone 1 | E018 | K070011 | 3.00 | | | 3.33 |
| 2 | Escape route A | K070011 | B070012 | 10.00 | | | 7.69 |
| 3 | Door A | A010010 | B010010 | 2.00 | | | 2.50 |
| 4 | Ladder A | A030010 | B030010 | 5.00 | | | 7.14 |
| 5 | Escape route A | A070040 | B070040 | 30.00 | | | 23.08 |
| 6 | Escape route A | A070050 | B070050 | 10.00 | | | 7.69 |
| 7 | Muster point | F004 | | 0.00 | | | 0.00 |
| 8 | Total | | | | | | 51.43 |

Table 37 represents the estimated time for embarked person ID 020.

TABLE 37
CALCULATION - Estimated time, person ID 020

| | | Site, person, | | | | | T - |
|---|---|---|---|---|---|---|---|
| | | connection | Next | L or L1 or L2 - | TP - | TS - | Estimated time |
| | | or access | connection | Calculation | Preset | Security | [(L*X)/(V*fi)] + |
| Step | Site or access | point | point | distance | time | time | TP + TS |
| number | point name | position ID | ID | m | s | s | s |
| 1 | Electrical workshop | E020 | A010020 | 0.00 | | | 0.00 |
| 1 | Door A | A010020 | B010020 | 2.00 | | | 2.50 |
| 2 | Escape route A | A070060 | B070060 | 8.00 | | | 6.15 |
| 3 | Ladder A | A030020 | B030020 | 4.00 | | | 5.71 |
| 4 | Door A | A010030 | B010030 | 2.00 | | | 2.50 |
| 5 | Escape route A | A070070 | B070070 | 4.00 | | | 3.08 |
| 6 | Escape route A | K070031 | A070031 | 1.00 | | | 0.77 |
| 7 | Vertical ladder B | A040010 | B040010 | 4.50 | | | 11.25 |
| 8 | Escape route A | A070080 | B070080 | 7.00 | | | 5.40 |
| 9 | Door A | A010040 | B010040 | 2.00 | | | 2.50 |
| 10 | Escape route A | A070090 | B070090 | 11.00 | | | 8.50 |
| 11 | Muster point | F004 | | 0.00 | | | 0.00 |
| 12 | Total | | | | | | 48.36 |

Table 38 represents the estimated time for embarked person ID 022.

TABLE 38
CALCULATION - Estimated time, person ID 022

| | | Site, person, | | | | | T - |
|---|---|---|---|---|---|---|---|
| | | connection | Next | L or L1 or L2- | TP - | TS - | Estimated time |
| | | or access | connection | Calculation | Preset | Security | [(L*X)/(V*fi)] + |
| Step | Site or access | point | point | distance | time | time | TP + TS |
| number | point name | position ID | ID | m | s | s | s |
| 1 | Engine room 2 | E022 | A070100 | 0.00 | | 160.00 | 160.00 |
| 2 | Escape route A | A070100 | B070100 | 8.00 | | | 6.15 |
| 3 | Ladder A | A030030 | B030030 | 6.00 | | | 8.57 |
| 4 | Watertight door B | A020010 | B020010 | 2.00 | | | 3.33 |
| 5 | Escape route A | A070110 | B070110 | 23.00 | | | 17.69 |
| 6 | Escape route A | K070021 | B070120 | 5.00 | | | 3.85 |
| 7 | Ladder A | A030040 | B030040 | 5.00 | | | 7.14 |
| 8 | Escape route A | A070130 | B070130 | 15.00 | | | 11.54 |
| 9 | Escape route A | A070140 | B070140 | 7.00 | | | 5.38 |
| 10 | Muster point | F004 | | 0.00 | | | 0.00 |
| 11 | Total | | | | | | 223.65 |

Table 39 represents the estimated time for embarked person ID 033.

TABLE 39
CALCULATION - Estimated time, person ID 033

| | | Site, person, | | | | | T - |
|---|---|---|---|---|---|---|---|
| | | connection | Next | L or L1 or L2 - | TP - | TS - | Estimated time |
| | | or access | connection | Calculation | Preset | Security | [(L*X)/(V*fi)] + |
| Step | Site or access | point | point | distance | time | time | TP + TS |
| number | point name | position ID | ID | m | s | s | s |
| 1 | Cement silo 1 | E033 | A070150 | 0.00 | | 120.00 | 120.00 |
| 2 | Escape route A | A070150 | B070150 | 14.00 | | | 10.77 |
| 3 | Vertical ladder B | A040020 | B040020 | 8.00 | | | 20.00 |
| 5 | Escape route A | A070160 | B070160 | 21.00 | | | 16.15 |
| 6 | Escape route A | A070170 | B070170 | 10.50 | | | 8.08 |
| 7 | Ladder A | A030050 | B030050 | 7.50 | | | 10.71 |
| 8 | Escape route A | A070180 | B070180 | 4.00 | | | 3.08 |
| 9 | Escape route A | A070190 | B070190 | 2.00 | | | 1.54 |
| 10 | Muster point | F004 | | 0.00 | | | 0.00 |
| 11 | Total | | | | | | 190.33 |

Table 40 shows examples of estimated escape routes and response times for the formation of fire teams using table 28 (fire team duties only) and table 32.

Table 41 shows examples of escape routes and estimated response times for the formation of fire teams using table 28 (only “wait for instructions”) and table 32.

Table 42 shows the resulting fire teams using tables 40 and 41, forming a part of the updated real-time Emergency Management Method for fire teams. In the same way that fire teams are calculated, so are all other teams, always following table 25 and the sequence for team formation. In this way the entire Emergency Management Method is updated in real time.

TABLE 42
CALCULATION - Fire teams using dynamic duties

| | | | | | | Estimated |
|---|---|---|---|---|---|---|
| | | | Dynamic | | | response |
| Route | Person | Boots, | duty | | | time |
| ID | ID | suit | ID | Duty name | Condition | s |
| 090 | 015 | 42.56 | 030105 | Fire Team Leader | Off Duty | 83.50 |
| 005 | 006 | 41.56 | 030205 | Alternative leader, wearing fire-suit 1 | On Duty | 58.06 |
| 019 | 018 | 43.60 | 030305 | Wear fire-suit 2, hold fire hose nozzle | On Duty | 51.43 |
| 041 | 020 | 41.56 | 030405 | Help put fire-suit 1, hold fire hose | On Duty | 48.36 |
| 063 | 025 | 40.54 | 030505 | Help put fire-suit 2, hold fire hose | On Duty | 74.42 |
| 173 | 019 | 44.62 | 030605 | Open, dose fire valve | Off Duty | 93.45 |
| 003 | 017 | 41.56 | 030106 | Fire Team Leader | On Duty | 50.40 |
| 009 | 029 | 42.62 | 030206 | Alternative leader, wearing fire-suit 1 | On Duty | 62.35 |
| 029 | 031 | 44.58 | 030306 | Wear fire-suit 2, hold fire hose nozzle | On Duty | 58.53 |
| 046 | 010 | 43.60 | 030406 | Help put fire-suit 1, hold fire hose | On Duty | 42.17 |
| 073 | 027 | 43.60 | 030506 | Help put fire-suit 2, hold fire hose | On Duty | 63.64 |
| 187 | 011 | 42.56 | 030606 | Open, close fire valve | Off Duty | 101.35 |

Table 43 shows the fire teams created using the Initial Station Bill and resulting response times.

TABLE 43
CALCULATION - Fire teams, using initial duties

| | | | | | | Estimated |
|---|---|---|---|---|---|---|
| | | | Initial | | | response |
| Route | Person | Boots, | duty | | | time |
| ID | ID | suit | ID | Duty name | Condition | s |
| 001 | 017 | 41.56 | 011 | Fire Team Leader | On Duty | 61.30 |
| 005 | 006 | 41.56 | 006 | Alternative leader, wearing fire-suit 1 | On Duty | 58.06 |
| 014 | 010 | 43.60 | 008 | Wear fire-suit 2, hold fire hose nozzle | On Duty | 55.60 |
| 040 | 022 | 42.56 | 014 | Help put fire-suit 1, hold fire hose | On Duty | 223.65 |
| 062 | 020 | 41.56 | 013 | Help put fire-suit 2, hold fire hose | On Duty | 48.36 |
| 080 | 018 | 43.60 | 012 | Open, close fire valve | On Duty | 51.43 |
| 004 | 016 | 43.62 | 011 | Fire Team Leader | Off Duty | 95.70 |
| 009 | 029 | 42.62 | 006 | Alternative leader, wearing fire-suit 1 | On Duty | 62.35 |
| 027 | 033 | 44.58 | 008 | Wear fire-suit 2, hold fire hose nozzle | On Duty | 182.91 |
| 049 | 031 | 44.58 | 014 | Help put fire-suit 1, hold fire hose | On Duty | 58.53 |
| 071 | 025 | 40.54 | 013 | Help put fire-suit 2, hold fire hose | On Duty | 88.34 |
| 089 | 027 | 43.60 | 012 | Open, close fire valve | On Duty | 63.64 |

Table 44 shows the sum of the times using the Emergency Management System.

TABLE 44
CALCULATION - Fire teams, times review with the use of dynamic duties

| | | | | | Calculated | | | |
|---|---|---|---|---|---|---|---|---|
| | | Dynamic | | Preparation | Estimated | Total | Time | Time |
| Route | Person | duty | | time | time | time | limit | left |
| ID | ID | ID | Duty name | s | s | s | s | s |
| 090 | 015 | 030105 | Fire Team Leader | 10 | 83.50 | 93.50 | 230 | +136.50 |
| 005 | 006 | 030205 | Alternative leader, wearing fire-suit 1 | 60 | 58.06 | 118.06 | 230 | +111.94 |
| 019 | 018 | 030305 | Wear fire-suit 2, hold fire hose nozzle | 60 | 51.43 | 111.43 | 230 | +118.57 |
| 041 | 020 | 030405 | Help put fire-suit 1, hold fire hose | 60 | 48.36 | 108.36 | 230 | +121.64 |
| 063 | 025 | 030505 | Help put fire-suit 2, hold fire hose | 60 | 74.42 | 134.42 | 230 | +95.58 |
| 173 | 019 | 030605 | Open, close fire valve | 10 | 93.45 | 103.45 | 230 | +126.55 |
| 003 | 017 | 030106 | Fire Team Leader | 10 | 50.40 | 60.40 | 230 | +169.60 |
| 009 | 029 | 030206 | Alternative leader, wearing fire-suit 1 | 60 | 62.35 | 122.35 | 230 | +107.65 |
| 029 | 031 | 030306 | Wear fire-suit 2, hold fire hose nozzle | 60 | 58.53 | 118.53 | 230 | +111.47 |
| 046 | 010 | 030406 | Help put fire-suit 1, hold fire hose | 60 | 42.17 | 102.17 | 230 | +127.83 |
| 073 | 027 | 030506 | Help put fire-suit 2, hold fire hose | 60 | 63.64 | 123.64 | 230 | +106.36 |
| 187 | 011 | 030606 | Open, close fire valve | 10 | 101.35 | 111.35 | 230 | +118.65 |

Table 45 shows the sum of the times using the Initial Station Bill.

TABLE 45
CALCULATION - Fire teams, times review with the use of initial duties

| | | | | | Calculated | | | |
|---|---|---|---|---|---|---|---|---|
| | | Dynamic | | Preparation | Estimated | Total | Time | Time |
| Route | Person | duty | | time | time | time | limit | left |
| ID | ID | ID | Duty name | s | s | s | s | s |
| 001 | 017 | 011 | Fire Team Leader | 10 | 61.30 | 71.30 | 230 | +158.70 |
| 005 | 006 | 006 | Alternative leader, wearing fire-suit 1 | 60 | 58.06 | 118.06 | 230 | +111.94 |
| 014 | 010 | 008 | Wear fire-suit 2, hold fire hose nozzle | 60 | 55.60 | 115.60 | 230 | +114.40 |
| 040 | 022 | 014 | Help put fire-suit 1, hold fire hose | 60 | 223.65 | 283.65 | 230 | −53.65 |
| 062 | 020 | 013 | Help put fire-suit 2, hold fire hose | 60 | 48.36 | 108.36 | 230 | +121.64 |
| 080 | 018 | 012 | Open, close fire valve | 10 | 51.43 | 61.43 | 230 | +168.57 |
| 004 | 016 | 011 | Fire Team Leader | 10 | 95.70 | 105.70 | 230 | +124.30 |
| 009 | 029 | 006 | Alternative leader, wearing fire-suit 1 | 60 | 62.35 | 122.35 | 230 | +107.65 |
| 027 | 033 | 008 | Wear fire-suit 2, hold fire hose nozzle | 60 | 182.91 | 242.91 | 230 | −12.91 |
| 049 | 031 | 014 | Help put fire-suit 1, hold fire hose | 60 | 58.53 | 118.53 | 230 | +111.47 |
| 071 | 025 | 013 | Help put fire-suit 2, hold fire hose | 60 | 88.34 | 148.34 | 230 | +81.66 |
| 089 | 027 | 012 | Open, close fire valve | 10 | 63.64 | 73.64 | 230 | +156.36 |

Table 46 shows the position of the detected and selected muster points in the previous steps for calculating abandonment and graphic representation.

TABLE 46
CALCULATION - Fire, muster points positions

| Muster | | | | Point |
|---|---|---|---|---|
| point | | X | Y | position |
| code ID | Muster point name | position m | position m | ID |
| 01 | Lifeboat 1 | 35 | 28 | F008 |
| 02 | Lifeboat 2 | 35 | 2 | F009 |
| 03 | Lifeboat 3 | 175 | 28 | F010 |
| 04 | Lifeboat 4 | 175 | 2 | F011 |
| 05 | Firefighter's locker 1 | 80 | 25 | F004 |
| 06 | Firefighter's locker 2 | 160 | 5 | F005 |
| 07 | Ship's Bridge | 32 | 16 | F006 |
| 08 | On scene | 145 | 17 | S005 |
| 09 | Engine room | 180 | 13 | F007 |
| 10 | Hospital | 50 | 3 | F012 |
| 11 | Fast rescue boat | — | — | F013 |
| 12 | Fire team 1 | 140 | 25 | P040 |
| 13 | Fire team 2 | 160 | 17 | P048 |

Table 47 represents the detected position of the embarked persons for the abandonment emergency, but after the fire emergency. Position of the embarked persons in the moment of the firefighting and distance of the lifeboats.

TABLE 47
CALCULATION - Dynamic Station Bill, abandon after fire - person's position and distance

| | | | Fire | | | | |
|---|---|---|---|---|---|---|---|
| | X | Y | emergency | Distance from | Distance from | Distance from | Distance from |
| Person | position | position | duty | lifeboat 1 | lifeboat 2 | lifeboat 3 | lifeboat 4 |
| ID | m | m | ID | m | m | m | m |
| 001 | 32 | 16 | 010107 | 12.37 | 14.32 | 143.50 | 143.68 |
| 002 | 180 | 13 | 040109 | 145.77 | 145.42 | 15.81 | 12.08 |
| 003 | 145 | 17 | 020108 | 110.55 | 111.02 | 31.95 | 33.54 |
| 004 | 32 | 16 | 010207 | 12.37 | 14.32 | 143.50 | 143.68 |
| 005 | 36 | 9 | 060102 | 19.03 | 7.07 | 140.29 | 139.18 |
| 006 | 140 | 25 | 030205 | 105.04 | 107.49 | 35.13 | 41.88 |
| 007 | 55 | 12 | 060202 | 25.61 | 22.36 | 121.06 | 120.42 |
| 008 | 97 | 11 | 060103 | 64.29 | 62.65 | 79.83 | 78.52 |
| 009 | 40 | 10 | 060202 | 18.68 | 9.43 | 136.19 | 135.24 |
| 010 | 160 | 17 | 030406 | 125.48 | 125.90 | 18.60 | 21.21 |
| 011 | 160 | 17 | 030606 | 125.48 | 125.90 | 18.60 | 21.21 |
| 012 | 180 | 13 | 040209 | 145.77 | 145.42 | 15.81 | 12.08 |
| 013 | 32 | 16 | 010307 | 12.37 | 14.32 | 143.50 | 143.68 |
| 014 | 32 | 16 | 010307 | 12.37 | 14.32 | 143.50 | 143.68 |
| 015 | 140 | 25 | 030105 | 105.04 | 107.49 | 35.13 | 41.88 |
| 016 | 50 | 17 | 060202 | 18.60 | 21.21 | 125.48 | 125.90 |
| 017 | 160 | 17 | 030106 | 125.48 | 125.90 | 18.60 | 21.21 |
| 018 | 140 | 25 | 030305 | 105.04 | 107.49 | 35.13 | 41.88 |
| 019 | 140 | 25 | 030605 | 105.04 | 107.49 | 35.13 | 41.88 |
| 020 | 140 | 25 | 030405 | 105.04 | 107.49 | 35.13 | 41.88 |
| 021 | 50 | 5 | 060202 | 27.46 | 15.30 | 127.10 | 125.04 |
| 022 | 105 | 5 | 060203 | 73.68 | 70.06 | 73.68 | 70.06 |
| 023 | 41 | 5 | 060202 | 23.77 | 6.71 | 135.96 | 134.03 |
| 024 | 50 | 3 | 050110 | 29.15 | 15.03 | 127.48 | 125.00 |
| 025 | 160 | 10 | 060203 | 126.29 | 125.26 | 23.43 | 17.00 |
| 026 | 45 | 25 | 060202 | 10.44 | 25.08 | 130.03 | 132.02 |
| 027 | 160 | 17 | 030506 | 125.48 | 125.90 | 18.60 | 21.21 |
| 028 | 40 | 15 | 060202 | 13.93 | 13.93 | 135.62 | 135.62 |
| 029 | 160 | 17 | 030206 | 125.48 | 125.90 | 18.60 | 21.21 |
| 030 | 52 | 23 | 060202 | 17.72 | 27.02 | 123.10 | 124.78 |
| 031 | 160 | 17 | 030306 | 125.48 | 125.90 | 18.60 | 21.21 |
| 032 | 45 | 22 | 060202 | 11.66 | 22.36 | 130.14 | 131.53 |
| 033 | 140 | 25 | 030505 | 105.04 | 107.49 | 35.13 | 41.88 |
| 034 | 55 | 7 | 060202 | 29.00 | 20.62 | 121.82 | 120.10 |
| 035 | 100 | 3 | 060203 | 69.64 | 65.01 | 79.06 | 75.01 |
| 036 | 55 | 27 | 060202 | 20.02 | 32.02 | 120.00 | 122.58 |
| 037 | 105 | 4 | 060203 | 74.00 | 70.03 | 74.00 | 70.03 |
| 038 | 55 | 3 | 060202 | 32.02 | 20.02 | 122.58 | 120.00 |
| 039 | 105 | 8 | 060202 | 72.80 | 70.26 | 72.80 | 70.26 |
| 040 | 55 | 17 | 060202 | 22.83 | 25.00 | 120.50 | 120.93 |

Table 48 shows the application of table 47 and the Initial Station Bill for abandonment which is table 8. For exemplary purposes, only air distance is calculated. Time is calculated as done in previous calculations, for the formation of the fire teams.

TABLE 48
CALCULATION - Initial Station Bill, abandon after the fire - person's position and distance

| | | | Fire | Distance | Distance | Distance | Distance | | |
|---|---|---|---|---|---|---|---|---|---|
| | X | Y | emergency | from | from | from | from | Lifeboat | Distance |
| Person | position | position | duty | lifeboat 1 | lifeboat 2 | lifeboat 3 | lifeboat 4 | for | for |
| ID | m | m | ID | m | m | m | m | abandon | abandon |
| 001 | 32 | 16 | 010107 | 12.37 | 14.32 | 143.50 | 143.68 | 1 | 12.37 |
| 002 | 180 | 13 | 040109 | 145.77 | 145.42 | 15.81 | 12.08 | 1 | 145.77 |
| 003 | 145 | 17 | 020108 | 110.55 | 111.02 | 31.95 | 33.54 | 4 | 33.54 |
| 004 | 32 | 16 | 010207 | 12.37 | 14.32 | 143.50 | 143.68 | 1 | 12.37 |
| 005 | 36 | 9 | 060104 | 19.03 | 7.07 | 140.29 | 139.18 | 4 | 139.18 |
| 006 | 140 | 25 | 030205 | 105.04 | 107.49 | 35.13 | 41.88 | 1 | 105.04 |
| 007 | 55 | 12 | 060204 | 25.61 | 22.36 | 121.06 | 120.42 | 4 | 120.42 |
| 008 | 97 | 11 | 060101 | 64.29 | 62.65 | 79.83 | 78.52 | 1 | 64.29 |
| 009 | 40 | 10 | 060204 | 18.68 | 9.43 | 136.19 | 135.24 | 4 | 135.24 |
| 010 | 140 | 25 | 030305 | 105.04 | 107.49 | 35.13 | 41.88 | 1 | 105.04 |
| 011 | 40 | 8 | 060204 | 20.62 | 7.81 | 136.47 | 135.13 | 4 | 135.13 |
| 012 | 180 | 13 | 040209 | 145.77 | 145.42 | 15.81 | 12.08 | 4 | 12.08 |
| 013 | 32 | 16 | 010307 | 12.37 | 14.32 | 143.50 | 143.68 | 1 | 12.37 |
| 014 | 32 | 16 | 010307 | 12.37 | 14.32 | 143.50 | 143.68 | 4 | 143.68 |
| 015 | 190 | 10 | 060201 | 156.04 | 155.21 | 23.43 | 17.00 | 1 | 156.04 |
| 016 | 160 | 17 | 030106 | 125.48 | 125.90 | 18.60 | 21.21 | 1 | 125.48 |
| 017 | 140 | 25 | 030105 | 105.04 | 107.49 | 35.13 | 41.88 | 4 | 41.88 |
| 018 | 140 | 25 | 030605 | 105.04 | 107.49 | 35.13 | 41.88 | 1 | 105.04 |
| 019 | 52 | 8 | 060201 | 26.25 | 18.03 | 124.62 | 123.15 | 1 | 26.25 |
| 020 | 140 | 25 | 030505 | 105.04 | 107.49 | 35.13 | 41.88 | 1 | 105.04 |
| 021 | 50 | 5 | 060201 | 27.46 | 15.30 | 127.10 | 125.04 | 1 | 27.46 |
| 022 | 140 | 25 | 030405 | 105.04 | 107.49 | 35.13 | 41.88 | 4 | 41.88 |
| 023 | 41 | 5 | 060204 | 23.77 | 6.71 | 135.96 | 134.03 | 4 | 134.03 |
| 024 | 50 | 3 | 050110 | 29.15 | 15.03 | 127.48 | 125.00 | 1 | 29.15 |
| 025 | 160 | 17 | 030506 | 125.48 | 125.90 | 18.60 | 21.21 | 4 | 21.21 |
| 026 | 45 | 25 | 060204 | 10.44 | 25.08 | 130.03 | 132.02 | 4 | 132.02 |
| 027 | 160 | 17 | 030606 | 125.48 | 125.90 | 18.60 | 21.21 | 4 | 21.21 |
| 028 | 40 | 15 | 060204 | 13.93 | 13.93 | 135.62 | 135.62 | 4 | 135.62 |
| 029 | 160 | 17 | 030206 | 125.48 | 125.90 | 18.60 | 21.21 | 4 | 21.21 |
| 030 | 52 | 23 | 060204 | 17.72 | 27.02 | 123.10 | 124.78 | 4 | 124.78 |
| 031 | 160 | 17 | 030406 | 125.48 | 125.90 | 18.60 | 21.21 | 4 | 21.21 |
| 032 | 45 | 22 | 060204 | 11.66 | 22.36 | 130.14 | 131.53 | 4 | 131.53 |
| 033 | 160 | 17 | 030306 | 125.48 | 125.90 | 18.60 | 21.21 | 4 | 21.21 |
| 034 | 55 | 7 | 060204 | 29.00 | 20.62 | 121.82 | 120.10 | 4 | 120.10 |
| 035 | 100 | 3 | 060201 | 69.64 | 65.01 | 79.06 | 75.01 | 1 | 69.64 |
| 036 | 55 | 27 | 060204 | 20.02 | 32.02 | 120.00 | 122.58 | 4 | 122.58 |
| 037 | 105 | 4 | 060201 | 74.00 | 70.03 | 74.00 | 70.03 | 1 | 74.00 |
| 038 | 55 | 3 | 060204 | 32.02 | 20.02 | 122.58 | 120.00 | 4 | 120.00 |
| 039 | 105 | 8 | 060201 | 72.80 | 70.26 | 72.80 | 70.26 | 1 | 72.80 |
| 040 | 55 | 17 | 060201 | 22.83 | 25.00 | 120.50 | 120.93 | 1 | 22.83 |

| | |
|---|---|
| Total distance | 3200.77 |
| m | |

Table 49 shows the best option of lifeboats. According to the Emergency Management System are lifeboats 2 and 3. This table shows a division in equal part of embarked persons in each lifeboat. The shorter distances for transfer between lifeboats are represented in column 5, only for those embarked persons with the duty “wait for instructions”. Column 6 represents an application of a dynamic duty on embarked persons. This column has 22 embarked persons on the lifeboat 2 and 18 on the 3. To equalize, we use the values of column 5, embarked persons with value 1 and 2 in this column were transferred to lifeboat 3, thus forming two teams with the same number of embarked persons. However, considering the body weight of the embarked persons and the total weight allowed in the lifeboat to calculate a maximum number of passengers, we can avoid equalizing the number of embarked persons, if the calculation of the total weight and number of passengers for the lifeboat is not exceeded. This calculation is made for all combinations of lifeboats.

TABLE 49
CALCULATION - Dynamic Station Bill, combination of lifeboats for abandon after fire, shortest distance

| | | | Difference | Duty | | | | | |
|---|---|---|---|---|---|---|---|---|---|
| | | | between | distribution | Partial | Partial | Final | Final | |
| Person | Function | Nearest | distances | hierarchy | dynamic | lifeboat | distance | dynamic | Assigned |
| ID | ID | lifeboat | m | number | duty | assignment | m | duty | lifeboat |
| 001 | 04 | 2 | 129.18 | 15 | 060202 | 2 | 14.32 | 060202 | 2 |
| 002 | 05 | 3 | 129.61 | | 060203 | 3 | 15.81 | 060203 | 3 |
| 003 | 06 | 3 | 79.06 | | 060203 | 3 | 31.95 | 060203 | 3 |
| 004 | 07 | 2 | 129.18 | 16 | 060202 | 2 | 14.32 | 060202 | 2 |
| 005 | 07 | 2 | 133.22 | | 060102 | 2 | 7.07 | 060102 | 2 |
| 006 | 08 | 3 | 72.36 | | 060203 | 3 | 35.13 | 060203 | 3 |
| 007 | 08 | 2 | 98.70 | | 060402 | 2 | 22.36 | 060402 | 2 |
| 008 | 09 | 2 | 17.18 | | 060103 | 3 | 79.83 | 060103 | 3 |
| 009 | 09 | 2 | 126.76 | 14 | 060202 | 2 | 9.43 | 060202 | 2 |
| 010 | 10 | 3 | 107.30 | | 060403 | 3 | 18.60 | 060403 | 3 |
| 011 | 10 | 3 | 107.30 | | 060203 | 3 | 18.60 | 060203 | 3 |
| 012 | 11 | 3 | 129.61 | | 060203 | 3 | 15.81 | 060203 | 3 |
| 013 | 12 | 2 | 129.18 | 17 | 060202 | 2 | 14.32 | 060202 | 2 |
| 014 | 12 | 2 | 129.18 | 18 | 060202 | 2 | 14.32 | 060202 | 2 |
| 015 | 11 | 3 | 72.36 | | 060203 | 3 | 35.13 | 060203 | 3 |
| 016 | 13 | 2 | 104.27 | 8 | 060202 | 2 | 21.21 | 060202 | 2 |
| 017 | 13 | 3 | 107.30 | | 060203 | 3 | 18.60 | 060203 | 3 |
| 018 | 01 | 3 | 72.36 | | 060203 | 3 | 35.13 | 060203 | 3 |
| 019 | 01 | 3 | 72.36 | | 060203 | 3 | 35.13 | 060203 | 3 |
| 020 | 02 | 3 | 72.36 | | 060203 | 3 | 35.13 | 060203 | 3 |
| 021 | 02 | 2 | 111.80 | 11 | 060202 | 2 | 15.30 | 060202 | 2 |
| 022 | 03 | 2 | 3.62 | 2 | 060202 | 2 | 73.68 | 060203 | 3 |
| 023 | 03 | 2 | 129.25 | 19 | 060202 | 2 | 6.71 | 060202 | 2 |
| 024 | 14 | 2 | 112.44 | 12 | 060202 | 2 | 15.03 | 060202 | 2 |
| 025 | 15 | 3 | 101.82 | | 060203 | 3 | 23.43 | 060203 | 3 |
| 026 | 15 | 2 | 104.95 | 9 | 060202 | 2 | 25.08 | 060202 | 2 |
| 027 | 16 | 3 | 107.30 | | 060203 | 3 | 18.60 | 060203 | 3 |
| 028 | 16 | 2 | 121.70 | 13 | 060202 | 2 | 13.93 | 060202 | 2 |
| 029 | 17 | 3 | 107.30 | | 060203 | 3 | 18.60 | 060203 | 3 |
| 030 | 17 | 2 | 96.08 | 6 | 060202 | 2 | 27.02 | 060202 | 2 |
| 031 | 18 | 3 | 107.30 | | 060203 | 3 | 18.60 | 060203 | 3 |
| 032 | 18 | 2 | 107.78 | 10 | 060202 | 2 | 22.36 | 060202 | 2 |
| 033 | 19 | 3 | 72.36 | | 060203 | 3 | 35.13 | 060203 | 3 |
| 034 | 19 | 2 | 101.21 | 7 | 060202 | 2 | 20.62 | 060202 | 2 |
| 035 | 20 | 2 | 14.05 | 3 | 060202 | 2 | 65.01 | 060202 | 2 |
| 036 | 20 | 2 | 87.99 | 4 | 060202 | 2 | 32.02 | 060202 | 2 |
| 037 | 21 | 2 | 3.97 | | 060303 | 3 | 74.00 | 060303 | 3 |
| 038 | 21 | 2 | 102.55 | | 060302 | 2 | 20.02 | 060302 | 2 |
| 039 | 22 | 2 | 2.54 | 1 | 060202 | 2 | 72.80 | 060203 | 3 |
| 040 | 22 | 2 | 95.50 | 5 | 060202 | 2 | 25.00 | 060202 | 2 |
| Total Distance | | | | | | | | | 1115.14 |
| m | | | | | | | | | |

Table 50 is used for demonstrating distances using the Initial Station Bill and the Emergency Management System after the fire emergency. It is noticeable that the selection of lifeboats and duties for all combinations using the Emergency Management System is better (less distance) than using the Initial Station Bill.

TABLE 50
CALCULATION - Abandon after fire, duties, lifeboats and total escape routes length

| | | | | | | | Initial |
|---|---|---|---|---|---|---|---|
| Person | | | | | | | Station |
| ID | Dynamic Station Bill | | | | | | Bill |
| 001 | 060201 | 060201 | 60201 | 060202 | 060202 | 060204 | 070101 |
| 002 | 060202 | 060203 | 60204 | 060203 | 060204 | 060204 | 070201 |
| 003 | 060201 | 060203 | 60204 | 060203 | 060204 | 060203 | 070104 |
| 004 | 060201 | 060201 | 60201 | 060202 | 060202 | 060204 | 070301 |
| 005 | 060102 | 060101 | 60101 | 060102 | 060102 | 060103 | 070304 |
| 006 | 060401 | 060203 | 60204 | 060203 | 060204 | 060203 | 070801 |
| 007 | 060402 | 060401 | 60401 | 060402 | 060402 | 060204 | 070804 |
| 008 | 060101 | 060103 | 60104 | 060103 | 060104 | 060104 | 070501 |
| 009 | 060202 | 060201 | 60201 | 060202 | 060202 | 060204 | 070504 |
| 010 | 060202 | 060403 | 60404 | 060403 | 060404 | 060403 | 070801 |
| 011 | 060202 | 060203 | 60204 | 060203 | 060204 | 060404 | 070804 |
| 012 | 060202 | 060203 | 60204 | 060203 | 060204 | 060204 | 070204 |
| 013 | 060201 | 060201 | 60201 | 060202 | 060202 | 060204 | 070701 |
| 014 | 060201 | 060201 | 60201 | 060202 | 060202 | 060204 | 070704 |
| 015 | 060201 | 060203 | 60204 | 060203 | 060204 | 060203 | 070801 |
| 016 | 060201 | 060201 | 60201 | 060202 | 060202 | 060203 | 070801 |
| 017 | 060202 | 060203 | 60204 | 060203 | 060204 | 060203 | 070804 |
| 018 | 060201 | 060203 | 60204 | 060203 | 060204 | 060203 | 070801 |
| 019 | 060201 | 060203 | 60204 | 060203 | 060204 | 060203 | 070801 |
| 020 | 060201 | 060203 | 60204 | 060203 | 060204 | 060203 | 070801 |
| 021 | 060202 | 060201 | 60201 | 060202 | 060202 | 060204 | 070801 |
| 022 | 060202 | 060203 | 60204 | 060203 | 060204 | 060204 | 070804 |
| 023 | 060202 | 060201 | 60201 | 060202 | 060202 | 060204 | 070804 |
| 024 | 060202 | 060201 | 60201 | 060202 | 060202 | 060204 | 070801 |
| 025 | 060202 | 060203 | 60204 | 060203 | 060204 | 060204 | 070804 |
| 026 | 060201 | 060201 | 60201 | 060202 | 060202 | 060203 | 070804 |
| 027 | 060202 | 060203 | 60204 | 060203 | 060204 | 060203 | 070804 |
| 028 | 060202 | 060201 | 60201 | 060202 | 060202 | 060204 | 070804 |
| 029 | 060201 | 060203 | 60204 | 060203 | 060204 | 060203 | 070804 |
| 030 | 060201 | 060201 | 60201 | 060202 | 060202 | 060203 | 070804 |
| 031 | 060201 | 060203 | 60204 | 060203 | 060204 | 060203 | 070804 |
| 032 | 060201 | 060201 | 60201 | 060202 | 060202 | 060203 | 070804 |
| 033 | 060201 | 060203 | 60204 | 060203 | 060204 | 060203 | 070804 |
| 034 | 060202 | 060201 | 60201 | 060202 | 060202 | 060204 | 070804 |
| 035 | 060202 | 060201 | 60201 | 060202 | 060202 | 060304 | 070401 |
| 036 | 060301 | 060301 | 60301 | 060202 | 060202 | 060203 | 070404 |
| 037 | 060202 | 060303 | 60304 | 060303 | 060304 | 060303 | 070601 |
| 038 | 060302 | 060201 | 60201 | 060302 | 060302 | 060204 | 070604 |
| 039 | 060202 | 060203 | 60204 | 060203 | 060204 | 060204 | 070801 |
| 040 | 060201 | 060201 | 60201 | 060202 | 060202 | 060203 | 070801 |
| Total | 2532.32 | 1148.74 | 1181.18 | 1115.14 | 1147.58 | 3245.70 | 3200.77 |

Table 51 shows an example of embarked persons and lifeboats distances (routes) to be calculated. Embarked persons from the list dispute the mentioned duties. This table refers only to abandonment after the fire.

TABLE 51
CALCULATION - Routes for duty 060302 and 060303

| Person | Function | Distance from | Distance from |
|---|---|---|---|
| ID | ID | lifeboat 2 m | lifeboat 3 m |
| 035 | 20 | 65.01 | 79.06 |
| 036 | 20 | 32.02 | 120.00 |
| 037 | 21 | 70.03 | 74.00 |
| 038 | 21 | 20.02 | 122.58 |

Table 52 shows a combination of all duties (routes) disputed in table 51. For example, the best selection for duty 060302 is embarked person 038, and duty 060303 is embarked person 037. This table refers only to abandonment after the fire.

TABLE 52
CALCULATION - Duties distribution, duty 060302 and 060303

| Routes | Person ID | Person ID | | | |
|---|---|---|---|---|---|
| combination | with route to | with route to | Distance to | Distance to | |
| number | lifeboat 2 | lifeboat 3 | lifeboat 2 m | lifeboat 3 m | Total m |
| 1 | 035 | 036 | 65.01 | 120.00 | 185.01 |
| 2 | 035 | 037 | 65.01 | 74.00 | 139.01 |
| 3 | 035 | 038 | 65.01 | 122.58 | 187.58 |
| 4 | 036 | 037 | 32.02 | 74.00 | 106.02 |
| 5 | 036 | 038 | 32.02 | 122.58 | 154.59 |
| 6 | 037 | 038 | 70.03 | 122.58 | 192.61 |
| 7 | 038 | 035 | 20.02 | 79.06 | 99.08 |
| 8 | 038 | 036 | 20.02 | 120.00 | 140.03 |
| 9 | 038 | 037 | 20.02 | 74.00 | 94.02 |
| 10 | 037 | 035 | 70.03 | 79.06 | 149.09 |
| 11 | 037 | 036 | 70.03 | 120.00 | 190.03 |
| 12 | 036 | 035 | 32.02 | 79.06 | 111.07 |
| Option with | 038 | 037 | 20.02 | 74.00 | 94.02 |
| shortest distance | | | | | |

Table 53 represents the detected position of the embarked persons for the emergency of direct abandonment without the fire emergency and the respective distances of the lifeboats.

TABLE 53
CALCULATION - Abandon - person's position and distance

| | | | Distance | Distance | Distance | Distance |
|---|---|---|---|---|---|---|
| Per- | X | Y | from | from | from | from |
| son | position | position | lifeboat 1 | lifeboat 2 | lifeboat 3 | lifeboat 4 |
| ID | m | m | m | m | m | m |
| 001 | 40 | 20 | 9.43 | 18.68 | 135.24 | 136.19 |
| 002 | 40 | 17 | 12.08 | 15.81 | 135.45 | 135.83 |
| 003 | 50 | 20 | 17.00 | 23.43 | 125.26 | 126.29 |
| 004 | 25 | 15 | 16.40 | 16.40 | 150.56 | 150.56 |
| 005 | 36 | 9 | 19.03 | 7.07 | 140.29 | 139.18 |
| 006 | 140 | 8 | 106.89 | 105.17 | 40.31 | 35.51 |
| 007 | 55 | 12 | 25.61 | 22.36 | 121.06 | 120.42 |
| 008 | 97 | 11 | 64.29 | 62.65 | 79.83 | 78.52 |
| 009 | 40 | 10 | 18.68 | 9.43 | 136.19 | 135.24 |
| 010 | 180 | 25 | 145.03 | 146.81 | 5.83 | 23.54 |
| 011 | 40 | 8 | 20.62 | 7.81 | 136.47 | 135.13 |
| 012 | 55 | 15 | 23.85 | 23.85 | 120.70 | 120.70 |
| 013 | 28 | 13 | 16.55 | 13.04 | 147.76 | 147.41 |
| 014 | 50 | 13 | 21.21 | 18.60 | 125.90 | 125.48 |
| 015 | 190 | 10 | 156.04 | 155.21 | 23.43 | 17.00 |
| 016 | 50 | 17 | 18.60 | 21.21 | 125.48 | 125.90 |
| 017 | 190 | 13 | 155.72 | 155.39 | 21.21 | 18.60 |
| 018 | 120 | 20 | 85.38 | 86.88 | 55.58 | 57.87 |
| 019 | 52 | 8 | 26.25 | 18.03 | 124.62 | 123.15 |
| 020 | 150 | 25 | 115.04 | 117.28 | 25.18 | 33.97 |
| 021 | 50 | 5 | 27.46 | 15.30 | 127.10 | 125.04 |
| 022 | 105 | 5 | 73.68 | 70.06 | 73.68 | 70.06 |
| 023 | 41 | 5 | 23.77 | 6.71 | 135.96 | 134.03 |
| 024 | 50 | 10 | 23.43 | 17.00 | 126.29 | 125.26 |
| 025 | 160 | 10 | 126.29 | 125.26 | 23.43 | 17.00 |
| 026 | 45 | 25 | 10.44 | 25.08 | 130.03 | 132.02 |
| 027 | 150 | 20 | 115.28 | 116.40 | 26.25 | 30.81 |
| 028 | 40 | 15 | 13.93 | 13.93 | 135.62 | 135.62 |
| 029 | 80 | 20 | 45.71 | 48.47 | 95.34 | 96.69 |
| 030 | 52 | 23 | 17.72 | 27.02 | 123.10 | 124.78 |
| 031 | 98 | 5 | 67.07 | 63.07 | 80.36 | 77.06 |
| 032 | 45 | 22 | 11.66 | 22.36 | 130.14 | 131.53 |
| 033 | 80 | 12 | 47.76 | 46.10 | 96.34 | 95.52 |
| 034 | 55 | 7 | 29.00 | 20.62 | 121.82 | 120.10 |
| 035 | 100 | 3 | 69.64 | 65.01 | 79.06 | 75.01 |
| 036 | 55 | 27 | 20.02 | 32.02 | 120.00 | 122.58 |
| 037 | 105 | 4 | 74.00 | 70.03 | 74.00 | 70.03 |
| 038 | 55 | 3 | 32.02 | 20.02 | 122.58 | 120.00 |
| 039 | 105 | 8 | 72.80 | 70.26 | 72.80 | 70.26 |
| 040 | 55 | 17 | 22.83 | 25.00 | 120.50 | 120.93 |

Table 54 shows the position of the lifeboats for distance calculations.

TABLE 54
CALCULATION - Lifeboats position

| | X | Y |
|---|---|---|
| Lifeboat | position m | position m |
| 1 | 35 | 28 |
| 2 | 35 | 2 |
| 3 | 175 | 28 |
| 4 | 175 | 2 |

Table 55 shows that the best option of lifeboats according to the Emergency Management System in table 56 are lifeboats 2 and 4, calculating direct abandonment without the fire emergency. The calculation and separation of the embarked persons are made in the same way as in table 49.

TABLE 55
CALCULATION - Combination of lifeboats for Abandon, shortest distance

| | | | Difference | Duty | | | | | |
|---|---|---|---|---|---|---|---|---|---|
| | | | between | distribution | Partial | Partial | Final | Final | |
| Person | Function | Nearest | distances | hierarchy | dynamic | lifeboat | distance | dynamic | Assigned |
| ID | ID | lifeboat | m | number | duty | assignment | m | duty | lifeboat |
| 001 | 04 | 2 | 117.51 | | 070102 | 2 | 18.68 | 070102 | 2 |
| 002 | 05 | 2 | 120.02 | | 070202 | 2 | 15.81 | 070202 | 2 |
| 003 | 06 | 2 | 102.86 | | 070104 | 4 | 126.29 | 070104 | 4 |
| 004 | 07 | 2 | 134.16 | | 070302 | 2 | 16.40 | 070302 | 2 |
| 005 | 07 | 2 | 132.11 | | 070304 | 4 | 139.18 | 070304 | 4 |
| 006 | 08 | 4 | 69.66 | | 070804 | 4 | 35.51 | 070804 | 4 |
| 007 | 08 | 2 | 98.06 | 10 | 070802 | 2 | 22.36 | 070802 | 2 |
| 008 | 09 | 2 | 15.87 | 4 | 070802 | 2 | 78.52 | 070804 | 4 |
| 009 | 09 | 2 | 125.80 | | 070502 | 2 | 9.43 | 070502 | 2 |
| 010 | 10 | 4 | 123.28 | | 070804 | 4 | 23.54 | 070804 | 4 |
| 011 | 10 | 2 | 127.32 | 19 | 070802 | 2 | 7.81 | 070802 | 2 |
| 012 | 11 | 2 | 96.85 | 8 | 070802 | 2 | 23.85 | 070802 | 2 |
| 013 | 12 | 2 | 134.37 | | 070702 | 2 | 13.04 | 070702 | 2 |
| 014 | 12 | 2 | 106.88 | | 070704 | 4 | 125.48 | 070704 | 4 |
| 015 | 11 | 4 | 138.21 | | 070204 | 4 | 17.00 | 070204 | 4 |
| 016 | 13 | 2 | 104.68 | 12 | 070802 | 2 | 21.21 | 070802 | 2 |
| 017 | 13 | 4 | 136.79 | | 070804 | 4 | 18.60 | 070804 | 4 |
| 018 | 01 | 4 | 29.01 | | 070804 | 4 | 57.87 | 070804 | 4 |
| 019 | 01 | 2 | 105.12 | 13 | 070802 | 2 | 18.03 | 070802 | 2 |
| 020 | 02 | 4 | 83.31 | | 070804 | 4 | 33.97 | 070804 | 4 |
| 021 | 02 | 2 | 109.74 | 17 | 070802 | 2 | 15.30 | 070802 | 2 |
| 022 | 03 | 2 | 0.00 | 1 | 070802 | 2 | 70.06 | 070804 | 4 |
| 023 | 03 | 2 | 127.33 | 20 | 070802 | 2 | 6.71 | 070802 | 2 |
| 024 | 14 | 2 | 108.26 | 15 | 070802 | 2 | 17.00 | 070802 | 2 |
| 025 | 15 | 4 | 108.26 | | 070804 | 4 | 17.00 | 070804 | 4 |
| 026 | 15 | 2 | 106.94 | 14 | 070802 | 2 | 25.08 | 070802 | 2 |
| 027 | 16 | 4 | 85.59 | | 070804 | 4 | 30.81 | 070804 | 4 |
| 028 | 16 | 2 | 121.70 | 18 | 070802 | 2 | 13.93 | 070802 | 2 |
| 029 | 17 | 2 | 48.22 | 5 | 070802 | 2 | 96.69 | 070804 | 4 |
| 030 | 17 | 2 | 97.76 | 9 | 070802 | 2 | 27.02 | 070802 | 2 |
| 031 | 18 | 2 | 13.99 | 3 | 070802 | 2 | 77.06 | 070804 | 4 |
| 032 | 18 | 2 | 109.17 | 16 | 070802 | 2 | 22.36 | 070802 | 2 |
| 033 | 19 | 2 | 49.43 | 6 | 070802 | 2 | 95.52 | 070804 | 4 |
| 034 | 19 | 2 | 99.49 | 11 | 070802 | 2 | 20.62 | 070802 | 2 |
| 035 | 20 | 2 | 10.00 | | 070604 | 4 | 75.01 | 070604 | 4 |
| 036 | 20 | 2 | 90.56 | | 070602 | 2 | 32.02 | 070602 | 2 |
| 037 | 21 | 2 | 0.00 | | 070404 | 4 | 70.03 | 070404 | 4 |
| 038 | 21 | 2 | 99.98 | | 070402 | 2 | 20.02 | 070402 | 2 |
| 039 | 22 | 2 | 0.00 | 2 | 070802 | 2 | 70.26 | 070804 | 4 |
| 040 | 22 | 2 | 95.93 | 7 | 070802 | 2 | 120.93 | 070804 | 4 |
| Total Distance | | | | | | | | | 1746.01 |
| m | | | | | | | | | |

Table 56 is used for demonstrating distances using the Initial Station Bill and Emergency Management System, only direct abandonment emergency without fire emergency. The options of lifeboats and duties for all combinations (excluding 3 and 4) using the Emergency Management System is clearly better than using the Initial Station Bill, because the distance is shorter.

TABLE 56
CALCULATION - Abandon, duties, lifeboats and total escape routes length

| | | | | | | | Initial |
|---|---|---|---|---|---|---|---|
| Person | | | | | | | Station |
| ID | Dynamic Station Bill | | | | | | Bill |
| 001 | 070101 | 070101 | 070101 | 070102 | 070102 | 070104 | 070101 |
| 002 | 070201 | 070201 | 070201 | 070202 | 070202 | 070803 | 070201 |
| 003 | 070102 | 070103 | 070104 | 070103 | 070104 | 070103 | 070104 |
| 004 | 070301 | 070301 | 070301 | 070302 | 070302 | 070303 | 070301 |
| 005 | 070302 | 070303 | 070304 | 070303 | 070304 | 070304 | 070304 |
| 006 | 070802 | 070803 | 070804 | 070803 | 070804 | 070804 | 070801 |
| 007 | 070802 | 070801 | 070801 | 070802 | 070802 | 070804 | 070804 |
| 008 | 070501 | 070803 | 070804 | 070803 | 070804 | 070804 | 070501 |
| 009 | 070802 | 070501 | 070501 | 070502 | 070502 | 070503 | 070504 |
| 010 | 070801 | 070803 | 070804 | 070803 | 070804 | 070803 | 070801 |
| 011 | 070802 | 070801 | 070801 | 070802 | 070802 | 070804 | 070804 |
| 012 | 070801 | 070801 | 070801 | 070802 | 070802 | 070803 | 070204 |
| 013 | 070702 | 070701 | 070701 | 070702 | 070702 | 070703 | 070701 |
| 014 | 070701 | 070703 | 070704 | 070703 | 070704 | 070704 | 070704 |
| 015 | 070801 | 070803 | 070204 | 070803 | 070204 | 070204 | 070801 |
| 016 | 070202 | 070801 | 070801 | 070802 | 070802 | 070803 | 070801 |
| 017 | 070801 | 070203 | 070804 | 070203 | 070804 | 070203 | 070804 |
| 018 | 070801 | 070803 | 070804 | 070803 | 070804 | 070803 | 070801 |
| 019 | 070802 | 070801 | 070801 | 070802 | 070802 | 070804 | 070801 |
| 020 | 070801 | 070803 | 070804 | 070803 | 070804 | 070803 | 070801 |
| 021 | 070802 | 070801 | 070801 | 070802 | 070802 | 070804 | 070801 |
| 022 | 070802 | 070803 | 070804 | 070803 | 070804 | 070804 | 070804 |
| 023 | 070802 | 070801 | 070801 | 070802 | 070802 | 070804 | 070804 |
| 024 | 070802 | 070801 | 070801 | 070802 | 070802 | 070804 | 070801 |
| 025 | 070802 | 070803 | 070804 | 070803 | 070804 | 070804 | 070804 |
| 026 | 070801 | 070801 | 070801 | 070802 | 070802 | 070803 | 070804 |
| 027 | 070801 | 070803 | 070804 | 070803 | 070804 | 070803 | 070804 |
| 028 | 070801 | 070801 | 070801 | 070802 | 070802 | 070803 | 070804 |
| 029 | 070801 | 070803 | 070804 | 070803 | 070804 | 070803 | 070804 |
| 030 | 070801 | 070801 | 070801 | 070802 | 070802 | 070803 | 070804 |
| 031 | 070802 | 070803 | 070804 | 070803 | 070804 | 070804 | 070804 |
| 032 | 070801 | 070801 | 070801 | 070802 | 070802 | 070803 | 070804 |
| 033 | 070802 | 070803 | 070804 | 070803 | 070804 | 070804 | 070804 |
| 034 | 070802 | 070803 | 070804 | 070802 | 070802 | 070804 | 070804 |
| 035 | 070602 | 070603 | 070604 | 070603 | 070604 | 070404 | 070401 |
| 036 | 070401 | 070601 | 070601 | 070602 | 070602 | 070603 | 070404 |
| 037 | 070601 | 070403 | 070404 | 070403 | 070404 | 070403 | 070601 |
| 038 | 070402 | 070401 | 070401 | 070402 | 070402 | 070604 | 070604 |
| 039 | 070802 | 070803 | 070804 | 070803 | 070804 | 070804 | 070801 |
| 040 | 070801 | 070801 | 070801 | 070803 | 070804 | 070803 | 070801 |
| Total | 1883.03 | 1777.26 | 1769.86 | 1751.26 | 1746.01 | 3944.12 | 3391.00 |

Table 57 shows examples of embarked persons and lifeboats distances (routes) to be calculated. Embarked persons contained in the list dispute the mentioned duties. This table refers only to direct abandonment without the fire emergency.

TABLE 57
CALCULATION - Routes for duty 070202 and 070204

| Person | Function | Distance from | Distance from |
|---|---|---|---|
| ID | ID | lifeboat 2 m | lifeboat 4 m |
| 002 | 05 | 15.81 | 135.83 |
| 012 | 11 | 23.85 | 120.70 |
| 015 | 11 | 155.21 | 17.00 |
| 016 | 13 | 21.21 | 125.90 |
| 017 | 13 | 155.39 | 18.60 |

Table 58 shows a combination of all the disputed duties (routes) of table 57. For example, the best selection for duty 070202 is embarked person 002 and duty 070204 is embarked person 015. This table refers only to direct abandonment without the fire emergency.

TABLE 58
CALCULATION - Duties distribution, duty 070202 and 070204

| Routes | Person ID | Person ID | | | |
|---|---|---|---|---|---|
| combination | with route to | with route to | Distance to | Distance to | |
| number | lifeboat 2 | lifeboat 4 | lifeboat 2 m | lifeboat 4 m | Total m |
| 1 | 002 | 012 | 15.81 | 120.70 | 136.51 |
| 2 | 002 | 015 | 15.81 | 17.00 | 32.81 |
| 3 | 002 | 016 | 15.81 | 125.90 | 141.71 |
| 4 | 002 | 017 | 15.81 | 18.60 | 34.41 |
| 5 | 012 | 015 | 23.85 | 17.00 | 40.85 |
| 6 | 012 | 016 | 23.85 | 125.90 | 149.75 |
| 7 | 012 | 017 | 23.85 | 18.60 | 42.45 |
| 8 | 015 | 016 | 155.21 | 125.90 | 281.10 |
| 9 | 015 | 017 | 155.21 | 18.60 | 173.81 |
| 10 | 016 | 017 | 21.21 | 18.60 | 39.81 |
| 11 | 017 | 002 | 155.39 | 135.83 | 291.22 |
| 12 | 017 | 012 | 155.39 | 120.70 | 276.09 |
| 13 | 017 | 015 | 155.39 | 17.00 | 172.39 |
| 14 | 017 | 016 | 155.39 | 125.90 | 281.29 |
| 15 | 016 | 002 | 21.21 | 135.83 | 157.04 |
| 16 | 016 | 012 | 21.21 | 120.70 | 141.92 |
| 17 | 016 | 015 | 21.21 | 17.00 | 38.21 |
| 18 | 015 | 002 | 155.21 | 135.83 | 291.04 |
| 19 | 015 | 012 | 155.21 | 120.70 | 275.91 |
| 20 | 012 | 002 | 23.85 | 135.83 | 159.68 |
| Option with | 002 | 015 | 15.81 | 17.00 | 32.81 |
| shortest distance | | | | | |

Step I (9)—Maintain communication between system modules to inform the new routes and duties that have been assigned to the embarked persons after updating the Emergency Management System.

The human factors are obtained by filling out the forms in steps A (1), B (2), C (3), F (6) and G (7) and updating the positioning of the embarked persons performed in step D (4).

The vessel and emergency factors are predefined in step A (1) and changed according to the real conditions, or conditions assigned for training or simulation, through steps E (5) and F (6).

In the event of an alarm, the embarked person must use the nearest Field Module (13), Smart Portable Radio Module (14) or any computer connected and authenticated in the Emergency Management System to identify their location. At this point, the implementation of step D (4) will be a priority in the computer program sending the information through the Specific Communication Network (11). RFID detectors and sensors distributed at key points of the vessel also send their information through the Specific Communication Network (11) to update the location of the embarked person in the Control and Monitoring Module (10).

The forms provided by the Method in steps A (1), B (2), C (3), F (6) and G (7) should be understood as spreadsheets or screens with fields to be filled, where the data required for dynamic updating of the Initial Station Bill are provided by automatic or manual migration by the responsible for safety on board or assistants authorized by the commander or responsible for safety on board.

When the Emergency Management System is used in training or simulation, the information resulting from the communication between the modules—steps D (4) and E (5)—can be entered manually to generate the conditions to be trained or simulated. When using the Emergency Management System for training or simulation, it will be allowed to exclude embarked persons for any type of emergency, which is not always allowed in real situation, because in this case, it depends on the type of emergency.

Training is understood as the realization of events with the physical involvement of the people on board, performing assigned duties as if one or more types of emergencies had occurred. It is understood as simulation the execution of a mathematical model fed by the current situation data, that is, real data, and virtual data, for security evaluation in order to search for current or future security failures.

In order to distinguish the activities and responsibilities attributed to embarked persons in normal situations and emergency, the terms tasks and duties were adopted respectively. The Duties are related to the Initial Station Bill or the Emergency Management System, inserted in Step A (1) and G (7), and the tasks are listed on the Permit to Work in Step C (3).

From the Initial Station Bill, Step A (1), and from the POB information, Step B (2), the Emergency Management System, either automatically or manually, in Step G (7) provides a revisions form, which presents options of duties that an embarked person can take over and which was not initially assigned in Step A (1). These duties are called dynamic duties.

The means responsible for implementing the Emergency Management Method are either installed in the emergency management modules or are stored in the portable version media device for use on the Authorized Computers, in accordance with the following assignments:

a) Control and Monitoring Module (10) has as its function to execute the algorithms, which contains at least the steps from A (1) to H (8), store the data of the embarked persons and keep at least an exact copy of the system and all the history of events of at least 5 years in Backup Module (10a). Also, attribution of the module to receive, through the Specific Communication Network (11), the embarked persons locations, Security Assets (12), vessel stability condition, weather condition and sensor information that are identified/captured by Portable Modules (14) or Field Modules (13) and by the plurality of sensors distributed in the environments of the vessel where the stay and transit of people are foreseen as well as all the updates inserted through Authorized Computers (10b).

b) Backup Module (10a), has as its function storing all events, settings, simulations and changes in Control and Monitoring Module (10). Keeping thus the data necessary for the operation of the system safe and ready for use in case of possible loss or damage occurring in the Control and Monitoring Module (10), in this case, it becomes a main system computer to continue to control the Dynamic Station Bill generation with all attributes of the Control and Monitoring Module (10). The Backup Module (10a) can be in a flameproof room, separated from the other rooms for safety reasons to keep control of the vessel in extreme emergency.

c) Authorized Computer (10b) has, as its function, maintenance of the data system and may receive the authorization of the Control and Monitoring Module (10) for the maintenance of the list of people on board, maintenance of the daily tasks of the people on board, monitoring of the events on the vessel through the cameras, between other essential tasks for the functioning of the Emergency Management System.

d) Field Module (13) is assigned to the MMI Man/Machine Interface, and it is distributed on the vessel, muster points, and key areas. It is used for people on board to inform their arrival in a certain environment, complementing the location sensors, being able to confirm information of services or events related to the location. In the emergency situation, Field Modules (13) assume the role of providing embarked persons with guidance on routes, tasks and duties, which in this case may be those of the Initial Station Bill or Dynamic Station Bill by the commander from the Control and Monitoring Module (10). The Field Module (13) has, in addition to the usual communication networks, a PLC (power line communications) network connection and uses a long-range VHF Radio Modem to create a specific Wireless Communication Network (11) between the various Field Modules (13) and send the necessary information to the Control and Monitoring Module (10) in real or simulated emergency situations. Field Modules also have radio frequency transceivers under 1 GHz (400 MHz to 950 MHz) for communication with other modules and equipment in local communication network, 2.4 GHz radio frequency transceiver for receiving Bluetooth transmitters, and a read/write RFID card. The Field Module (13) is provided with LiFePO4 battery pack for operation in case of power failure. In this case, Field Modules (13) use the VHF Radio Modems to create a mesh data communication network and send the embarked persons location information and other emergency information to the Control and Monitoring Module (10).

e) Smart Portable Radio Module (14) has the same attribution as the Field Modules (13), but because it is for personal use, it transmits the user position and makes it easier to count him at the muster points. It is also used to inform the position of Security Assets and people not detected by the location sensors, and to send additional emergency information to the Control and Monitoring Module (10). It is also considered to be an emergency information repeater node in the data communication mesh network implemented by the Specific Communication Network (11).

f) Scanning Module with Camera (15) is assigned to locate and integrate the Specific Communication Network (11) Security Assets (12) and Smart Portable Radio Modules (14) that are out of reach of a Field Module (13). The Scanning Module with Camera (15) should be installed on the ceiling, preferably near the point of illumination, so that assets, people, escape routes and entire zones are accessible to radio waves and camera range. The Scanning Module with Camera (15) can also be used to send emergency information when connected to the PLC network or when connected to the Specific Communication Network (11) by radiofrequency.

g) Considered as Sensor Modules (16) the plurality of sensors on the vessel and assigned to inform its stability situation, weather conditions, potentially dangerous events, beginning of possible emergency, faults and other events. Such information is used by the Control and Monitoring Module (10) for calculations and generation of the Dynamic Station Bill. The relevant information shall be sent to the Control and Monitoring Module (10) and may, for this purpose, use Authorized Computers (10b), PLC network, Field Modules (13), Smart Portable Radio Modules (14) and Auxiliary Nodes (17). During emergency events, sensors may communicate with the Specific Communication Network (11) using the suggested Emergency Communication Protocol to repeat data from Field Modules (13) and Smart Portable Radio Modules (14) acting as Auxiliary Nodes (17). This communication may be performed by radio frequency using frequencies under 1 GHz, captured by Field Modules (13), Smart Portable Radio Modules (14) and Auxiliary Nodes (17), and subsequently sent to the Control and Monitoring Module (10) via the Specific Communication Network (11).

In the event of a catastrophic failure, which may render the Emergency Management System inoperative, Field Modules (13), Smart Portable Radio Modules (14) and Computers (10, 10a and 10b) who are able to display information in this situation, show information only from Initial Station Bill enhanced with the use of simulators. The Station Bill may continue to be displayed as it is in warning frames placed at designated points so that it is always visible and accessible to all in the event of failure. In this way, all people aboard will have access, through the modules and computers that interface with embarked persons, to the list of duties in all on-board trained emergencies that they can carry out in a normal situation using the Emergency Management System and the duties found in the Initial Station Bill enhanced with the use of simulators when catastrophic failure occurs. The enhanced Initial Station Bill with the use of simulators contains duties in all regularly trained vessel emergencies, unlike those currently used.

Modules, particularly Field Modules (13), are equipped with a battery charge management system, designed to perform balanced loading and discharge of lithium-iron phosphate battery cells (LiFePO4), in addition to performing the coupling and uncoupling to the electronic power circuit of the module, system which will not be detailed in the present invention. In the emergency it is possible that there is a power outage (blackout), so the modules have batteries to operate during the blackout by radiofrequency and forming a mesh data communication network. Each module uses cells, depending on its operating voltage. In the case of Field Module (13), a set of five LiFePO4 lithium-iron phosphate battery cells is used.

The lithium-iron phosphate battery is a type of rechargeable battery that uses LiFePO4 as cathode material. Despite lower energy density than LiCoO2 batteries, it offers longer battery life, greater power discharge capacity and greater safety of use.

Unlike other Li-ion batteries, LiFePO4 batteries have a constant discharge voltage. The voltage remains close to 3.2 volts until the cell is exhausted, simplifying voltage regulator circuits besides having greater chemical and thermal stability, improving the safety of its use and, therefore, are safer for application in hazardous industrial environment with explosion risk.

The emergency management modules communicate with each other in the Specific Communication Network (11), distinct from any communication networks used in a normal situation, because during the emergency these communication networks may be out of operation or congested. Where possible the Specific Communication Network uses PLC technology (power line communications) to transport the data. In case of blackout, the Field Modules (13) use VHF Radio Modems to form a mesh data communication network between them and create a new Specific Communication Network (11). Other modules, sensors and equipment with radio communication in frequencies under 1 GHz can send information to the Specific Communication Network (11) using the suggested Emergency Communication Protocol, assisting to update the information of the Control and Monitoring Module (10). When authenticating to the Specific Communication Network (11) each of these elements acts as Auxiliary Node (17) for network regeneration functions.

In a non-emergency situation, the modules and the Specific Communication Network (11) will be used for emergency training and simulations and if necessary, the results can be migrated to other networks and/or computers for analysis and identification of improvements.

Computational algorithms in (14), Scanning Module with Camera (15) and Sensor Modules (16) may be protected by secret or copyright and have not been detailed in the present application.

Security Assets (12), considered in this invention are individual or collective protective and rescue equipment, e.g. stretchers, fire extinguishers, autonomous masks, emergency lights, firefighting equipment, lifeboats, life rafts, etc.

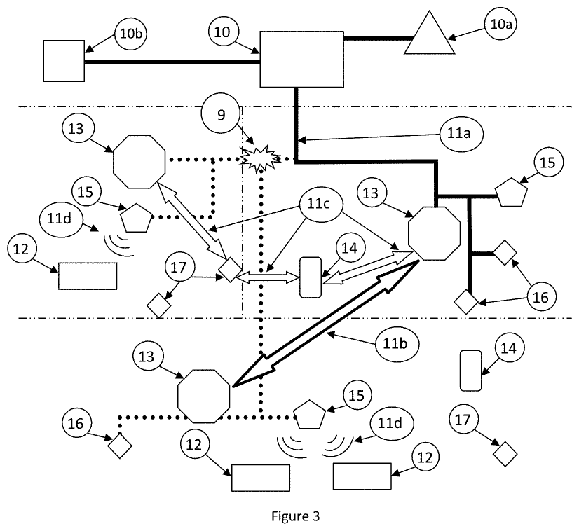

FIG. 2 exemplifies a distribution and use of the modules in the vessel and the Specific Communication Network (11) for communication between the modules.

The Specific Communication Network (11) is formed by networks:

a) Ethernet Network—Power Line Communications (PLC) (11a): this method of communication uses as a physical path the cabling of the equipment power network, adapted to simultaneously transmit data and electric energy. It communicates using Ethernet protocol and is used whenever available. Uses TCP/IP protocol to implement mesh network communication between system modules. When beneficial to the system, other equipment can be connected to the central module via the PLC network, but such equipment is silenced during actual emergency or training and serves only to identify the position and send the emergency information.

b) Radio Modem VHF 147-174 MHz (11b): uses radio frequency band as the physical medium for data transmission. It operates at low frequencies for range enhancement and transposition of barriers and uses the IEEE 802.15.4 and ISO/IEC 18000-7 communication protocols for wireless communication networks under 1 GHz. It implements mesh network between the system modules, allowing the regeneration of communications and reach of the isolated modules. In the event of a blackout, the mesh network formed by the Field Modules (13) using VHF Radio Modems will form the new Main Specific Communication Network (11).

c) MCU Radio 433-915 MHz (11c): through radio transceiver, this network uses radio frequency band as the physical path in frequency bands higher than the network (11b). It uses IEEE 802.15.4 and ISO/IEC 18000-7 communication protocols for wireless communication networks under 1 GHz. This network uses Sensor Modules (16) and Auxiliary Nodes (17) (devices and actuators), adapted or originally constructed to communicate at the same frequency and protocol, to implement mesh data communication network. Used primarily for the collection of sensing information, it acts as a resource for sending data between Field Modules (13), carrying the relevant data through the Sensor Modules (16) and Auxiliary Nodes (17).

d) Bluetooth Low Energy 2.4 GHz (11d): uses radiofrequency as a physical path for data transmission and IEEE 802.15.1 standard for data communication. Primarily used for communication with Smart Portable Radio Modules (14) and Scanning Modules with Camera (15) in locating of people and Security Assets (12). As an extra emergency resource, this communication can be used by the Control and Monitoring Module (10) to communicate with other modules. In this situation the Scanning Modules with Camera (15) act as repeaters of the communication packets. In this way, it is possible to use active tags with BLE technology to locate people and Security Assets.

The physical redundancy of the Specific Communication Network (11) for communication between the modules is reinforced by the route's regenerative capacity with the adoption of mesh network topology, implemented using the abovementioned technologies. Whenever available and amenable to installation the system uses the PLC network for data communication, updating the Control and Monitoring Module (10) without increasing data traffic on conventional data communication lines. When not implemented PLC network or in case of power failure, the Specific Communication Network (11) is formed through the radio transceivers present in the various system modules and auxiliary modules distributed on the vessel. Primarily, Field Modules (13) use VHF Radio Modems to communicate with the Control and Monitoring Module (10) using other technologies to aid in carrying information when necessary.

The Emergency Communication Network, when the use of the PLC communication network is not possible, is formed by multiple local networks. The main network is formed by Field Modules (13) through VHF Radio Modems. When a Field Module (13) cannot communicate with the Control and Monitoring Module (10) via the VHF network, it uses the under 1 GHz local network to pass the required data to other Field Modules (13) that can communicate with the Control and Monitoring Module (10). This secondary network, also in mesh topology, can assist the transport of information by tracing new routes to the emergency information packages. In the latter case, the Specific Communication Network (11) uses the Bluetooth transceivers with an Emergency Communication Protocol implemented to create a third auxiliary data transport network.

FIG. 3 exemplifies the communication route regenerated using the Mesh network technology, for condition of the fixed network via PLC to become inoperative due to Disaster 9, real or simulated, in one or all areas of the vessel.

In the process of regeneration, the network may use sensors, instruments or electronic devices available on location that, originally or by adaptation have radio transceivers in the network frequencies of the Radio Modem VHF 147-174 MHz (11b) or MCU Radio 433-915 MHz (11c) or Ethernet Network—PLC (11a), in this context called Sensor Modules (16) and Auxiliary Nodes (17), being examples of:
a) Sensor Modules (16) correspond to the various sensors distributed on the vessel, such as smoke sensor, fire sensor, vibration sensor, flood sensor, level sensor, gas sensor, open/closed door sensor, anemometer, gyroscope, magnetometer, pressure, altitude, noise, humidity, heat;
b) Auxiliary Nodes (17) are field instrumentation: transducers, indicators and controllers, valves and actuators or electronics: television, refrigerators, personal computers, tablets or smartphones.

In addition to the physical redundancy of the means of transmission and mesh network topology, the security, speed and network readiness occurs using word encodings, set of bits, which are transmitted between the modules to signal changes and presences. In this way it is suggested the creation of a standard data communication protocol for the specific emergency information transport called Emergency Communication Protocol.

The Emergency Communication Protocol is based on IEEE 802.15.4 and ISO/IEC 18000-7 standards. Such protocols are designed for wireless networks with reduced data rate, maximizing the significance of transmitted bytes. The Emergency Management System information packages follow the same implementation line transporting the information through the smallest possible code size. This bit reduction improves the speed of communications and facilitates the transmission of data through the networks of lower transmission rate and/or shorter range. Messages encrypted with the Emergency Communication Protocol have priority over other data packages and are sent in the form of a broadcast so that any device in the Specific Communication Network (11) is able to receive and reply, increasing the chances of the information reaching the Control and Monitoring Module (10).

The IEEE 802.15.4 and ISO/IEC 18000-7 standards have a field for protocol identification, the Emergency Communication Protocol is implemented using this field to indicate an emergency communication package, which will follow the same dynamic of communication and access to the physical environment, but with priority over the other messages.

The main purpose of the Emergency Communication Protocol is to transmit positioning information of the embarked persons to the Control and Monitoring Module (10) and transmit commands and responses thereof to the Field Modules (13), thus reaching the other modules that interface with the people on board, responsible for updating the escape routes and indicating the new dynamic duties. This information should be condensed, encoded and reduced to the smallest possible number of significant symbols and transported in the payload fields of the IEEE 802.15.4 and ISO/IEC 18000-7 protocols.

### Form of Application of the System.

The application of the Emergency Management System is described below, whereby simulation, training or in fact the Disaster 9 is occurring, the behavior of the disaster is analyzed.

In Step A (1) the initial information of the Station Bill items contents will be loaded into the Control and Monitoring Module (10). As we can see from the list below, items two, five, six and seven are considered as upgradeable in cases of vessels with a complex structure and more people on board.

Station Bill Contents:
1. Name of vessel/IMO number.
2. Emergency duties of all crew and people on board.
3. General and emergency alarms.
4. Responsible for the maintenance of rescue and firefighting devices or means.
5. Substitutes for key personnel who may become unavailable to act.
6. Signature of commander, location of muster points and pollutions emergency plans.
7. Special duties in case of emergency and abandonment of the vessel.
8. Station Bill format to be approved by the vessel flag State.

Through the implementation of Steps B (2) and C (3) the Emergency Management System will receive information about the people on board, and what was planned for their positions and tasks in progress.

Implementation of Step D (4) allows the dynamic updating of the embarked persons positions as a result of the communication between the modules, under routine or emergency conditions.

On a routine basis, the embarked person must confirm in the nearest Field Module (13) through the RFID tag or in the Smart Portable Radio Module (14) or the Authorized Computers (10b) that has started the execution of a single step of the task assigned in Step C (3) to keep its position informed on the vessel and, firstly, to keep the safety time required for the calculation of the dynamic duties up to date, as the constant scanning of the embarked persons and Security Assets grants the positioning.

In the event of an emergency, the embarked person shall confirm in the nearest Field Module (13), through the RFID tag or the Smart Portable Radio Module (14) or the Authorized Computers (10b) the receiving of the duty assigned to him, as soon as he hears the alarm sound or emergency announcement, this will confirm his position on the vessel and will allow the calculation to continue. Otherwise, if the embarked person is unable for any reason to accept the duty passed to him, may reject it and as soon as it is ready confirm the readiness to receive new duty in emergency. Each rejection of duty must have a clear explanation, otherwise the responsible for safety on board may use the assessment system to correct safety faults caused by human factor among several other known options. This is the unforeseen factor that cannot be controlled, but can be minimized by certifying reliable embarked persons and those who demonstrate good appraisal.

If the embarked person has a task in progress that cannot be safely stopped in time to perform the main duty assigned to him, the Emergency Management System will provide a substitute duty, for example:
a) in case of abandonment of the vessel an abandonment muster point will be assigned with an appropriate duty.
b) wait for rescue team to rescue him if his work location is threatened by an emergency, for example no more escape route is available.
c) continuation of the current task if nothing interferes.

It is mandatory that all embarked persons in an emergency confirm the receipt of the duty assigned. For this reason, if the embarked person has an ongoing task that cannot be safely stopped, it is recommended to have the Smart Portable Radio Module (14), to confirm the receipt of the duty in time and to be in continuous contact with the Control and Monitoring Module (10).

To exemplify Step H (8), supposing that the commander forms dynamic duties for a fire team, consisting of a leader, persons with fire hose, hydrant, and various on support. The Emergency Management System will indicate a complete list of qualified persons on board to form this fire team due to the certificates and the function that each crew member exercises on board the vessel so that the commander can exclude embarked persons from this list or add new ones by modifying the dynamic duties.

As routine or occasional tasks, recorded in Step C (3), are factors used to recalculate times and redistribute emergency duties. The Dynamic Station Bill depending on the configuration of the dynamic duties and required certification can maintain the leader and one or two persons with the fire hose, and new embarked persons are placed as support personnel, due to the positioning at the time of the alarm and the certificates that enable them to help firefighting. The estimated time required for the new option to be fulfilled must be informed by the Emergency Management System, as per updates of the additional duties initially maintained and approved by the responsible person. Through real-time updates of the embarked persons location and the available resources, several changes are generated in the Emergency Management System, to compare the options of the muster points and instructions, the shorter time of the team formation and the more competent team will be verified as well as the nearest one to the accident to make the emergency response as fast as possible.

A second example of the execution of Step H (8) is the redefinition of duty, where a leader of an emergency combat team, even though it is a commander person of confidence, knowledgeable about the vessel, experienced and required certificate holder, will be in a certain period involved in a task that cannot be interrupted or the time that this leader will take to demobilize and arrive at the predicted location for its team to fight the emergency will exceed the one of the another nearer leader.

Leadership exchange is automatic if there is an embarked person with dynamic duty registered in Step G (7) as a firefighting leader. If there is no embarked with this additional duty, the Emergency Management System will issue the warning of a safety failure. Thus, the commander may arrange a temporary replacement. The temporary substitute is first sought among the embarked persons awaiting instructions on the lifeboats. Once the replacement is selected, the alarm in the Field Module (13) and the Smart Portable Radio Module (14) will be generated asking the substitute for confirmation of receipt of the new dynamic duty. Confirming the receiving, he must proceed to the new muster point. Failures like this can be avoided by using previous simulations and by assigning and creating additional duties certifying those embarked persons with necessary certificates to guarantee substitutes.

The embarked persons will be notified through the Emergency Management System, through the permanent execution of Step I (9), about the leadership exchange during this period in the form of an alarm in a Field Module (13), Smart Portable Radio Module (14) or Authorized Computer (10b).

When an emergency occurs, the travel path to the emergency team formation muster point is blocked and does not allow the foreseen access for certain embarked persons. The execution of step H (8) will give the commander the option of shorter time and the safest option, if different, to determine the new muster point or change of emergency duty in the Dynamic Station Bill. Once this option is approved, the embarked persons will be notified of this change through the updated Emergency Management System on the standing execution of Step I (9).

Based on this descriptive and the numberless combinations between the total number and the characteristics of the people on board, certificates, duties, muster points, work permits, emergencies and their consequences (interdictions of escape routes and chain reaction between emergencies), meteorological conditions, vessel characteristics as well as the need for the improvement of those responsible for safety on board in the fight against emergencies and in the daily use of the Emergency Management System requires the use of simulators.

Another use of the simulators is intended for those responsible for the implementation of the Station Bill and the Ship Security Station Bill (ISPS Code) and for the general safety of all those on board, they are: Captain, Vessel Safety Officer and substitutes, on behalf of representatives such as the ISM Code Designated Person and the Company Security Officer by the ISPS Code and substitutes, may provide for an appropriate combination of duties, certificates, muster points, Security Assets according to the vessel characteristics and emergencies, using simulations for the creation of an Initial Station Bill, among others, that serve as a basis for future dynamic updates in the Emergency Management System.

The technology and calculations used in the Emergency Management System can be applied in addition to maritime vessels also onshore, in different constructions and industrial installations among others. The Emergency Management System for evacuation optimization can be applied and adapted to all facilities that uses a control system for monitoring and/or evacuation of the facility indicating escape routes and alerting the responsible authorities. Examples are buildings, hospitals, schools, hotels, industrial and military facilities, airports, ports and the like.

In addition to the above-mentioned facilities, the system and all modules are applicable to the urban traffic system and vehicle control. With the sensors and vehicle ID transmitters (chassis and registration plate information) where they transmit and are captured at the scan points installed on the urban traffic system fixed points. Fixed points such as traffic lights, public lighting poles, signs and traffic signs, house number plates and street signs, parking spaces and the like may be used for scanning and data transmission. The control and monitoring points or responsible authorities on land are police, fire department, emergency and similar. Vehicles can also identify other traffic participants near them using installed sensors and transmitters and pass the same data to fixed stations if necessary, applying the mesh network characteristic. Locating vehicles and passing their position to the drivers and the control and monitoring stations. Using maps, the system can provide the location without using GPS and internet.

The present invention has been described in terms of its characteristics considered to be more expressive, however, certain variations and modifications will become apparent to one skilled in the art from the present disclosure and such variations and modifications are not in any way limiting and are included within the scope of the present invention.

1. A method for emergency management characterized by comprising the steps of:
provide a Station Bill including a list of emergencies and basic duties for people in the environment;
register each person, through the filling of personal data, professional information and skills related to emergencies;
associate each person with a passive or active radio frequency identification device;
register the routine tasks and the eventual tasks, informing the location of execution, machines, tools, individual or collective security equipment used in the task, chronological procedures of the task, safety information, participants, start time and end of the form validity and the estimated time required to safely abandon the task and reach a nearer escape route;
identify the position of the people, confirming the presence of the people in the locations, and the position of each Safety Asset (12);
provide the location of an emergency, in real situation, training or simulation, and what are the restrictions on access to muster points caused by the emergency situation;
register additional duties that individuals may carry out in the occurrence of the various types of emergency situations;
to calculate the times of escape routes or course to the location to combat the emergency situation;
inform people of the new routes and duties that have been assigned to them after updating the Station Bill.

2. An emergency management system characterized for comprising:
a Control and Monitoring Module (10);
a Backup Module (10a);
at least one computing device (10b);
at least one Field Module (13);
at least one Smart Portable Radio Module (14);
at least one Scanning Module with Camera (15);
at least one Sensor Module (16);
at least one Auxiliary Node (17), and
at least one Safety Asset (12),
wherein the system elements (10, 10a, 10b, 13, 14, 15, 16, 17) comprise modems and radio transceivers for forming a specific communication network (11), in which a method as defined in claim 1 is carried out.

3. A system, according to claim 2, characterized by the fact that the Control and Monitoring Module (10) carries out the method steps, stores the data from people, receives, through the Specific Communication Network (11), the location of people and at least one Safety Asset (12), identified/captured by: at least one Smart Portable Radio Module (14), at least one Field Module (13), at least one Scanning Module with Camera (15), and at least one Sensor Module (16).

4. A system according to claim 2, characterized by the fact that at least one Field Module (13) is located in a distributed way in environments where people are expected to stay and to transit, and comprises of a long-range VHF modem radio and batteries for continuous operation in the event of a power outage.

5. A system according to claim 2, characterized by the fact that at least one Field Module (13) comprises of a Man-Machine Interface (MMI), in which the people inform their arrival in a determined location, information about events or services related to the location, and in the event of an emergency, receives guidance on routes and tasks through the Station Bill.

6. A system according to claim 2, characterized by the fact that at least one Safety Asset (12) is one of: a stretcher, a fire extinguisher, a stand-alone mask, an emergency light, a firefighting equipment, a lifeboat, and a life raft.

7. A system according to claim 2, characterized by the fact that at least one Safety Asset (12) comprises of radio transceivers operating at the frequency of one of the networks: Radio Modem VHF 147-174 MHz (11b), MCU Radio 433-915 MHz (11c), and Ethernet Network—PLC (11a).

8. A system according to claim 2, characterized by the fact that at least one Auxiliary Node (17) is one of: a transducer, an indicator, a controller, a valve, an actuator, a television, a refrigerator, a personal computer, a tablet, and a smartphone.

9. A system according to claim 2, characterized by the fact that at least one Auxiliary Node (17) comprises of radio transceivers operating at the frequency of one of the networks: Radio Modem VHF 147-174 MHz (11b), MCU Radio 433-915 MHz (11c), and Ethernet Network—PLC (11a).

10. System according to claim 2, characterized by the fact that the Specific Communication Network (11) is formed by the following networks:
an Ethernet Network—Power Line Communications (PLC) (11a), which uses as a physical mean the cabling of the network equipment power supply, adapted to simultaneously transmit data and electrical energy;
a Radio Modem VHF 147-174 MHz (11b), which uses radio frequency band as the physical mean for data transmission;
an MCU Radio Network 433-915 MHz (11c), which uses a radio transceiver, in frequency bands higher than the Radio Modem VHF 147-174 MHz (11b) network; and
a Bluetooth Low Energy 2.4 GHz (11d) network, which uses radiofrequency as the physical mean for data transmission and IEEE 802.15.1 standard for data communication.

11. A system according to claim 10, characterized by the fact that the radio modem networks VHF 147-174 MHz (11b) and MCU 433-915 MHz (11c) operate at low frequencies using the IEEE 802.15.4 communication protocols and ISO/IEC 18000-7 for wireless communication networks under 1 GHz.

12. A system according to claim 10, characterized by the fact that at least one Sensor Module (16) communicates on the same frequency and with the same protocol as the MCU Radio 433-915 MHz (11c) and Power Line Communications (PLC) (11a), and wherein it is used to implement a mesh data communication network.

13. A system according to claim 10, characterized by the fact that at least one Auxiliary Node (17) communicates on the same frequency and with the same protocol of the MCU Radio 433-915 MHz (11c), and wherein is used to implement a mesh communication network.

14. A system according to claim 2, characterized by the fact that the system comprises redundancies by physical means of the specific communication network (11) to provide enhanced communication between the system elements (10, 10a, 10b, 13, 14, 15, 16, 17) through regenerative route capability provided by the mesh network.

15. A system according to claim 2, characterized by the fact that the Bluetooth Low Energy 2.4 GHz (11d) network is used primarily for communication with at least one Smart Portable Radio Module (14) and at least one Scanning Module with Camera (15) in locating people and at least one Safety Asset (12).

16. A system according to claim 2, characterized by the fact that the Bluetooth Low Energy 2.4 GHz (11d) network is used by the Control and Monitoring Module (10) as an extra emergency resource to communicate with other modules.

17. A system according to claim 2, characterized by the fact that at least one Scanning Module with Camera (15) acts as a repeater of the communication packages.

18. A system according to claim 2, characterized by the fact that the Field Modules (13), the Smart Portable Radio Modules (14), the Scanning Modules with Camera (15), the Sensor Modules (16), the Auxiliary Nodes (17) use lithium-iron phosphate (LiFePO4) battery cells, and are equipped with a battery charge management system, which is designed to perform balanced charging and discharging of battery cells and performing coupling and uncoupling of the battery cells to an electronic power circuit.

19. A System according to claim 2, characterized by the fact that the Field Modules (13) and the Smart Portable Radio Modules (14) have a VHF radio modem enabling the creation of a Specific Communication Network (11) with a mesh topology in an industrial environment.

20. A system according to claim 2, characterized by the fact that the Specific Communication Network (11) uses a standardized communication protocol for local networks enabling the regeneration of communication links using different frequency bands under 1 GHz, organized on different local networks.

21. A system according to claim 2, characterized by the fact that the Emergency Communication Protocol implements media access control and data format according to ISO/IEC 18000-7 and IEEE 802.15.4 standards with an emergency protocol identifier enabling to send messages with a higher priority.

22. System according to claim 2, characterized by the fact that the environment consists of a vessel and/or a platform.

23. A system according to claim 21, characterized by the fact that the method still comprises the step of obtaining information regarding vessel stability, weather situation, potentially dangerous events, beginning of emergencies and failures.

24. A system according to claim 22, characterized by the fact that the stability condition of the vessel and/or platform and the weather condition, identified/captured by: at least one Smart Portable Radio Module (14), at least one Field Module (13), at least one Scanning Module with Camera (15) and at least one Sensor Module (16).

25. System according to claim 2, characterized by the fact that the system generates a Station Bill updated in real time.
